(19) United States
(12) Patent Application Publication
(10) Pub. No.: US 2012/0053062 A1
(43) Pub. Date: Mar. 1, 2012

(54) DEFINING DIAGNOSTIC AND THERAPEUTIC TARGETS OF CONSERVED FREE FLOATING FETAL DNA IN MATERNAL CIRCULATING BLOOD

(75) Inventor: Andrew BROOKS, New York, NY (US)

(73) Assignee: Bio Dx, Inc., San Diego, CA (US)

(21) Appl. No.: 13/216,992

(22) Filed: Aug. 24, 2011

Related U.S. Application Data
(60) Provisional application No. 61/376,637, filed on Aug. 24, 2010.

(51) Int. Cl. C40B 20/00; G06F 17/30; C40B 40/06

(52) U.S. Cl. 506/2; 506/16; 707/758; 707/E17.014

(57) ABSTRACT

The present invention provides methods and materials useful for detecting cell free fetal DNA as well as markers for fetal conditions by using biological samples of a maternal host.

### CROSS REFERENCE TO RELATED APPLICATIONS

This application claims priority to U.S. Provisional Application No. 61/376,637 filed, Aug. 24, 2010, which is incorporated by reference herein in its entirety.

### FIELD OF THE INVENTION

The present invention provides for detecting and characterizing fetal genetic material, e.g., fetal DNA in maternal samples, e.g., maternal blood as well as identification of fetal conditions based on non-invasive prenatal testing.

### BACKGROUND OF THE INVENTION

The challenges associated with DNA diagnostics from free floating fetal DNA are many. Issues associated with the amount of DNA, enrichment of fetal specific DNA, nucleic acid purity and understanding the specific fetal DNA sequence that is conserved across pregnancies and subjects are among the largest hurdles. Currently there is no satisfactory methodology for determining the presence of fetal DNA prior to diagnostic testing which adversely affects the ability to report consistent and reliable data. There is also lack of sufficient characterization of free floating fetal DNA that can be used to identify specific sequences (in addition to disease targets) that can be used to obtain a high rate of success in assay development across pregnancies.

Sequence and mutation specific assay development is currently difficult to carry out given the variability associated with prenatal nucleic acid analysis from maternal whole blood.

As such, there remains a need in the art for methods and approaches of detecting fetal DNA and related fetal conditions.

The present invention describes a technological approach for detecting and characterizing fetal genetic material in maternal samples. In addition, the present invention provides methods and related materials for identifying fetal conditions based on fetal genetic materials in maternal samples.

### SUMMARY OF THE INVENTION

The present invention is based, in part, on the discovery that certain fetal genetic materials are conserved in maternal biological samples, e.g., maternal blood. Accordingly the present invention provides methods and materials useful for detecting fetal genetic material as well as for identification of fetal conditions.

In one aspect, the present invention provides a method for detecting the presence of fetal DNA in a biological sample of a maternal host. In one embodiment, the method comprises identifying the genotype of at least one conserved genomic segment in a biological sample of a maternal host and comparing the genotype to the corresponding maternal genotype to determine the presence of fetal DNA based on one or more differences between the genotype of the sample and the genotype of the maternal host.

In one embodiment, the conserved genomic segment is a genomic segment provided in Table 1. In one embodiment, the conserved genomic segment includes any probe identified in Table 1. In another embodiment, the conserved genomic segment includes any gene identified in Table 1. In yet another embodiment, the conserved genomic segment is a fragment of a gene identified in Table 1, e.g., a fragment associated with any genotype marker of a gene identified in Table 1. In still another embodiment, the conserved genomic segment is any gene identifiable by the probe or associated with the probe identified in Table 1.

In one embodiment, the method comprises detecting the genotypes of at least two, at least three, at least four, at least five, at least six, at least seven, at least eight, at least nine, at least ten, at least 20, at least 50, at least 100, at least 150, at least 200, at least 250, at least 500, at least 600, at least 700, or at least 800 conserved genomic segments provided in Table 1 in a biological sample of a maternal host and comparing the genotypes to the corresponding maternal genotypes to determine the presence of fetal DNA based on one or more differences between the genotype of the sample and the genotype of the maternal host.

In one embodiment, the genotype of a conserved genomic segment comprises the profile of any one or more genetic makeup suitable for distinguishing one genome from another genome. For example, the genotype of a conserved genomic segment can comprise the profile of single nucleotide polymorphism (SNP), restriction fragment length polymoprhism (RFLP), short tandem repeats (STR), DNA sequence, or any combination thereof. In one embodiment, the genotype of a conserved genomic segment comprises the profile of SNP. In yet another embodiment, the genotype of one or more conserved genomic segments comprises the profile of at least about 1, 2, 3, 4, 5, 6, 7, 8, 9, 10, 15, 20, 25, 30, 35, 40, 50, 60, 70, 80, 90, or 100 SNPs in one or more conserved genomic segments.

In one embodiment, the biological sample of a maternal host includes any processed or unprocessed, solid, semi-solid, or liquid biological sample, e.g., blood, urine, saliva, mucosal samples (such as samples from uterus or vagina, etc.). For example, the biological sample of a maternal host can be a sample of whole blood, partially lysed whole blood, plasma, partially processed whole blood. In one embodiment, the biological sample of a maternal host is a sample of cell free DNA or free floating DNA from the whole blood of the maternal host.

In one embodiment, the biological sample of a maternal host is enriched for fetal DNA. In one embodiment, the biological sample of a maternal host is enriched for fetal DNA by DNA size fractionation. In one embodiment the fraction of DNA containing fetal DNA is characterized by having a size of about less than 500 base pairs, or about 50 to about 500 base pairs or about 50 to about 400 base pairs, or about 50 to about 300 base pairs, or about 50 to about 200 base pairs, or about 50 to about 100 base pairs.

In one embodiment, the genotype of at least one conserved genomic segment in a biological sample of a maternal host that has been enriched for fetal DNA is determined and compared to a maternal genotype for the same conserved genomic segments in a maternal cell sample. In one embodiment, the maternal biological sample enriched for fetal DNA is a whole blood sample. In a further embodiment, the maternal cell sample is derived from a maternal whole blood sample, e.g., prior to pregnancy.

In another aspect, the invention provides for a method of detecting the presence or absence of a genetic condition in a fetus comprising detecting the presence or absence of a genetic marker in a biological sample obtained from the maternal host of a fetus. In one embodiment, the genetic marker is within a chromosomal location conserved in cell free fetal DNA in the biological sample of the maternal host. In one embodiment, the chromosomal location is selected from the chromosomal locations listed in Table 2. In one embodiment, the presence or absence of the genetic marker indicates the presence or absence of the genetic condition in the fetus.

In one embodiment, the biological sample of a maternal host includes any processed or unprocessed, solid, semi-solid, or liquid biological sample, e.g., blood, urine, saliva, mucosal samples (such as samples from uterus or vagina, etc.). For example, the biological sample of a maternal host can be a sample of whole blood, partially lysed whole blood, plasma, partially processed whole blood. In one embodiment, the biological sample of a maternal host is a sample of cell free DNA or free floating DNA from the whole blood of the maternal host.

In one embodiment, the biological sample of a maternal host is enriched for fetal DNA. In one embodiment, the biological sample of a maternal host is enriched for fetal DNA by DNA size fractionation. In one embodiment the fraction of DNA containing fetal DNA is characterized by having a size of about less than 500 base pairs, or about 50 to about 500 base pairs or about 50 to about 400 base pairs, or about 50 to about 300 base pairs, or about 50 to about 200 base pairs, or about 50 to about 100 base pairs.

In one embodiment, prior to, concurrent with or subsequent to the detection of the presence or absence of a genetic marker, the presence of fetal DNA is confirmed in the biological sample. In one embodiment, the presence of fetal DNA is confirmed in the biological sample by identifying the genotype of at least one conserved genomic segment in the biological sample and comparing the genotype to the corresponding maternal genotype to determine the presence of fetal DNA based on one or more differences between the genotype of the sample and the genotype of the maternal host.

In one embodiment, the genetic marker is a combination of a first genetic marker from a first chromosomal location conserved in cell free fetal DNA and a second genetic marker from a second chromosomal location conserved in cell free fetal DNA. In another embodiment, the first and second chromosomal locations are different. In a further embodiment, the method further includes a third genetic marker from a third chromosomal location in cell free fetal DNA. In still another embodiment, the method further includes a fourth genetic marker from a fourth chromosomal location in cell free fetal DNA. In yet another embodiment, the method further includes a fifth genetic marker from a fifth chromosomal location in cell free fetal DNA. In one embodiment, the third, fourth and/or fifth chromosomal locations are different from the first two and each other. In another embodiment, the first and second chromosomal locations, and optionally the third, fourth, and fifth chromosomal locations are on the same or different chromosomes.

In one embodiment, the genetic marker is associated with skeletal dysplasia. In a further embodiment, the genetic marker is associated with spinal muscular atrophy. In yet another embodiment, the genetic marker is located within the chromosomal location 5q13-5q13.

In one embodiment, the genetic maker is associated with an aneuploidy. In one embodiment, the aneuploidy is a trisomy. In a further embodiment, the genetic marker associated with a trisomy is within one or more of the chromosomal locations selected from the group consisting of X21.2-Xp21.1, 17q11.2-17q11.2, 3p26-3p25, 5q13-5q13, 16q24.3-16q24.3, 1q24.2-1q23 and/or 11q22-11q23. In one embodiment, the genetic marker associated with a trisomy is within a chromosomal location of chromosome 13, 14, 15, 16, 18, 21, 22, X or Y. In another embodiment, the genetic marker includes a panel of genetic markers from a chromosomal location of chromosome 13, 14, 15, 16, 18, 21, 22, X, Y, or any combination thereof. In yet another embodiment, the generic marker includes a panel of genetic markers from one or more chromosomal locations of X21.2-Xp21.1, 17q11.2-17q11.2, 3p26-3p25, 5q13-5q13, 16q24.3-16q24.3, 1q24.2-1q23, 11q22-11q23 or any combination thereof.

In one aspect, the current invention provides a method for selecting a genetic marker for determining a genetic condition of a fetus in a biological sample of a maternal host of the fetus by identifying a group of genetic markers associated with a genetic condition to be determined for the fetus in a biological sample of a the maternal host, identifying within the group of genetic markers, a subset of genetic makers that are within one or more chromosomal locations conserved in cell free fetal DNA in the biological sample of the maternal host, selecting the subset of genetic markers for assay testing and determining the genetic condition of the fetus based on the results obtained from assay testing.

In another aspect, the current invention provides for a databases in a computer readable medium comprising conserved genomic segments. In one embodiment, the conserved genomic segments are those conserved genomic segments provided for in Table 1. In a further embodiment, the database is searchable based on an identifier for each chromosomal location or gene provided in Table 1.

In one aspect, the current invention provides for a computer readable medium comprising chromosomal locations provided in Table 2. In one embodiment, the database is searchable based on an identifier for each chromosomal location provided in Table 2.

In one aspect, the current invention provides an array of probes useful for detecting a panel of genetic markers within one or more chromosomal locations provided in Table 2.

### DETAILED DESCRIPTION

The present invention is based, in part, on the discovery that certain fetal genetic materials are conserved in maternal biological samples, e.g., maternal blood. Accordingly the present invention provides methods and materials useful for detecting fetal genetic material as well as for identification of fetal conditions.

In one step of the invention, the presence of fetal DNA is detected in a biological sample of a maternal host of a fetus. Specifically, cell free fetal DNA is detected in a whole blood sample of a pregnant female. By “cell free fetal DNA” is meant, DNA that is derived from the fetus and not the mother and is not within a cell. In one embodiment, cell free fetal DNA includes fetal DNA circulating in maternal blood. In another embodiment, cell free fetal DNA includes fetal DNA existing outside of a cell, for example a fetal cell. In yet another embodiment, cell free fetal DNA includes fetal DNA existing outside of a cell as well as fetal DNA present in maternal blood sample after such blood sample undergoing partial or gentle cell lysing.

In this aspect of the invention, a biological sample, such as a whole blood sample, is obtained from the maternal host of a fetus, and the genotype of at least one conserved genomic segment in the biological sample of the maternal host is determined. The one or more conserved genomic segment is one or more of the identified conserved genomic segments listed in Table 1. The genotype of the biological sample of the maternal host is then compared with the genotype of the same conserved genomic segment of the mother. A difference in maternal genotype and the genotype determined from the biological sample of the maternal host of the fetus indicates the presence of fetal DNA in the biological sample of the maternal host.

In this aspect of the invention, the biological sample from the maternal host can be enriched for fetal DNA by any means known in the art. In the first trimester fetal DNA is approximately 6% of the total cell free DNA found in maternal blood. This percentage increases as gestation ages progresses. However, the entire fetal DNA genome is not present in any given sample, e.g., only certain fragments of fetal DNA genome are consistently present or conserved in maternal biological samples. In addition, the fetal DNA species that are found in circulating maternal blood are generally smaller in size than that of maternal DNA. Therefore, fetal DNA may be enriched by DNA size fractionation. In this method, DNA is separated based on size. The fetal DNA fraction is characterized as the fraction of DNA having a size of less than about 500 base pairs, for example about 50 to about 500 base pairs or about 50 to about 400 base pairs, or about 50 to about 300 base pairs or about 50 to about 200 base pairs or about 50 to about 100 base pairs. Thus, isolating the fraction of DNA having a size of less than about 500 base pairs, particularly the fraction having a size of about 50 to about 300 enriches the fetal DNA in a biological sample of maternal host. The enriched fetal DNA fraction can then be used to determine the genotype of the fetus by determining the genotype of at least one conserved genomic segment listed in Table 1. This genotype is then compared to the genotype of the same one or more conserved genomic segments from the mother. The maternal genotype can be determined by determining the genotype of the one ore more conserved genomic segments in the biological sample prior to enriching for fetal DNA or by determining the genotype of the one or more conserved genomic segments in the fraction of DNA containing DNA larger than about 250 base pairs after size fractionation. Alternatively, the genotype can be compared to a maternal genotype of the conserved genomic segments determined prior to the pregnancy.

By “genotype” is meant the genetic makeup of a cell or an individual (i.e. a fetus or the maternal host of a fetus). The genotype may be determined by any method known in the art. For example, the genotype of the fetus or the maternal host of a fetus may be determined by DNA sequencing, for example NextGen sequencing, SNP, RFLP or STR analysis. For SNP analysis any number of SNPs may be used to determine the genotype. For example, a panel of 96 SNPs allows for the SNP pattern to repeat in every 2×10²³ individuals, thereby giving a high probability of genetic identity. Methods of determining genotypes by DNA sequencing, SNP, RFLP, and STR are well known in the art.

In one aspect of the invention, the genotype of one or more of the conserved genomic fragments listed in Table 1 is determined. By “conserved genomic fragments” is meant, the entire length or a fragment thereof the probe given in Table 1, any gene identified in Table 1, or any fragment of a gene identified in Table 1. In one embodiment, conserved genomic fragments include a panel of fragments within one or more probes or genes identified in Table 1. In one aspect of the invention, the genotypes of about 5 to about 500 of the conserved genomic fragments given in Table 1 are determined. In another aspect of the invention, the genotypes of about 10 to about 400 of the conserved genomic fragments given in Table 1 are determined. In yet another example, the genotype of about 20 to about 300 of the conserved genomic fragments given in Table 1 is determined. In still another embodiment, the genotypes of about 30 to about 200 of the conserved genomic fragments given in Table 1 are determined. In another embodiment, the genotypes of about 40 to about 100 of the conserved genomic fragments given in Table 1 are determined.

By “maternal host of a fetus” is meant the woman who is pregnant with the fetus whose DNA is sought to be detected and/or tested for a genetic condition. The term “maternal host of a fetus,” “maternal host” and “mother” are used interchangeably. By “fetus” is meant in uterus developing offspring of any gestational stage. Fetal DNA can be detected prior to the “fetal period” which begins at 11 weeks of gestation in human. Therefore, “fetus” encompasses not only the developing offspring in the fetal period but also in the earlier embryonic stages of development prior to the 11^{th} week of human gestation.

By “biological sample” is meant any sample that is derived from the maternal host of the fetus. In one embodiment, the biological sample of a maternal host includes any processed or unprocessed, solid, semi-solid, or liquid biological sample, e.g., blood, urine, saliva, mucosal samples (such as samples from uterus or vagina, etc.). For example, the biological sample of a maternal host can be a sample of whole blood, partially lysed whole blood, plasma, partially processed whole blood. In one embodiment, the biological sample of a maternal host is a sample of cell free DNA or free floating DNA from the whole blood of the maternal host.

In a further aspect, the current invention provides for a method of non-invasive genetic testing of a fetus by detecting the presence or absence of a genetic marker associated with a genetic condition in a fetus. For example, a method is provided for the detection of the presence or absence of a genetic marker in a fetus by detecting the presence or absence of the genetic marker in a biological sample obtained from a maternal host of a fetus. The presence or absence of the genetic marker indicates the presence or absence of the genetic condition.

In some aspects, the invention provides first detecting the presence of fetal DNA in a sample from a maternal host of fetus by the methods described above, then testing the detected fetal DNA for the presence or absence of a genetic marker associated with a disease or condition.

By “genetic marker” is meant any genetic marker known to be associated with a disease or condition. In one embodiment, the genetic marker is located within a chromosomal location conserved in cell free fetal DNA in the biological sample of the maternal host. For example, the chromosomal location is one or more of the chromosomal locations/genes listed in Table 2. In some embodiments, a condition is detected in a fetus by detecting the presence or absence of a marker located in just one chromosomal location listed in Table 2. In other embodiments, a condition is detected in a fetus by detecting the presence or absence of more than one genetic markers, for example two, three, four, five, or more than five markers in one or more chromosomal locations/genes listed in Table 2. In some embodiments, the genetic marker can be a mutation in the one or more chromosomal locations or genes listed in Table 2. The mutation can be an insertion, deletion, frame shift, substitution, or any other mutations known in the art.

The presence or absence of the genetic marker can be determined by any method known in the art, for example, DNA sequencing, or PCR.

In some embodiments, the presence or absence of the one or more genetic markers can be detected in enriched fetal DNA derived from a whole blood sample from the maternal host of the fetus. By way of example, a whole blood sample may be taken from the maternal host of the fetus and size fractionated as described above, to obtain a sample of enriched fetal DNA. The enriched fetal DNA is then tested by any method known in the art, for example, DNA sequencing or PCR, to detect the presence or absence of a genetic marker within one or more chromosomal locations listed in Table 2. The results of the fetal DNA testing done by this method may be further compared against the same genetic marker testing of un-enriched whole blood derived from the mother, or fractionated DNA of larger size containing maternal DNA or a DNA sample obtained from the maternal host prior to pregnancy to confirm the presence or absence of the genetic marker is being detected in the fetal DNA and not the maternal DNA.

The genetic condition to be detected can be any condition listed in Table 2. For example, the condition can be spinal muscular atrophy and may be detected by detecting the presence of one or more genetic markers within the 5q13-5q13 chromosomal location.

The methods of the present invention are also useful in detecting the presence or absence of aneuploidies, including monosomies or trisomies. For example, the methods of the current invention are useful in detecting trisomy 13, 14, 15, 16, 18, 21, 22, X, and/or Y. In a specific embodiment, trisomy 21 is detected by measuring the DCR gene located at chromosome 21q22.2-21q22.3, the CBS gene located at chromosome 21q22.2-21q22.3, the KNO gene at 21q22.3-21q22.3 and/or the SOD1 gene at chromosoome 21q22.1-21q22.1 or any combination thereof.

The current invention further provides for a method for selecting a genetic marker for determining the genetic condition of a fetus in a biological sample of a maternal host of a fetus. In this aspect of the invention, a genetic marker is selected by first identifying a group of genetic markers associated with the genetic condition to be determined for the fetus followed by determining which of these markers among the group of genetic markers identified as being associated with the particular condition fall within one or more chromosomal locations conserved in cell free fetal DNA in the maternal host of the mother. Next, the subset of markers that fall within these one or more chromosomal locations is selected for assay testing, for example, PCR or DNA sequencing analysis to determine the presence or absence of the marker. Lastly, the biological sample is assayed for the presence or absence of the selected genetic marker and the genetic condition of the fetus is determined based on the results of the assay.

In addition to methods of detecting and characterizing fetal DNA and methods of selecting genetic markers, the invention also provides for a database in a computer readable medium comprising the conserved genomic segments in Table 1. In a particular embodiment, the database is searchable based on an identifier for each conserved genomic segment provided in Table 1. Such identifiers include, but are not limited to, the chromosomal location, the alignment probe ID, the sequence of the segment, gene symbol, the accession number, the segment description, and any other useful identifier.

The invention also provides for a computer readable medium comprising the chromosomal locations provided for in Table 2. In a particular embodiment, the database is searchable based on identifiers for each of the chromosomal locations provided in Table 2. Such identifiers include, but are not limited to, gene name, genbank ID number, gene sequence, chromosomal location, associated genetic condition, and any other useful identifier.

The invention also provides arrays of probes useful for genetic testing of fetal DNA and/or fetal conditions. In one embodiment, the array of the present invention includes probes useful for detecting one or more genetic markers within one or more chromosomal locations listed in Table 2. In one embodiment, the array of the present invention includes probes useful for detecting one or more conserved segments provided in Table 1. In another embodiment, the array contains one or more, or 10 or more or 50 or more or 100 or more defined DNA probes selected from those listed in Table 1 which can be hybridized to the DNA derived from the maternal biological sample to detect and increase or decrease in copy number changes in the DNA. In this embodiment, the array can detect an increase or decrease in the copy number of any particular DNA region encompassed within a particular probe, thereby signifying an increased copy number and the presence of fetal DNA. In some embodiments, the array is customized to detect only certain chromosomal locations corresponding to particular genetic markers in Table 2 which are useful in detecting a particular condition, for example, trisomy. In this embodiment, probes from Table 1 are selected which correspond to the chromosomal locations encompassing the genetic markers of the particular genes of interest listed in Table 2. In other embodiments, the array contains a random sampling of the probes listed in Table 1. In another embodiment, the array contains all of the probes listed in Table 1. In some embodiments, the probes are attached to the array ready for hybridization of DNA from the maternal biological sample. In other embodiments, the probes are contained in solution ready for attachment by the end user. In this embodiment, the array may be customized by the end user to allow attachment of only particular probes of interest.

TABLE 1

| Chromosomal | Agilent | Gene | | |
|---|---|---|---|---|
| Location | Probe ID | Symbol | Accession | Description |
| hs\|chr1: 114435166-114435226 | A_16_P15264986 | entg\|SYT6 | ref\|NM_205848 | ref\|Homo sapiens synaptotagmin VI |
| | | | | (SYT6), mRNA. |
| hs\|chr1: 114743586-114743645 | A_14_P112940 | entg\|TRIM33 | ref\|NM_015906\| | ref\|Homo sapiens tripartite motif- |
| | | | ref\|NM_033020 | containing 33 (TRIM33), transcript |
| | | | | variant a, mRNA. |
| hs\|chr1: 114913877-114913937 | A_16_P15266009 | entg\|BCAS2 | ref\|NM_005872 | ref\|Homo sapiens breast carcinoma |
| | | | | amplified sequence 2 (BCAS2), |
| | | | | mRNA. |
| hs\|chr1: 114931604-114931662 | A_16_P15266059 | entg\|DENND2C | ref\|NM_198459 | ref\|Homo sapiens DENN/MADD |
| | | | | domain containing 2C (DENND2C), |
| | | | | mRNA. |
| hs\|chr1: 115017266-115017326 | A_14_P105570 | entg\|AMPD1 | ref\|NM_000036 | ref\|Homo sapiens adenosine |
| | | | | monophosphate deaminase 1 |
| | | | | (isoform M) (AMPD1), mRNA. |
| hs\|chr1: 115053836-115053896 | A_14_P103853 | entg\|NRAS | ref\|NM_002524 | ref\|Homo sapiens neuroblastoma |
| | | | | RAS viral (v-ras) oncogene homolog |
| | | | | (NRAS), mRNA. |
| hs\|chr1: 115070345-115070405 | A_16_P00151987 | entg\|CSDE1 | ref\|NM_001007553\| | ref\|Homo sapiens cold shock domain |
| | | | ref\| | containing E1, RNA-binding |
| | | | NM_007158 | (CSDE1), transcript variant 1, |
| | | | | mRNA. |
| hs\|chr1: 115120477-115120537 | A_14_P103084 | entg\|SIKE | ref\|NM_025073 | ref\|Homo sapiens suppressor of IKK |
| | | | | epsilon (SIKE), mRNA. |
| hs\|chr1: 12214130-12214190 | A_16_P35031747 | entg\|VPS13D | ref\|NM_015378\| | ref\|Homo sapiens vacuolar protein |
| | | | ref\|NM_018156 | sorting 13 homolog D (S. cerevisiae) |
| | | | | (VPS13D), transcript variant 1, |
| | | | | mRNA. |
| hs\|chr1: 12550506-12550566 | A_16_P00016149 | entg\|DHRS3 | ref\|NM_004753 | ref\|Homo sapiens |
| | | | | dehydrogenase/reductase (SDR |
| | | | | family) member 3 (DHRS3), mRNA. |
| hs\|chr1: 12632722-12632782 | A_14_P127931 | entg\|AADACL4 | ref\|NM_001013630 | ref\|Homo sapiens arylacetamide |
| | | | | deacetylase-like 4 (AADACL4), |
| | | | | mRNA. |
| hs\|chr1: 12776478-12776535 | A_16_P00016397 | entg\|PRAMEF1 | ref\|NM_023013 | ref\|Homo sapiens PRAME family |
| | | | | member 1 (PRAMEF1), mRNA. |
| hs\|chr1: 143623627-143623687 | A_16_P15281639 | entg\|PDE4DIP | ref\|NM_014644\| | ref\|Homo sapiens phosphodiesterase |
| | | | ref\|NM_001002811\| | 4D interacting protein (myomegalin) |
| | | | ref\|NM_001002812 | (PDE4DIP), transcript variant 1, |
| | | | | mRNA. |
| hs\|chr1: 143815232-143815289 | A_14_P105608 | entg\|SEC22B | ref\|NM_004892 | ref\|Homo sapiens SEC22 vesicle |
| | | | | trafficking protein homolog B (S. cerevisiae) |
| | | | | (SEC22B), mRNA. |
| hs\|chr1: 144124744-144124804 | A_14_P131300 | entg\|HFE2 | ref\|NM_145277\| | ref\|Homo sapiens hemochromatosis |
| | | | ref\|NM_202004\| | type 2 (juvenile) (HFE2), transcript |
| | | | ref\| | variant b, mRNA. |
| | | | NM_213652\| | |
| | | | ref\|NM_213653 | |
| hs\|chr1: 144151603-144151663 | A_14_P137169 | entg\|TXNIP | ref\|NM_006472 | ref\|Homo sapiens thioredoxin |
| | | | | interacting protein (TXNIP), mRNA. |
| hs\|chr1: 144168032-144168092 | A_14_P112233 | entg\|POLR3GL | ref\|NM_032305 | ref\|Homo sapiens polymerase (RNA) |
| | | | | III (DNA directed) polypeptide G |
| | | | | (32 kD)-like (POLR3GL), mRNA. |
| hs\|chr1: 144185298-144185345 | A_16_P35294813 | entg\|ANKRD34 | ref\|NM_001039888 | ref\|Homo sapiens ankyrin repeat |
| | | | | domain 34 (ANKRD34), mRNA. |
| hs\|chr1: 144188985-144189045 | A_14_P122491 | entg\|LIX1L | ref\|NM_153713 | ref\|Homo sapiens Lix1 homolog |
| | | | | (mouse)-like (LIX1L), mRNA. |
| hs\|chr1: 144219514-144219565 | A_14_P116802 | entg\|RBM8A | ref\|NM_005105 | ref\|Homo sapiens RNA binding |
| | | | | motif protein 8A (RBM8A), mRNA. |
| hs\|chr1: 144232911-144232971 | A_14_P102523 | entg\|PEX11B | ref\|NM_003846 | ref\|Homo sapiens peroxisomal |
| | | | | biogenesis factor 11B (PEX11B), |
| | | | | mRNA. |
| hs\|chr1: 144236527-144236587 | A_16_P35294963 | entg\|ITGA10 | ref\|NM_003637 | ref\|Homo sapiens integrin, alpha 10 |
| | | | | (ITGA10), mRNA. |
| hs\|chr1: 144288579-144288637 | A_14_P134227 | entg\|PIAS3 | ref\|NM_006099 | ref\|Homo sapiens protein inhibitor of |
| | | | | activated STAT, 3 (PIAS3), mRNA. |
| hs\|chr1: 144298474-144298532 | A_16_P00159877 | entg\|NUDT17 | ref\|NM_001012758 | ref\|Homo sapiens nudix (nucleoside |
| | | | | diphosphate linked moiety X)-type |
| | | | | motif 17 (NUDT17), mRNA. |
| hs\|chr1: 144308251-144308311 | A_14_P122423 | entg\|POLR3C | ref\|NM_006468 | ref\|Homo sapiens polymerase (RNA) |
| | | | | III (DNA directed) polypeptide C |
| | | | | (62 kD) (POLR3C), mRNA. |
| hs\|chr1: 144337593-144337653 | A_16_P15283520 | entg\|ZNF364 | ref\|NM_014455 | ref\|Homo sapiens zinc finger protein |
| | | | | 364 (ZNF364), mRNA. |
| hs\|chr1: 144407857-144407917 | A_14_P102237 | entg\|CD160 | ref\|NM_007053 | ref\|Homo sapiens CD160 molecule |
| | | | | (CD160), mRNA. |
| hs\|chr1: 144440681-144440741 | A_16_P35295539 | entg\|PDZK1 | ref\|NM_002614 | ref\|Homo sapiens PDZ domain |
| | | | | containing 1 (PDZK1), mRNA. |
| hs\|chr1: 144764770-144764828 | A_16_P35296161 | entg\|NBPF11 | ref\|NM_183372 | ref\|Homo sapiens neuroblastoma |
| | | | | breakpoint family, member 11 |
| | | | | (NBPF11), mRNA. |
| hs\|chr1: 150903667-150903712 | A_14_P200034 | entg\|LCE2D | ref\|NM_178430 | ref\|Homo sapiens late cornified |
| | | | | envelope 2D (LCE2D), mRNA. |
| hs\|chr1: 150915503-150915553 | A_14_P200035 | entg\|LCE2C | ref\|NM_178429 | ref\|Homo sapiens late cornified |
| | | | | envelope 2C (LCE2C), mRNA. |
| hs\|chr1: 150926290-150926344 | A_14_P133620 | entg\|LCE2B | ref\|NM_014357 | ref\|Homo sapiens late cornified |
| | | | | envelope 2B (LCE2B), mRNA. |
| hs\|chr1: 150937952-150938009 | A_14_P100722 | entg\|LCE2A | ref\|NM_178428 | ref\|Homo sapiens late cornified |
| | | | | envelope 2A (LCE2A), mRNA. |
| hs\|chr1: 150999073-150999133 | A_16_P00165508 | entg\|KPRP | ref\|NM_001025231 | ref\|Homo sapiens keratinocyte |
| | | | | proline-rich protein (KPRP), mRNA. |
| hs\|chr1: 151026227-151026285 | A_14_P131413 | entg\|LCE1E | ref\|NM_178353 | ref\|Homo sapiens late cornified |
| | | | | envelope 1E (LCE1E), mRNA. |
| hs\|chr1: 151036434-151036494 | A_16_P35310000 | entg\|LCE1D | ref\|NM_178352 | ref\|Homo sapiens late cornified |
| | | | | envelope 1D (LCE1D), mRNA. |
| hs\|chr1: 151044658-151044718 | A_14_P138003 | entg\|LCE1C | ref\|NM_178351 | ref\|Homo sapiens late cornified |
| | | | | envelope 1C (LCE1C), mRNA. |
| hs\|chr1: 151051979-151052027 | A_14_P134645 | entg\|LCE1B | ref\|NM_178349 | ref\|Homo sapiens late cornified |
| | | | | envelope 1B (LCE1B), mRNA. |
| hs\|chr1: 151121644-151121704 | A_14_P131912 | entg\|SMCP | ref\|NM_030663 | ref\|Homo sapiens sperm |
| | | | | mitochondria-associated cysteine- |
| | | | | rich protein (SMCP), nuclear gene |
| | | | | encoding mitochondrial protein, |
| | | | | mRNA. |
| hs\|chr1: 151148957-151149005 | A_14_P120925 | entg\|IVL | ref\|NM_005547 | ref\|Homo sapiens involucrin (IVL), |
| | | | | mRNA. |
| hs\|chr1: 151210846-151210906 | A_14_P122655 | entg\|SPRR4 | ref\|NM_173080 | ref\|Homo sapiens small proline-rich |
| | | | | protein 4 (SPRR4), mRNA. |
| hs\|chr1: 151224196-151224256 | A_14_P124410 | entg\|SPRR1A | ref\|NM_005987 | ref\|Homo sapiens small proline-rich |
| | | | | protein 1A (SPRR1A), mRNA. |
| hs\|chr1: 151242009-151242069 | A_14_P116391 | entg\|SPRR3 | ref\|NM_005416 | ref\|Homo sapiens small proline-rich |
| | | | | protein 3 (SPRR3), mRNA. |
| hs\|chr1: 151271033-151271088 | A_14_P120073 | entg\|SPRR1B | ref\|NM_003125 | ref\|Homo sapiens small proline-rich |
| | | | | protein 1B (cornifin) (SPRR1B), |
| | | | | mRNA. |
| hs\|chr1: 151280809-151280869 | A_16_P15297784 | entg\|SPRR2D | ref\|NM_006945 | ref\|Homo sapiens small proline-rich |
| | | | | protein 2D (SPRR2D), mRNA. |
| hs\|chr1: 151443781-151443841 | A_16_P00166054 | entg\|LELP1 | ref\|NM_001010857 | ref\|Homo sapiens late cornified |
| | | | | envelope-like proline-rich 1 |
| | | | | (LELP1), mRNA. |
| hs\|chr1: 151500023-151500072 | A_14_P110433 | entg\|LOR | ref\|NM_000427 | ref\|Homo sapiens loricrin (LOR), |
| | | | | mRNA. |
| hs\|chr1: 151541460-151541519 | A_16_P15298291 | entg\|PGLYRP3 | ref\|NM_052891 | ref\|Homo sapiens peptidoglycan |
| | | | | recognition protein 3 (PGLYRP3), |
| | | | | mRNA. |
| hs\|chr1: 151576489-151576549 | A_14_P102942 | entg\|PGLYRP4 | ref\|NM_020393 | ref\|Homo sapiens peptidoglycan |
| | | | | recognition protein 4 (PGLYRP4), |
| | | | | mRNA. |
| hs\|chr1: 151599178-151599238 | A_14_P100749 | entg\|S100A9 | ref\|NM_002965 | ref\|Homo sapiens S100 calcium |
| | | | | binding protein A9 (S100A9), |
| | | | | mRNA. |
| hs\|chr1: 151612984-151613042 | A_14_P124338 | entg\|S100A12 | ref\|NM_005621 | ref\|Homo sapiens S100 calcium |
| | | | | binding protein A12 (S100A12), |
| | | | | mRNA. |
| hs\|chr1: 151629265-151629319 | A_14_P105363 | entg\|S100A8 | ref\|NM_002964 | ref\|Homo sapiens S100 calcium |
| | | | | binding protein A8 (S100A8), |
| | | | | mRNA. |
| hs\|chr1: 151657016-151657076 | A_14_P106240 | entg\|S100A7A | ref\|NM_176823 | ref\|Homo sapiens S100 calcium |
| | | | | binding protein A7A (S100A7A), |
| | | | | mRNA. |
| hs\|chr1: 151676848-151676908 | A_16_P15298617 | entg\|S100A7L2 | ref\|NM_001045479 | ref\|Homo sapiens S100 calcium |
| | | | | binding protein A7-like 2 |
| | | | | (S100A7L2), mRNA. |
| hs\|chr1: 151698217-151698277 | A_14_P125828 | entg\|S100A7 | ref\|NM_002963 | ref\|Homo sapiens S100 calcium |
| | | | | binding protein A7 (S100A7), |
| | | | | mRNA. |
| hs\|chr1: 151780744-151780804 | A_16_P00166502 | entg\|S100A5 | ref\|NM_002962 | ref\|Homo sapiens S100 calcium |
| | | | | binding protein A5 (S100A5), |
| | | | | mRNA. |
| hs\|chr1: 151800251-151800311 | A_16_P15298906 | entg\|S100A2 | ref\|NM_005978 | ref\|Homo sapiens S100 calcium |
| | | | | binding protein A2 (S100A2), |
| | | | | mRNA. |
| hs\|chr1: 151851895-151851947 | A_14_P118231 | entg\|S100A16 | ref\|NM_080388 | ref\|Homo sapiens S100 calcium |
| | | | | binding protein A16 (S100A16), |
| | | | | mRNA. |
| hs\|chr1: 151854423-151854471 | A_14_P107098 | entg\|S100A14 | ref\|NM_020672 | ref\|Homo sapiens S100 calcium |
| | | | | binding protein A14 (S100A14), |
| | | | | mRNA. |
| hs\|chr1: 151859028-151859088 | A_14_P105005 | entg\|S100A13 | ref\|NM_001024213\| | ref\|Homo sapiens S100 calcium |
| | | | ref\| | binding protein A13 (S100A13), |
| | | | NM_001024212\| | transcript variant 5, mRNA. |
| | | | ref\|NM_001024211\| | |
| | | | ref\|NM_005979\| | |
| | | | ref\| | |
| | | | NM_001024210 | |
| hs\|chr1: 151900853-151900913 | A_14_P123709 | entg\|SNAPAP | ref\|NM_012437 | ref\|Homo sapiens SNAP-associated |
| | | | | protein (SNAPAP), mRNA. |
| hs\|chr1: 151901906-151901966 | A_14_P123851 | entg\|ILF2 | ref\|NM_004515 | ref\|Homo sapiens interleukin |
| | | | | enhancer binding factor 2, 45 kDa |
| | | | | (ILF2), mRNA. |
| hs\|chr1: 151920328-151920380 | A_14_P125388 | entg\|NPR1 | ref\|NM_000906 | ref\|Homo sapiens natriuretic peptide |
| | | | | receptor A/guanylate cyclase A |
| | | | | (atrionatriuretic peptide receptor A) |
| | | | | (NPR1), mRNA. |
| hs\|chr1: 151968127-151968187 | A_16_P00166729 | entg\|INTS3 | ref\|NM_023015 | ref\|Homo sapiens integrator complex |
| | | | | subunit 3 (INTS3), mRNA. |
| hs\|chr1: 152018088-152018140 | A_14_P120830 | entg\|SLC27A3 | ref\|NM_024330 | ref\|Homo sapiens solute carrier |
| | | | | family 27 (fatty acid transporter), |
| | | | | member 3 (SLC27A3), mRNA. |
| hs\|chr1: 152047064-152047124 | A_14_P106047 | entg\|GATAD2B | ref\|NM_020699 | ref\|Homo sapiens GATA zinc finger |
| | | | | domain containing 2B (GATAD2B), |
| | | | | mRNA. |
| hs\|chr1: 16799333-16799393 | A_16_P15040292 | entg\|NBPF1 | ref\|NM_017940 | ref\|Homo sapiens neuroblastoma |
| | | | | breakpoint family, member 1 |
| | | | | (NBPF1), mRNA. |
| hs\|chr1: 171715748-171715808 | A_16_P00193532 | entg\|PRDX6 | ref\|NM_004905 | ref\|Homo sapiens peroxiredoxin 6 |
| | | | | (PRDX6), mRNA. |
| hs\|chr1: 171736794-171736854 | A_16_P35360428 | entg\|SLC9A11 | ref\|NM_178527 | ref\|Homo sapiens solute carrier |
| | | | | family 9, member 11 (SLC9A11), |
| | | | | mRNA. |
| hs\|chr1: 171956212-171956272 | A_16_P35360836 | entg\|KLHL20 | ref\|NM_014458 | ref\|Homo sapiens kelch-like 20 |
| | | | | (Drosophila) (KLHL20), mRNA. |
| hs\|chr1: 172039213-172039273 | A_16_P35360976 | entg\|CENPL | ref\|NM_033319 | ref\|Homo sapiens centromere protein |
| | | | | L (CENPL), mRNA. |
| hs\|chr1: 172064084-172064144 | A_16_P00193883 | entg\|DARS2 | ref\|NM_018122 | ref\|Homo sapiens aspartyl-tRNA |
| | | | | synthetase 2, mitochondrial |
| | | | | (DARS2), mRNA. |
| hs\|chr1: 172104549-172104596 | A_14_P105924 | entg\|ZBTB37 | ref\|NM_032522 | ref\|Homo sapiens zinc finger and |
| | | | | BTB domain containing 37 |
| | | | | (ZBTB37), mRNA. |
| hs\|chr1: 172139669-172139729 | A_16_P35361267 | entg\|SERPINC1 | ref\|NM_000488 | ref\|Homo sapiens serpin peptidase |
| | | | | inhibitor, clade C (antithrombin), |
| | | | | member 1 (SERPINC1), mRNA. |
| hs\|chr1: 172174438-172174498 | A_16_P15345792 | entg\|RC3H1 | ref\|NM_172071 | ref\|Homo sapiens ring finger and |
| | | | | CCCH-type zinc finger domains 1 |
| | | | | (RC3H1), mRNA. |
| hs\|chr1: 172403349-172403409 | A_16_P35361795 | entg\|RABGAP1L | ref\|NM_014857 | ref\|Homo sapiens RAB GTPase |
| | | | | activating protein 1-like |
| | | | | (RABGAP1L), transcript variant 1, |
| | | | | mRNA. |
| hs\|chr1: 173237005-173237065 | A_16_P15347942 | entg\|CACYBP | ref\|NM_001007214\| | ref\|Homo sapiens calcyclin binding |
| | | | ref\| | protein (CACYBP), transcript |
| | | | NM_014412 | variant 2, mRNA. |
| hs\|chr1: 173249841-173249901 | A_14_P137189 | entg\|MRPS14 | ref\|NM_022100 | ref\|Homo sapiens mitochondrial |
| | | | | ribosomal protein S14 (MRPS14), |
| | | | | nuclear gene encoding mitochondrial |
| | | | | protein, mRNA. |
| hs\|chr1: 173311424-173311484 | A_16_P15348134 | entg\|TNN | ref\|NM_022093 | ref\|Homo sapiens tenascin N (TNN), |
| | | | | mRNA. |
| hs\|chr1: 173563122-173563182 | A_16_P35364331 | entg\|TNR | ref\|NM_003285 | ref\|Homo sapiens tenascin R |
| | | | | (restrictin, janusin) (TNR), mRNA. |
| hs\|chr1: 174187052-174187112 | A_16_P15350466 | entg\|RFWD2 | ref\|NM_001001740\| | ref\|Homo sapiens ring finger and |
| | | | ref\| | WD repeat domain 2 (RFWD2), |
| | | | NM_022457 | transcript variant 2, mRNA. |
| hs\|chr1: 174699129-174699188 | A_14_P121406 | entg\|PAPPA2 | ref\|NM_021936\| | ref\|Homo sapiens pappalysin 2 |
| | | | ref\|NM_020318 | (PAPPA2), transcript variant 2, |
| | | | | mRNA. |
| hs\|chr1: 175097268-175097326 | A_16_P00198075 | entg\|ASTN1 | ref\|NM_004319 | ref\|Homo sapiens astrotactin 1 |
| | | | | (ASTN1), transcript variant 1, |
| | | | | mRNA. |
| hs\|chr1: 175407389-175407438 | A_14_P104389 | entg\|FAM5B | ref\|NM_021165 | ref\|Homo sapiens family with |
| | | | | sequence similarity 5, member B |
| | | | | (FAM5B), mRNA. |
| hs\|chr1: 201711813-201711873 | A_16_P15416146 | entg\|PRELP | ref\|NM_002725\| | ref\|Homo sapiens proline/arginine- |
| | | | ref\|NM_201348 | rich end leucine-rich repeat protein |
| | | | | (PRELP), transcript variant 1, |
| | | | | mRNA. |
| hs\|chr1: 201736742-201736802 | A_16_P15416233 | entg\|OPTC | ref\|NM_014359 | ref\|Homo sapiens opticin (OPTC), |
| | | | | mRNA. |
| hs\|chr1: 201872544-201872604 | A_14_P104923 | entg\|ATP2B4 | ref\|NM_001001396\| | ref\|Homo sapiens ATPase, Ca++ |
| | | | ref\| | transporting, plasma membrane 4 |
| | | | NM_001684 | (ATP2B4), transcript variant 1, |
| | | | | mRNA. |
| hs\|chr1: 202001149-202001197 | A_14_P123051 | entg\|LAX1 | ref\|NM_017773 | ref\|Homo sapiens lymphocyte |
| | | | | transmembrane adaptor 1 (LAX1), |
| | | | | mRNA. |
| hs\|chr1: 202035642-202035702 | A_14_P109305 | entg\|ZC3H11A | ref\|NM_014827 | ref\|Homo sapiens zinc finger CCCH- |
| | | | | type containing 11A (ZC3H11A), |
| | | | | mRNA. |
| hs\|chr1: 202104164-202104224 | A_14_P124920 | entg\|SNRPE | ref\|NM_003094 | ref\|Homo sapiens small nuclear |
| | | | | ribonucleoprotein polypeptide E |
| | | | | (SNRPE), mRNA. |
| hs\|chr1: 202316986-202317046 | A_16_P00236486 | entg\|SOX13 | ref\|NM_005686 | ref\|Homo sapiens SRY (sex |
| | | | | determining region Y)-box 13 |
| | | | | (SOX13), mRNA. |
| hs\|chr1: 202368515-202368575 | A_16_P00236579 | entg\|ETNK2 | ref\|NM_018208 | ref\|Homo sapiens ethanolamine |
| | | | | kinase 2 (ETNK2), mRNA. |
| hs\|chr1: 202395021-202395081 | A_16_P15417739 | entg\|REN | ref\|NM_000537 | ref\|Homo sapiens renin (REN), |
| | | | | mRNA. |
| hs\|chr1: 21640254-21640312 | A_16_P00027100 | entg\|NBPF3 | ref\|NM_032264 | ref\|Homo sapiens neuroblastoma |
| | | | | breakpoint family, member 3 |
| | | | | (NBPF3), mRNA. |
| hs\|chr1: 21710313-21710371 | A_16_P00027150 | entg\|ALPL | ref\|NM_000478 | ref\|Homo sapiens alkaline |
| | | | | phosphatase, liver/bone/kidney |
| | | | | (ALPL), mRNA. |
| hs\|chr1: 21802090-21802142 | A_14_P116283 | entg\|RAP1GAP | ref\|NM_002885 | ref\|Homo sapiens RAP1 GTPase |
| | | | | activating protein (RAP1GAP), |
| | | | | mRNA. |
| hs\|chr1: 21879814-21879874 | A_16_P15052586 | entg\|USP48 | ref\|NM_032236 | ref\|Homo sapiens ubiquitin specific |
| | | | | peptidase 48 (USP48), transcript |
| | | | | variant 1, mRNA. |
| hs\|chr1: 22015677-22015726 | A_16_P00027573 | entg\|LDLRAD2 | ref\|NM_001013693 | ref\|Homo sapiens low density |
| | | | | lipoprotein receptor class A domain |
| | | | | containing 2 (LDLRAD2), mRNA. |
| hs\|chr1: 22026614-22026670 | A_16_P15052868 | entg\|HSPG2 | ref\|NM_005529 | ref\|Homo sapiens heparan sulfate |
| | | | | proteoglycan 2 (HSPG2), mRNA. |
| hs\|chr1: 22181194-22181250 | A_14_P119507 | entg\|ELA3B | ref\|NM_007352 | ref\|Homo sapiens elastase 3B, |
| | | | | pancreatic (ELA3B), mRNA. |
| hs\|chr1: 22200840-22200890 | A_16_P15053306 | entg\|ELA3A | ref\|NM_005747 | ref\|Homo sapiens elastase 3A, |
| | | | | pancreatic (ELA3A), mRNA. |
| hs\|chr1: 22255558-22255618 | A_14_P135733 | entg\|CDC42 | ref\|NM_044472\| | ref\|Homo sapiens cell division cycle |
| | | | ref\|NM_001039802\| | 42 (GTP binding protein, 25 kDa) |
| | | | ref\|NM_001791 | (CDC42), transcript variant 2, |
| | | | | mRNA. |
| hs\|chr1: 26615501-26615561 | A_16_P00033348 | entg\|LIN28 | ref\|NM_024674 | ref\|Homo sapiens lin-28 homolog |
| | | | | (C. elegans) (LIN28), mRNA. |
| hs\|chr1: 26632107-26632167 | A_14_P123708 | entg\|DHDDS | ref\|NM_024887\| | ref\|Homo sapiens dehydrodolichyl |
| | | | ref\|NM_205861 | diphosphate synthase (DHDDS), |
| | | | | transcript variant 1, mRNA. |
| hs\|chr1: 26673244-26673303 | A_14_P101569 | entg\|HMGN2 | ref\|NM_005517 | ref\|Homo sapiens high-mobility |
| | | | | group nucleosomal binding domain 2 |
| | | | | (HMGN2), mRNA. |
| hs\|chr1: 26730653-26730710 | A_16_P00033466 | entg\|RPS6KA1 | ref\|NM_002953 | ref\|Homo sapiens ribosomal protein |
| | | | | S6 kinase, 90 kDa, polypeptide 1 |
| | | | | (RPS6KA1), transcript variant 1, |
| | | | | mRNA. |
| hs\|chr1: 26899253-26899313 | A_14_P114927 | entg\|ARID1A | ref\|NM_006015\| | ref\|Homo sapiens AT rich interactive |
| | | | ref\|NM_139135 | domain 1A (SWI-like) (ARID1A), |
| | | | | transcript variant 1, mRNA. |
| hs\|chr1: 26995763-26995823 | A_14_P138024 | entg\|PIGV | ref\|NM_017837 | ref\|Homo sapiens |
| | | | | phosphatidylinositol glycan anchor |
| | | | | biosynthesis, class V (PIGV), |
| | | | | mRNA. |
| hs\|chr1: 27034390-27034450 | A_16_P15064276 | entg\|ZDHHC18 | ref\|NM_032283 | ref\|Homo sapiens zinc finger, |
| | | | | DHHC-type containing 18 |
| | | | | (ZDHHC18), mRNA. |
| hs\|chr1: 27063474-27063522 | A_14_P133833 | entg\|SFN | ref\|NM_006142 | ref\|Homo sapiens stratifin (SFN), |
| | | | | mRNA. |
| hs\|chr1: 27083378-27083438 | A_14_P132631 | entg\|ATPBD1B | ref\|NM_018066 | ref\|Homo sapiens ATP binding |
| | | | | domain 1 family, member B |
| | | | | (ATPBD1B), mRNA. |
| hs\|chr1: 27090489-27090549 | A_16_P15064409 | entg\|GPATCH3 | ref\|NM_022078 | ref\|Homo sapiens G patch domain |
| | | | | containing 3 (GPATCH3), mRNA. |
| hs\|chr1: 27110544-27110604 | A_14_P117463 | entg\|NR0B2 | ref\|NM_021969 | ref\|Homo sapiens nuclear receptor |
| | | | | subfamily 0, group B, member 2 |
| | | | | (NR0B2), mRNA. |
| hs\|chr1: 27124258-27124318 | A_14_P117899 | entg\|NUDC | ref\|NM_006600 | ref\|Homo sapiens nuclear |
| | | | | distribution gene C homolog (A. nidulans) |
| | | | | (NUDC), mRNA. |
| hs\|chr1: 27194323-27194377 | A_16_P15064612 | entg\|LOC388610 | ref\|NM_001013642 | ref\|Homo sapiens hypothetical |
| | | | | LOC388610 (LOC388610), mRNA. |
| hs\|chr1: 27204091-27204151 | A_16_P00034027 | entg\|FAM46B | ref\|NM_052943 | ref\|Homo sapiens family with |
| | | | | sequence similarity 46, member B |
| | | | | (FAM46B), mRNA. |
| hs\|chr1: 27298609-27298668 | A_14_P101060 | entg\|SLC9A1 | ref\|NM_003047 | ref\|Homo sapiens solute carrier |
| | | | | family 9 (sodium/hydrogen |
| | | | | exchanger), member 1 (antiporter, |
| | | | | Na+/H+, amiloride sensitive) |
| | | | | (SLC9A1), mRNA. |
| hs\|chr1: 27435269-27435329 | A_16_P35069118 | entg\|WDTC1 | ref\|NM_015023 | ref\|Homo sapiens WD and |
| | | | | tetratricopeptide repeats 1 (WDTC1), |
| | | | | mRNA. |
| hs\|chr1: 3758805-3758856 | A_14_P109063 | entg\|KIAA0562 | ref\|NM_014704 | ref\|Homo sapiens KIAA0562 |
| | | | | (KIAA0562), mRNA. |
| hs\|chr1: 3765500-3765559 | A_14_P106949 | entg\|DFFB | ref\|NM_001004285\| | ref\|Homo sapiens DNA |
| | | | ref\| | fragmentation factor, 40 kDa, beta |
| | | | NM_001004286\| | polypeptide (caspase-activated |
| | | | ref\|NM_004402 | DNase) (DFFB), transcript variant 3, |
| | | | | mRNA. |
| hs\|chr1: 50357045-50357105 | A_16_P15115282 | entg\|ELAVL4 | ref\|NM_021952 | ref\|Homo sapiens ELAV (embryonic |
| | | | | lethal, abnormal vision, Drosophila)- |
| | | | | like 4 (Hu antigen D) (ELAVL4), |
| | | | | mRNA. |
| hs\|chr1: 50685269-50685329 | A_16_P35122952 | entg\|FAF1 | ref\|NM_007051 | ref\|Homo sapiens Fas (TNFRSF6) |
| | | | | associated factor 1 (FAF1), mRNA. |
| hs\|chr1: 71641786-71641846 | A_14_P103412 | entg\|NEGR1 | ref\|NM_173808 | ref\|Homo sapiens neuronal growth |
| | | | | regulator 1 (NEGR1), mRNA. |
| hs\|chr1: 7260321-7260381 | A_16_P35019103 | entg\|CAMTA1 | ref\|NM_015215 | ref\|Homo sapiens calmodulin |
| | | | | binding transcription activator 1 |
| | | | | (CAMTA1), mRNA. |
| hs\|chr1: 7759362-7759422 | A_14_P201873 | entg\|VAMP3 | ref\|NM_004781 | ref\|Homo sapiens vesicle-associated |
| | | | | membrane protein 3 (cellubrevin) |
| | | | | (VAMP3), mRNA. |
| hs\|chr1: 78858785-78858845 | A_16_P00102704 | entg\|IFI44L | ref\|NM_006820 | ref\|Homo sapiens interferon-induced |
| | | | | protein 44-like (IFI44L), mRNA. |
| hs\|chr1: 78888581-78888641 | A_14_P139629 | entg\|IFI44 | ref\|NM_006417 | ref\|Homo sapiens interferon-induced |
| | | | | protein 44 (IFI44), mRNA. |
| hs\|chr2: 100376586-100376646 | A_16_P15757121 | entg\|CHST10 | ref\|NM_004854 | ref\|Homo sapiens carbohydrate |
| | | | | sulfotransferase 10 (CHST10), |
| | | | | mRNA. |
| hs\|chr2: 100460091-100460151 | A_16_P15757321 | entg\|NMS | ref\|NM_001011717 | ref\|Homo sapiens neuromedin S |
| | | | | (NMS), mRNA. |
| hs\|chr2: 100546568-100546628 | A_16_P00430789 | entg\|PDCL3 | ref\|NM_024065 | ref\|Homo sapiens phosducin-like 3 |
| | | | | (PDCL3), mRNA. |
| hs\|chr2: 100809955-100810015 | A_14_P115162 | entg\|NPAS2 | ref\|NM_002518 | ref\|Homo sapiens neuronal PAS |
| | | | | domain protein 2 (NPAS2), mRNA. |
| hs\|chr2: 100988528-100988586 | A_14_P131949 | entg\|RPL31 | ref\|NM_000993 | ref\|Homo sapiens ribosomal protein |
| | | | | L31 (RPL31), mRNA. |
| hs\|chr2: 106789810-106789870 | A_16_P15772616 | entg\|ST6GAL2 | ref\|NM_032528 | ref\|Homo sapiens ST6 beta- |
| | | | | galactosamide alpha-2,6- |
| | | | | sialyltranferase 2 (ST6GAL2), |
| | | | | mRNA. |
| hs\|chr2: 121696944-121697004 | A_14_P136286 | entg\|TFCP2L1 | ref\|NM_014553 | ref\|Homo sapiens transcription factor |
| | | | | CP2-like 1 (TFCP2L1), mRNA. |
| hs\|chr2: 1888059-1888119 | A_16_P15529975 | entg\|MYT1L | ref\|NM_015025 | ref\|Homo sapiens myelin |
| | | | | transcription factor 1-like (MYT1L), |
| | | | | mRNA. |
| hs\|chr2: 191631669-191631729 | A_16_P15975025 | entg\|STAT4 | ref\|NM_003151 | ref\|Homo sapiens signal transducer |
| | | | | and activator of transcription 4 |
| | | | | (STAT4), mRNA. |
| hs\|chr2: 191822112-191822172 | A_16_P15975485 | entg\|MYO1B | ref\|NM_012223 | ref\|Homo sapiens myosin IB |
| | | | | (MYO1B), mRNA. |
| hs\|chr2: 192251588-192251648 | A_14_P200716 | entg\|OBFC2A | ref\|NM_001031716 | ref\|Homo sapiens |
| | | | | oligonucleotide/oligosaccharide- |
| | | | | binding fold containing 2A |
| | | | | (OBFC2A), mRNA. |
| hs\|chr2: 192408323-192408383 | A_16_P15977068 | entg\|SDPR | ref\|NM_004657 | ref\|Homo sapiens serum deprivation |
| | | | | response (phosphatidylserine binding |
| | | | | protein) (SDPR), mRNA. |
| hs\|chr2: 192523146-192523206 | A_14_P136809 | entg\|TMEFF2 | ref\|NM_016192 | ref\|Homo sapiens transmembrane |
| | | | | protein with EGF-like and two |
| | | | | follistatin-like domains 2 (TMEFF2), |
| | | | | mRNA. |
| hs\|chr2: 21078979-21079039 | A_16_P00328924 | entg\|APOB | ref\|NM_000384 | ref\|Homo sapiens apolipoprotein B |
| | | | | (including Ag(x) antigen) (APOB), |
| | | | | mRNA. |
| hs\|chr2: 27853994-27854054 | A_14_P125784 | entg\|MRPL33 | ref\|NM_004891\| | ref\|Homo sapiens mitochondrial |
| | | | ref\|NM_145330 | ribosomal protein L33 (MRPL33), |
| | | | | nuclear gene encoding mitochondrial |
| | | | | protein, transcript variant 1, mRNA. |
| hs\|chr2: 27859923-27859983 | A_16_P00338681 | entg\|RBKS | ref\|NM_022128 | ref\|Homo sapiens ribokinase |
| | | | | (RBKS), mRNA. |
| hs\|chr2: 42692079-42692139 | A_16_P00359953 | entg\|MTA3 | ref\|NM_020744 | ref\|Homo sapiens metastasis |
| | | | | associated 1 family, member 3 |
| | | | | (MTA3), mRNA. |
| hs\|chr2: 42844829-42844874 | A_14_P119356 | entg\|OXER1 | ref\|NM_148962 | ref\|Homo sapiens oxoeicosanoid |
| | | | | (OXE) receptor 1 (OXER1), mRNA. |
| hs\|chr2: 42849045-42849101 | A_14_P132845 | entg\|HAAO | ref\|NM_012205 | ref\|Homo sapiens 3- |
| | | | | hydroxyanthranilate 3,4-dioxygenase |
| | | | | (HAAO), mRNA. |
| hs\|chr2: 43777975-43778035 | A_16_P35656762 | entg\|PLEKHH2 | ref\|NM_172069 | ref\|Homo sapiens pleckstrin |
| | | | | homology domain containing, family |
| | | | | H (with MyTH4 domain) member 2 |
| | | | | (PLEKHH2), mRNA. |
| hs\|chr2: 43857495-43857555 | A_14_P119626 | entg\|DYNC2LI1 | ref\|NM_015522\| | ref\|Homo sapiens dynein, |
| | | | ref\|NM_001012665\| | cytoplasmic 2, light intermediate |
| | | | ref\|NM_016008 | chain 1 (DYNC2LI1), transcript |
| | | | | variant 2, mRNA. |
| hs\|chr2: 43893636-43893696 | A_16_P00361747 | entg\|ABCG5 | ref\|NM_022436 | ref\|Homo sapiens ATP-binding |
| | | | | cassette, sub-family G (WHITE), |
| | | | | member 5 (sterolin 1) (ABCG5), |
| | | | | mRNA. |
| hs\|chr2: 43924557-43924617 | A_14_P123089 | entg\|ABCG8 | ref\|NM_022437 | ref\|Homo sapiens ATP-binding |
| | | | | cassette, sub-family G (WHITE), |
| | | | | member 8 (sterolin 2) (ABCG8), |
| | | | | mRNA. |
| hs\|chr2: 43968439-43968499 | A_16_P35657379 | entg\|LRPPRC | ref\|NM_133259 | ref\|Homo sapiens leucine-rich PPR- |
| | | | | motif containing (LRPPRC), mRNA. |
| hs\|chr2: 86693898-86693958 | A_16_P15735092 | entg\|RNF103 | ref\|NM_005667 | ref\|Homo sapiens ring finger protein |
| | | | | 103 (RNF103), mRNA. |
| hs\|chr2: 86810247-86810307 | A_16_P00422801 | entg\|RMND5A | ref\|NM_022780 | ref\|Homo sapiens required for |
| | | | | meiotic nuclear division 5 homolog |
| | | | | A (S. cerevisiae) (RMND5A), |
| | | | | mRNA. |
| hs\|chr2: 86867947-86868007 | A_14_P125558 | entg\|CD8A | ref\|NM_001768\| | ref\|Homo sapiens CD8a molecule |
| | | | ref\|NM_171827 | (CD8A), transcript variant 1, mRNA. |
| hs\|chr2: 86895990-86896048 | A_16_P00422914 | entg\|CD8B | ref\|NM_172101\| | ref\|Homo sapiens CD8b molecule |
| | | | ref\|NM_172102\| | (CD8B), transcript variant 3, mRNA. |
| | | | ref\| | |
| | | | NM_172213 | |
| hs\|chr2: 88041851-88041911 | A_16_P15738329 | entg\|RGPD1 | ref\|NM_001024457 | ref\|Homo sapiens RANBP2-like and |
| | | | | GRIP domain containing 1 |
| | | | | (RGPD1), mRNA. |
| hs\|chr2: 95058559-95058619 | A_16_P15744725 | entg\|MAL | ref\|NM_002371\| | ref\|Homo sapiens mal, T-cell |
| | | | ref\|NM_022438\| | differentiation protein (MAL), |
| | | | ref\| | transcript variant a, mRNA. |
| | | | NM_022439\| | |
| | | | ref\|NM_022440 | |
| hs\|chr2: 95121911-95121971 | A_16_P35771780 | entg\|MRPS5 | ref\|NM_031902 | ref\|Homo sapiens mitochondrial |
| | | | | ribosomal protein S5 (MRPS5), |
| | | | | nuclear gene encoding mitochondrial |
| | | | | protein, mRNA. |
| hs\|chr2: 95179627-95179687 | A_16_P00424939 | entg\|ZNF514 | ref\|NM_032788 | ref\|Homo sapiens zinc finger protein |
| | | | | 514 (ZNF514), mRNA. |
| hs\|chr2: 95198203-95198263 | A_14_P139016 | entg\|ZNF2 | ref\|NM_001017396\| | ref\|Homo sapiens zinc finger protein |
| | | | ref\| | 2 (ZNF2), transcript variant 2, |
| | | | NM_021088 | mRNA. |
| hs\|chr2: 95306707-95306752 | A_16_P35772142 | entg\|PROM2 | ref\|NM_144707 | ref\|Homo sapiens prominin 2 |
| | | | | (PROM2), mRNA. |
| hs\|chr2: 95328777-95328837 | A_16_P00425133 | entg\|KCNIP3 | ref\|NM_013434 | ref\|Homo sapiens Kv channel |
| | | | | interacting protein 3, calsenilin |
| | | | | (KCNIP3), transcript variant 1, |
| | | | | mRNA. |
| hs\|chr2: 95432576-95432623 | A_16_P00425280 | entg\|FAHD2A | ref\|NM_016044 | ref\|Homo sapiens |
| | | | | fumarylacetoacetate hydrolase |
| | | | | domain containing 2A (FAHD2A), |
| | | | | mRNA. |
| hs\|chr3: 100002243-100002298 | A_14_P101043 | entg\|DCBLD2 | ref\|NM_080927 | ref\|Homo sapiens discoidin, CUB |
| | | | | and LCCL domain containing 2 |
| | | | | (DCBLD2), mRNA. |
| hs\|chr3: 112323670-112323730 | A_14_P133366 | entg\|PVRL3 | ref\|NM_015480 | ref\|Homo sapiens poliovirus |
| | | | | receptor-related 3 (PVRL3), mRNA. |
| hs\|chr3: 112743747-112743807 | A_14_P124242 | entg\|CD96 | ref\|NM_005816\| | ref\|Homo sapiens CD96 molecule |
| | | | ref\|NM_198196 | (CD96), transcript variant 2, mRNA. |
| hs\|chr3: 112881173-112881233 | A_16_P00784860 | entg\|PLCXD2 | ref\|NM_153268 | ref\|Homo sapiens |
| | | | | phosphatidylinositol-specific |
| | | | | phospholipase C, X domain |
| | | | | containing 2 (PLCXD2), mRNA. |
| hs\|chr3: 113086456-113086516 | A_14_P128736 | entg\|PHLDB2 | ref\|NM_145753 | ref\|Homo sapiens pleckstrin |
| | | | | homology-like domain, family B, |
| | | | | member 2 (PHLDB2), mRNA. |
| hs\|chr3: 113183537-113183597 | A_16_P16360301 | entg\|ABHD10 | ref\|NM_018394 | ref\|Homo sapiens abhydrolase |
| | | | | domain containing 10 (ABHD10), |
| | | | | mRNA. |
| hs\|chr3: 113200641-113200695 | A_14_P111757 | entg\|TAGLN3 | ref\|NM_001008272\| | ref\|Homo sapiens transgelin 3 |
| | | | ref\| | (TAGLN3), transcript variant 2, |
| | | | NM_013259 | mRNA. |
| hs\|chr3: 113251153-113251213 | A_16_P00785505 | entg\|TMPRSS7 | ref\|NM_001042575 | ref\|Homo sapiens transmembrane |
| | | | | protease, serine 7 (TMPRSS7), |
| | | | | mRNA. |
| hs\|chr3: 125517341-125517401 | A_16_P00802920 | entg\|KALRN | ref\|NM_003947\| | ref\|Homo sapiens kalirin, RhoGEF |
| | | | ref\|NM_001024660 | kinase (KALRN), transcript variant |
| | | | | 2, mRNA. |
| hs\|chr3: 125939142-125939202 | A_16_P16391008 | entg\|UMPS | ref\|NM_000373 | ref\|Homo sapiens uridine |
| | | | | monophosphate synthetase (orotate |
| | | | | phosphoribosyl transferase and |
| | | | | orotidine-5′-decarboxylase) (UMPS), |
| | | | | mRNA. |
| hs\|chr3: 125964672-125964732 | A_14_P101320 | entg\|ITGB5 | ref\|NM_002213 | ref\|Homo sapiens integrin, beta 5 |
| | | | | (ITGB5), mRNA. |
| hs\|chr3: 135751597-135751657 | A_16_P00816629 | entg\|CEP63 | ref\|NM_001042383\| | ref\|Homo sapiens centrosomal |
| | | | ref\| | protein 63 kDa (CEP63), transcript |
| | | | NM_001042384\| | variant 3, mRNA. |
| | | | ref\|NM_001042400\| | |
| | | | ref\|NM_025180 | |
| hs\|chr3: 135804844-135804904 | A_16_P00816689 | entg\|KY | ref\|NM_178554 | ref\|Homo sapiens kyphoscoliosis |
| | | | | peptidase (KY), mRNA. |
| hs\|chr3: 136003065-136003125 | A_16_P16414472 | entg\|EPHB1 | ref\|NM_004441 | ref\|Homo sapiens EPH receptor B1 |
| | | | | (EPHB1), mRNA. |
| hs\|chr3: 14428173-14428233 | A_16_P00652813 | entg\|SLC6A6 | ref\|NM_003043 | ref\|Homo sapiens solute carrier |
| | | | | family 6 (neurotransmitter |
| | | | | transporter, taurine), member 6 |
| | | | | (SLC6A6), mRNA. |
| hs\|chr3: 14517426-14517486 | A_16_P16137157 | entg\|GRIP2 | ref\|NM_001080423 | ref\|Homo sapiens glutamate receptor |
| | | | | interacting protein 2 (GRIP2), |
| | | | | mRNA. |
| hs\|chr3: 193790665-193790725 | A_16_P16550531 | entg\|FGF12 | ref\|NM_004113 | ref\|Homo sapiens fibroblast growth |
| | | | | factor 12 (FGF12), transcript variant |
| | | | | 2, mRNA. |
| hs\|chr3: 194443932-194443992 | A_14_P202489 | entg\|HRASLS | ref\|NM_020386 | ref\|Homo sapiens HRAS-like |
| | | | | suppressor (HRASLS), mRNA. |
| hs\|chr3: 194479850-194479909 | A_16_P16552220 | entg\|ATP13A5 | ref\|NM_198505 | ref\|Homo sapiens ATPase type 13A5 |
| | | | | (ATP13A5), mRNA. |
| hs\|chr3: 194602704-194602764 | A_16_P36601463 | entg\|ATP13A4 | ref\|NM_032279 | ref\|Homo sapiens ATPase type 13A4 |
| | | | | (ATP13A4), mRNA. |
| hs\|chr3: 194795530-194795590 | A_14_P116641 | entg\|OPA1 | ref\|NM_015560\| | ref\|Homo sapiens optic atrophy 1 |
| | | | ref\|NM_130831\| | (autosomal dominant) (OPA1), |
| | | | ref\| | nuclear gene encoding mitochondrial |
| | | | NM_130832\| | protein, transcript variant 1, mRNA. |
| | | | ref\|NM_130833\| | |
| | | | ref\|NM_130834\|ref\| | |
| | | | NM_130835\| | |
| | | | ref\|NM_130836\| | |
| | | | ref\| | |
| | | | NM_130837 | |
| hs\|chr3: 195336705-195336765 | A_14_P128502 | entg\|HES1 | ref\|NM_005524 | ref\|Homo sapiens hairy and enhancer |
| | | | | of split 1, (Drosophila) (HES1), |
| | | | | mRNA. |
| hs\|chr3: 195546341-195546401 | A_16_P00901315 | entg\|CPN2 | ref\|NM_001080513 | ref\|Homo sapiens carboxypeptidase |
| | | | | N, polypeptide 2 (CPN2), mRNA. |
| hs\|chr3: 195557831-195557891 | A_16_P00901334 | entg\|LRRC15 | ref\|NM_130830 | ref\|Homo sapiens leucine rich repeat |
| | | | | containing 15 (LRRC15), mRNA. |
| hs\|chr3: 195597287-195597347 | A_14_P108587 | entg\|GP5 | ref\|NM_004488 | ref\|Homo sapiens glycoprotein V |
| | | | | (platelet) (GP5), mRNA. |
| hs\|chr3: 195790821-195790881 | A_16_P00901691 | entg\|TMEM44 | ref\|NM_001011655\| | ref\|Homo sapiens transmembrane |
| | | | ref\| | protein 44 (TMEM44), transcript |
| | | | NM_138399 | variant 2, mRNA. |
| hs\|chr3: 195844090-195844150 | A_14_P129090 | entg\|LSG1 | ref\|NM_018385 | ref\|Homo sapiens large subunit |
| | | | | GTPase 1 homolog (S. cerevisiae) |
| | | | | (LSG1), mRNA. |
| hs\|chr3: 21447756-21447816 | A_16_P16153167 | entg\|ZNF659 | ref\|NM_024697 | ref\|Homo sapiens zinc finger protein |
| | | | | 659 (ZNF659), mRNA. |
| hs\|chr3: 27127777-27127830 | A_14_P126966 | entg\|NEK10 | ref\|NM_001031741 | ref\|Homo sapiens NIMA (never in |
| | | | | mitosis gene a)-related kinase 10 |
| | | | | (NEK10), transcript variant 1, |
| | | | | mRNA. |
| hs\|chr3: 46278770-46278830 | A_14_P116163 | entg\|CCR3 | ref\|NM_001837\| | ref\|Homo sapiens chemokine (C-C |
| | | | ref\|NM_178329 | motif) receptor 3 (CCR3), transcript |
| | | | | variant 1, mRNA. |
| hs\|chr3: 48772265-48772325 | A_16_P16216781 | entg\|PRKAR2A | ref\|NM_004157 | ref\|Homo sapiens protein kinase, |
| | | | | cAMP-dependent, regulatory, type |
| | | | | II, alpha (PRKAR2A), mRNA. |
| hs\|chr3: 48869514-48869574 | A_16_P36257495 | entg\|SLC25A20 | ref\|NM_000387 | ref\|Homo sapiens solute carrier |
| | | | | family 25 (carnitine/acylcarnitine |
| | | | | translocase), member 20 |
| | | | | (SLC25A20), nuclear gene encoding |
| | | | | mitochondrial protein, mRNA. |
| hs\|chr3: 48935287-48935347 | A_16_P16217035 | entg\|ARIH2 | ref\|NM_006321 | ref\|Homo sapiens ariadne homolog 2 |
| | | | | (Drosophila) (ARIH2), mRNA. |
| hs\|chr3: 49008516-49008576 | A_16_P36257809 | entg\|PH-4 | ref\|NM_017732\| | ref\|Homo sapiens hypoxia-inducible |
| | | | ref\|NM_177938\| | factor prolyl 4-hydroxylase (PH-4), |
| | | | ref\| | transcript variant 2, mRNA. |
| | | | NM_177939 | |
| hs\|chr3: 49022098-49022158 | A_14_P118004 | entg\|WDR6 | ref\|NM_018031 | ref\|Homo sapiens WD repeat domain |
| | | | | 6 (WDR6), mRNA. |
| hs\|chr3: 49029949-49029998 | A_14_P115373 | entg\|DALRD3 | ref\|NM_00100996\| | ref\|Homo sapiens DALR anticodon |
| | | | ref\| | binding domain containing 3 |
| | | | NM_018114 | (DALRD3), transcript variant 1, |
| | | | | mRNA. |
| hs\|chr3: 5000394-5000453 | A_14_P202182 | entg\|BHLHB2 | ref\|NM_003670 | ref\|Homo sapiens basic helix-loop- |
| | | | | helix domain containing, class B, 2 |
| | | | | (BHLHB2), mRNA. |
| hs\|chr3: 5149509-5149569 | A_16_P00640028 | entg\|ARL8B | ref\|NM_018184 | ref\|Homo sapiens ADP-ribosylation |
| | | | | factor-like 8B (ARL8B), mRNA. |
| hs\|chr3: 5211926-5211986 | A_16_P00640112 | entg\|EDEM1 | ref\|NM_014674 | ref\|Homo sapiens ER degradation |
| | | | | enhancer, mannosidase alpha-like 1 |
| | | | | (EDEM1), mRNA. |
| hs\|chr3: 8769301-8769361 | A_16_P16123539 | entg\|OXTR | ref\|NM_000916 | ref\|Homo sapiens oxytocin receptor |
| | | | | (OXTR), mRNA. |
| hs\|chr3: 88118459-88118519 | A_16_P16314028 | entg\|HTR1F | ref\|NM_000866 | ref\|Homo sapiens 5- |
| | | | | hydroxytryptamine (serotonin) |
| | | | | receptor 1F (HTR1F), mRNA. |
| hs\|chr3: 8897159-8897219 | A_14_P138767 | entg\|RAD18 | ref\|NM_020165 | ref\|Homo sapiens RAD18 homolog |
| | | | | (S. cerevisiae) (RAD18), mRNA. |
| hs\|chr3: 9004934-9004994 | A_16_P16124045 | entg\|SRGAP3 | ref\|NM_001033116\| | ref\|Homo sapiens SLIT-ROBO Rho |
| | | | ref\| | GTPase activating protein 3 |
| | | | NM_001033117\| | (SRGAP3), transcript variant 3, |
| | | | ref\|NM_014850 | mRNA. |
| hs\|chr3: 95088204-95088264 | A_14_P200671 | entg\|PROS1 | ref\|NM_000313 | ref\|Homo sapiens protein S (alpha) |
| | | | | (PROS1), mRNA. |
| hs\|chr3: 95197059-95197119 | A_16_P16319812 | entg\|ARL13B | ref\|NM_144996\| | ref\|Homo sapiens ADP-ribosylation |
| | | | ref\|NM_182896 | factor-like 13B (ARL13B), transcript |
| | | | | variant 2, mRNA. |
| hs\|chr3: 95263582-95263642 | A_14_P116171 | entg\|DHFRL1 | ref\|NM_176815 | ref\|Homo sapiens dihydrofolate |
| | | | | reductase-like 1 (DHFRL1), mRNA. |
| hs\|chr3: 95270649-95270709 | A_16_P16320001 | entg\|NSUN3 | ref\|NM_022072 | ref\|Homo sapiens NOL1/NOP2/Sun |
| | | | | domain family, member 3 (NSUN3), |
| | | | | mRNA. |
| hs\|chr3: 99484653-99484713 | A_16_P00766758 | entg\|OR5H2 | ref\|NM_001005482 | ref\|Homo sapiens olfactory receptor, |
| | | | | family 5, subfamily H, member 2 |
| | | | | (OR5H2), mRNA. |
| hs\|chr3: 99556147-99556207 | A_16_P36372603 | entg\|OR5K4 | ref\|NM_001005517 | ref\|Homo sapiens olfactory receptor, |
| | | | | family 5, subfamily K, member 4 |
| | | | | (OR5K4), mRNA. |
| hs\|chr3: 99592803-99592863 | A_16_P00766854 | entg\|OR5K3 | ref\|NM_001005516 | ref\|Homo sapiens olfactory receptor, |
| | | | | family 5, subfamily K, member 3 |
| | | | | (OR5K3), mRNA. |
| hs\|chr3: 99720442-99720495 | A_14_P100635 | entg\|CLDND1 | ref\|NM_001040181\| | ref\|Homo sapiens claudin domain |
| | | | ref\| | containing 1 (CLDND1), transcript |
| | | | NM_001040182\| | variant 1, mRNA. |
| | | | ref\|NM_001040183\| | |
| | | | ref\|NM_001040199\|ref\| | |
| | | | NM_001040200\| | |
| | | | ref\|NM_019895 | |
| hs\|chr3: 99734089-99734146 | A_14_P129559 | entg\|GPR15 | ref\|NM_005290 | ref\|Homo sapiens G protein-coupled |
| | | | | receptor 15 (GPR15), mRNA. |
| hs\|chr3: 99783227-99783287 | A_14_P102812 | entg\|CPOX | ref\|NM_000097 | ref\|Homo sapiens |
| | | | | coproporphyrinogen oxidase |
| | | | | (CPOX), mRNA. |
| hs\|chr3: 99936231-99936291 | A_16_P16330223 | entg\|ST3GAL6 | ref\|NM_006100 | ref\|Homo sapiens ST3 beta- |
| | | | | galactoside alpha-2,3- |
| | | | | sialyltransferase 6 (ST3GAL6), |
| | | | | mRNA. |
| hs\|chr4: 10239076-10239136 | A_16_P36638427 | entg\|MIST | ref\|NM_052964 | ref\|Homo sapiens mast cell |
| | | | | immunoreceptor signal transducer |
| | | | | (MIST), mRNA. |
| hs\|chr4: 111267618-111267678 | A_14_P124325 | entg\|ELOVL6 | ref\|NM_024090 | ref\|Homo sapiens ELOVL family |
| | | | | member 6, elongation of long chain |
| | | | | fatty acids (FEN1/Elo2, SUR4/Elo3- |
| | | | | like, yeast) (ELOVL6), mRNA. |
| hs\|chr4: 153517616-153517676 | A_16_P16909685 | entg\|FBXW7 | ref\|NM_001013415\| | ref\|Homo sapiens F-box and WD |
| | | | ref\| | repeat domain containing 7 |
| | | | NM_033632 | (FBXW7), transcript variant 3, |
| | | | | mRNA. |
| hs\|chr4: 153767421-153767481 | A_16_P01108981 | entg\|TMEM154 | ref\|NM_152680 | ref\|Homo sapiens transmembrane |
| | | | | protein 154 (TMEM154), mRNA. |
| hs\|chr4: 153910326-153910386 | A_14_P106562 | entg\|TIGD4 | ref\|NM_145720 | ref\|Homo sapiens tigger transposable |
| | | | | element derived 4 (TIGD4), mRNA. |
| hs\|chr4: 153924767-153924827 | A_16_P16910701 | entg\|ARFIP1 | ref\|NM_001025593\| | ref\|Homo sapiens ADP-ribosylation |
| | | | ref\| | factor interacting protein 1 (arfaptin |
| | | | NM_001025595\| | 1) (ARFIP1), transcript variant 2, |
| | | | ref\|NM_014447 | mRNA. |
| hs\|chr4: 154083657-154083717 | A_16_P01109427 | entg\|KIAA1727 | ref\|NM_033393 | ref\|Homo sapiens KIAA1727 protein |
| | | | | (KIAA1727), mRNA. |
| hs\|chr4: 166095929-166095989 | A_16_P16939652 | entg\|TRIM61 | ref\|NM_001012414 | ref\|Homo sapiens tripartite motif- |
| | | | | containing 61 (TRIM61), mRNA. |
| hs\|chr4: 166175139-166175199 | A_14_P104097 | entg\|TRIM60 | ref\|NM_152620 | ref\|Homo sapiens tripartite motif- |
| | | | | containing 60 (TRIM60), mRNA. |
| hs\|chr4: 166219638-166219698 | A_14_P102622 | entg\|FLJ38482 | ref\|NM_152681 | ref\|Homo sapiens hypothetical |
| | | | | protein FLJ38482 (FLJ38482), |
| | | | | mRNA. |
| hs\|chr4: 166349285-166349345 | A_16_P16940192 | entg\|KLHL2 | ref\|NM_007246 | ref\|Homo sapiens kelch-like 2, |
| | | | | Mayven (Drosophila) (KLHL2), |
| | | | | mRNA. |
| hs\|chr4: 166472470-166472530 | A_16_P16940532 | entg\|SC4MOL | ref\|NM_001017369\| | ref\|Homo sapiens sterol-C4-methyl |
| | | | ref\| | oxidase-like (SC4MOL), transcript |
| | | | NM_006745 | variant 2, mRNA. |
| hs\|chr4: 166520939-166520999 | A_16_P16940635 | entg\|CPE | ref\|NM_001873 | ref\|Homo sapiens carboxypeptidase |
| | | | | E (CPE), mRNA. |
| hs\|chr4: 167014608-167014666 | A_14_P101657 | entg\|TLL1 | ref\|NM_012464 | ref\|Homo sapiens tolloid-like 1 |
| | | | | (TLL1), mRNA. |
| hs\|chr4: 39875242-39875302 | A_16_P00960225 | entg\|RHOH | ref\|NM_004310 | ref\|Homo sapiens ras homolog gene |
| | | | | family, member H (RHOH), mRNA. |
| hs\|chr4: 40032601-40032660 | A_14_P202451 | entg\|CHRNA9 | ref\|NM_017581 | ref\|Homo sapiens cholinergic |
| | | | | receptor, nicotinic, alpha 9 |
| | | | | (CHRNA9), mRNA. |
| hs\|chr4: 40130619-40130679 | A_16_P00960548 | entg\|FLJ20273 | ref\|NM_019027 | ref\|Homo sapiens RNA-binding |
| | | | | protein (FLJ20273), mRNA. |
| hs\|chr4: 98699087-98699147 | A_14_P138919 | entg\|MGC46496 | ref\|NM_174952 | ref\|Homo sapiens hypothetical |
| | | | | protein MGC46496 (MGC46496), |
| | | | | mRNA. |
| hs\|chr5: 119989315-119989375 | A_16_P01322931 | entg\|PRR16 | ref\|NM_016644 | ref\|Homo sapiens proline rich 16 |
| | | | | (PRR16), mRNA. |
| hs\|chr5: 121216336-121216396 | A_14_P123018 | entg\|FTMT | ref\|NM_177478 | ref\|Homo sapiens ferritin |
| | | | | mitochondrial (FTMT), mRNA. |
| hs\|chr5: 121330011-121330071 | A_14_P114585 | entg\|SRFBP1 | ref\|NM_152546 | ref\|Homo sapiens serum response |
| | | | | factor binding protein 1 (SRFBP1), |
| | | | | mRNA. |
| hs\|chr5: 141217581-141217641 | A_16_P01352316 | entg\|PCDH1 | ref\|NM_032420 | ref\|Homo sapiens protocadherin 1 |
| | | | | (PCDH1), transcript variant 2, |
| | | | | mRNA. |
| hs\|chr5: 141286271-141286331 | A_16_P01352410 | entg\|KIAA0141 | ref\|NM_014773 | ref\|Homo sapiens KIAA0141 |
| | | | | (KIAA0141), mRNA. |
| hs\|chr5: 141304698-141304756 | A_16_P01352447 | entg\|PCDH12 | ref\|NM_016580 | ref\|Homo sapiens protocadherin 12 |
| | | | | (PCDH12), mRNA. |
| hs\|chr5: 141330366-141330426 | A_16_P17326902 | entg\|RNF14 | ref\|NM_183399\| | ref\|Homo sapiens ring finger protein |
| | | | ref\|NM_004290\| | 14 (RNF14), transcript variant 3, |
| | | | ref\| | mRNA. |
| | | | NM_183398\| | |
| | | | ref\|NM_183400\| | |
| | | | ref\|NM_183401 | |
| hs\|chr5: 141360756-141360816 | A_14_P110042 | entg\|GNPDA1 | ref\|NM_005471 | ref\|Homo sapiens glucosamine-6- |
| | | | | phosphate deaminase 1 (GNPDA1), |
| | | | | mRNA. |
| hs\|chr5: 141469990-141470050 | A_16_P37392339 | entg\|NDFIP1 | ref\|NM_030571 | ref\|Homo sapiens Nedd4 family |
| | | | | interacting protein 1 (NDFIP1), |
| | | | | mRNA. |
| hs\|chr5: 3654212-3654272 | A_16_P01168082 | entg\|IRX1 | ref\|NM_024337 | ref\|Homo sapiens iroquois |
| | | | | homeobox protein 1 (IRX1), mRNA. |
| hs\|chr5: 60413758-60413818 | A_16_P17136872 | entg\|NDUFA12L | ref\|NM_174889 | ref\|Homo sapiens NDUFA12-like |
| | | | | (NDUFA12L), mRNA. |
| hs\|chr5: 60977230-60977290 | A_14_P101450 | entg\|FLJ37543 | ref\|NM_173667 | ref\|Homo sapiens hypothetical |
| | | | | protein FLJ37543 (FLJ37543), |
| | | | | mRNA. |
| hs\|chr5: 69767947-69768007 | A_16_P01253504 | entg\|LOC730394 | ref\|NM_001042490 | ref\|Homo sapiens general |
| | | | | transcription factor IIH, polypeptide |
| | | | | 2, 44 kDa-like (LOC730394), |
| | | | | mRNA. |
| hs\|chr5: 70343856-70343916 | A_16_P17159782 | entg\|NAIP | ref\|NM_004536\| | ref\|Homo sapiens NLR family, |
| | | | ref\|NM_022892 | apoptosis inhibitory protein (NAIP), |
| | | | | transcript variant 1, mRNA. |
| hs\|chr5: 98256993-98257053 | A_16_P01293348 | entg\|CHD1 | ref\|NM_001270 | ref\|Homo sapiens chromodomain |
| | | | | helicase DNA binding protein 1 |
| | | | | (CHD1), mRNA. |
| hs\|chr6: 100950534-100950594 | A_16_P01542002 | entg\|SIM1 | ref\|NM_005068 | ref\|Homo sapiens single-minded |
| | | | | homolog 1 (Drosophila) (SIM1), |
| | | | | mRNA. |
| hs\|chr6: 101063899-101063959 | A_14_P114084 | entg\|ASCC3 | ref\|NM_006828 | ref\|Homo sapiens activating signal |
| | | | | cointegrator 1 complex subunit 3 |
| | | | | (ASCC3), transcript variant 1, |
| | | | | mRNA. |
| hs\|chr6: 134254855-134254907 | A_14_P134630 | entg\|TCF21 | ref\|NM_003206\| | ref\|Homo sapiens transcription factor |
| | | | ref\|NM_198392 | 21 (TCF21), transcript variant 2, |
| | | | | mRNA. |
| hs\|chr6: 134319508-134319568 | A_16_P17730810 | entg\|TBPL1 | ref\|NM_004865 | ref\|Homo sapiens TBP-like 1 |
| | | | | (TBPL1), mRNA. |
| hs\|chr6: 134352222-134352282 | A_14_P129985 | entg\|SLC2A12 | ref\|NM_145176 | ref\|Homo sapiens solute carrier |
| | | | | family 2 (facilitated glucose |
| | | | | transporter), member 12 (SLC2A12), |
| | | | | mRNA. |
| hs\|chr6: 134533694-134533754 | A_14_P111298 | entg\|SGK | ref\|NM_005627 | ref\|Homo sapiens |
| | | | | serum/glucocorticoid regulated |
| | | | | kinase (SGK), mRNA. |
| hs\|chr6: 154405824-154405884 | A_16_P17779613 | entg\|OPRM1 | ref\|NM_001008504\| | ref\|Homo sapiens opioid receptor, |
| | | | ref\| | mu 1 (OPRM1), transcript variant |
| | | | NM_001008505\| | MOR-1A, mRNA. |
| | | | ref\|NM_000914\|ref\| | |
| | | | NM_001008503 | |
| hs\|chr6: 168161465-168161525 | A_14_P119280 | entg\|KIF25 | ref\|NM_005355\| | ref\|Homo sapiens kinesin family |
| | | | ref\|NM_030615 | member 25 (KIF25), transcript |
| | | | | variant 2, mRNA. |
| hs\|chr6: 168205933-138205989 | A_14_P122557 | entg\|FRMD1 | ref\|NM_024919 | ref\|Homo sapiens FERM domain |
| | | | | containing 1 (FRMD1), mRNA. |
| hs\|chr6: 168588480-168588540 | A_14_P125563 | entg\|SMOC2 | ref\|NM_022138 | ref\|Homo sapiens SPARC related |
| | | | | modular calcium binding 2 |
| | | | | (SMOC2), mRNA. |
| hs\|chr6: 169359278-169359338 | A_16_P37895988 | entg\|THBS2 | ref\|NM_003247 | ref\|Homo sapiens thrombospondin 2 |
| | | | | (THBS2), mRNA. |
| hs\|chr6: 169599492-169599540 | A_14_P103502 | entg\|WDR27 | ref\|NM_182552 | ref\|Homo sapiens WD repeat domain |
| | | | | 27 (WDR27), mRNA. |
| hs\|chr6: 169854024-169854084 | A_14_P105496 | entg\|PHF10 | ref\|NM_133325\| | ref\|Homo sapiens PHD finger protein |
| | | | ref\|NM_018288 | 10 (PHF10), transcript variant 2, |
| | | | | mRNA. |
| hs\|chr6: 28377106-28377166 | A_14_P119276 | entg\|PGBD1 | ref\|NM_032507 | ref\|Homo sapiens piggyBac |
| | | | | transposable element derived 1 |
| | | | | (PGBD1), mRNA. |
| hs\|chr6: 28401449-28401509 | A_16_P37560061 | entg\|ZNF323 | ref\|NM_145909\| | ref\|Homo sapiens zinc finger protein |
| | | | ref\|NM_030899 | 323 (ZNF323), transcript variant 2, |
| | | | | mRNA. |
| hs\|chr6: 28435225-28435281 | A_16_P17490848 | entg\|ZKSCAN3 | ref\|NM_024493 | ref\|Homo sapiens zinc finger with |
| | | | | KRAB and SCAN domains 3 |
| | | | | (ZKSCAN3), mRNA. |
| hs\|chr6: 28455949-28456009 | A_16_P17490896 | entg\|ZSCAN12 | ref\|NM_001039643 | ref\|Homo sapiens zinc finger and |
| | | | | SCAN domain containing 12 |
| | | | | (ZSCAN12), mRNA. |
| hs\|chr6: 28579500-28579560 | A_14_P109089 | entg\|GPX6 | ref\|NM_182701 | ref\|Homo sapiens glutathione |
| | | | | peroxidase 6 (olfactory) (GPX6), |
| | | | | mRNA. |
| hs\|chr6: 28605157-28605217 | A_16_P37560577 | entg\|GPX5 | ref\|NM_001509\| | ref\|Homo sapiens glutathione |
| | | | ref\|NM_003996 | peroxidase 5 (epididymal androgen- |
| | | | | related protein) (GPX5), transcript |
| | | | | variant 1, mRNA. |
| hs\|chr6: 28650448-28650508 | A_16_P37560676 | entg\|ZNF452 | ref\|NM_052923 | ref\|Homo sapiens zinc finger protein |
| | | | | 452 (ZNF452), mRNA. |
| hs\|chr6: 36538525-36538585 | A_16_P01458095 | entg\|KCTD20 | ref\|NM_173562 | ref\|Homo sapiens potassium channel |
| | | | | tetramerisation domain containing 20 |
| | | | | (KCTD20), mRNA. |
| hs\|chr6: 36571161-36571221 | A_16_P01458155 | entg\|STK38 | ref\|NM_007271 | ref\|Homo sapiens serine/threonine |
| | | | | kinase 38 (STK38), mRNA. |
| hs\|chr6: 36671563-36671623 | A_14_P118435 | entg\|SFRS3 | ref\|NM_003017 | ref\|Homo sapiens splicing factor, |
| | | | | arginine/serine-rich 3 (SFRS3), |
| | | | | mRNA. |
| hs\|chr6: 36759128-36759180 | A_14_P122468 | entg\|CDKN1A | ref\|NM_000389\| | ref\|Homo sapiens cyclin-dependent |
| | | | ref\|NM_078467 | kinase inhibitor 1A (p21, Cip1) |
| | | | | (CDKN1A), transcript variant 1, |
| | | | | mRNA. |
| hs\|chr6: 36816506-36816566 | A_16_P01458485 | entg\|CPNE5 | ref\|NM_020939 | ref\|Homo sapiens copine V |
| | | | | (CPNE5), mRNA. |
| hs\|chr6: 53795031-53795091 | A_14_P102227 | entg\|LRRC1 | ref\|NM_018214 | ref\|Homo sapiens leucine rich repeat |
| | | | | containing 1 (LRRC1), mRNA. |
| hs\|chr6: 8362675-8362735 | A_16_P01419072 | entg\|SLC35B3 | ref\|NM_015948 | ref\|Homo sapiens solute carrier |
| | | | | family 35, member B3 (SLC35B3), |
| | | | | mRNA. |
| hs\|chr6: 85507826-85507886 | A_14_P113060 | entg\|TBX18 | ref\|NM_001080508 | ref\|Homo sapiens T-box 18 |
| | | | | (TBX18), mRNA. |
| hs\|chr7: 103995220-103995280 | A_16_P18053858 | entg\|LHFPL3 | ref\|NM_199000 | ref\|Homo sapiens lipoma HMGIC |
| | | | | fusion partner-like 3 (LHFPL3), |
| | | | | mRNA. |
| hs\|chr7: 104444482-104444542 | A_14_P108324 | entg\|MLL5 | ref\|NM_018682\| | ref\|Homo sapiens myeloid/lymphoid |
| | | | ref\|NM_182931 | or mixed-lineage leukemia 5 |
| | | | | (trithorax homolog, Drosophila) |
| | | | | (MLL5), transcript variant 2, mRNA. |
| hs\|chr7: 104552408-104552468 | A_16_P01771211 | entg\|SRPK2 | ref\|NM_182691\| | ref\|Homo sapiens SFRS protein |
| | | | ref\|NM_182692 | kinase 2 (SRPK2), transcript variant |
| | | | | 2, mRNA. |
| hs\|chr7: 104895268-104895328 | A_14_P124528 | entg\|PUS7 | ref\|NM_019042 | ref\|Homo sapiens pseudouridylate |
| | | | | synthase 7 homolog (S. cerevisiae) |
| | | | | (PUS7), mRNA. |
| hs\|chr7: 104964297-104964357 | A_14_P134939 | entg\|RINT1 | ref\|NM_021930 | ref\|Homo sapiens RAD50 interactor |
| | | | | 1 (RINT1), mRNA. |
| hs\|chr7: 105188153-105188213 | A_14_P101721 | entg\|ATXN7L4 | ref\|NM_152749 | ref\|Homo sapiens ataxin 7-like 4 |
| | | | | (ATXN7L4), mRNA. |
| hs\|chr7: 1218820-1218880 | A_16_P17823267 | entg\|LOC641901 | ref\|NM_001085389 | ref\|Homo sapiens similar to Unc4.1 |
| | | | | homeobox (LOC641901), mRNA. |
| hs\|chr7: 126417354-126417414 | A_16_P01802575 | entg\|GRM8 | ref\|NM_000845 | ref\|Homo sapiens glutamate receptor, |
| | | | | metabotropic 8 (GRM8), mRNA. |
| hs\|chr7: 126800830-126800890 | A_16_P18108574 | entg\|ZNF800 | ref\|NM_176814 | ref\|Homo sapiens zinc finger protein |
| | | | | 800 (ZNF800), mRNA. |
| hs\|chr7: 127007929-127007989 | A_14_P118738 | entg\|GCC1 | ref\|NM_024523 | ref\|Homo sapiens GRIP and coiled- |
| | | | | coil domain containing 1 (GCC1), |
| | | | | mRNA. |
| hs\|chr7: 127017522-127017582 | A_14_P123307 | entg\|ARF5 | ref\|NM_001662 | ref\|Homo sapiens ADP-ribosylation |
| | | | | factor 5 (ARF5), mRNA. |
| hs\|chr7: 127022241-127022301 | A_16_P01803440 | entg\|FSCN3 | ref\|NM_020369 | ref\|Homo sapiens fascin homolog 3, |
| | | | | actin-bundling protein, testicular |
| | | | | (Strongylocentrotus purpuratus) |
| | | | | (FSCN3), mRNA. |
| hs\|chr7: 127037562-127037622 | A_16_P01803454 | entg\|PAX4 | ref\|NM_006193 | ref\|Homo sapiens paired box gene 4 |
| | | | | (PAX4), mRNA. |
| hs\|chr7: 127082551-127082611 | A_16_P01803523 | entg\|SND1 | ref\|NM_014390 | ref\|Homo sapiens staphylococcal |
| | | | | nuclease and tudor domain |
| | | | | containing 1 (SND1), mRNA. |
| hs\|chr7: 1447234-1447287 | A_16_P01643415 | entg\|MICALL2 | ref\|NM_182924\| | ref\|Homo sapiens MICAL-like 2 |
| | | | ref\|NM_024723 | (MICALL2), transcript variant 1, |
| | | | | mRNA. |
| hs\|chr7: 1481580-1481640 | A_16_P01643476 | entg\|INTS1 | ref\|NM_001080453 | ref\|Homo sapiens integrator complex |
| | | | | subunit 1 (INTS1), mRNA. |
| hs\|chr7: 1538517-1538574 | A_16_P01643559 | entg\|MAFK | ref\|NM_002360 | ref\|Homo sapiens v-maf |
| | | | | musculoaponeurotic fibrosarcoma |
| | | | | oncogene homolog K (avian) |
| | | | | (MAFK), mRNA. |
| hs\|chr7: 21435824-21435884 | A_16_P01671137 | entg\|SP4 | ref\|NM_003112 | ref\|Homo sapiens Sp4 transcription |
| | | | | factor (SP4), mRNA. |
| hs\|chr7: 36725683-36725743 | A_16_P17909621 | entg\|AOAH | ref\|NM_001637 | ref\|Homo sapiens acyloxyacyl |
| | | | | hydrolase (neutrophil) (AOAH), |
| | | | | mRNA. |
| hs\|chr7: 36860481-36860541 | A_14_P137337 | entg\|ELMO1 | ref\|NM_001039459\| | ref\|Homo sapiens engulfment and |
| | | | ref\| | cell motility 1 (ELMO1), transcript |
| | | | NM_130442\| | variant 3, mRNA. |
| | | | ref\|NM_014800 | |
| hs\|chr7: 37746850-37746908 | A_14_P201065 | entg\|GPR141 | ref\|NM_181791 | ref\|Homo sapiens G protein-coupled |
| | | | | receptor 141 (GPR141), mRNA. |
| hs\|chr7: 37856729-37856789 | A_14_P122270 | entg\|TXNDC3 | ref\|NM_016616 | ref\|Homo sapiens thioredoxin |
| | | | | domain containing 3 (spermatozoa) |
| | | | | (TXNDC3), mRNA. |
| hs\|chr7: 37912863-37912923 | A_16_P01694935 | entg\|SFRP4 | ref\|NM_003014 | ref\|Homo sapiens secreted frizzled- |
| | | | | related protein 4 (SFRP4), mRNA. |
| hs\|chr7: 37930896-37930956 | A_16_P17912735 | entg\|EPDR1 | ref\|NM_017549 | ref\|Homo sapiens ependymin related |
| | | | | protein 1 (zebrafish) (EPDR1), |
| | | | | mRNA. |
| hs\|chr7: 38185166-38185226 | A_14_P100323 | entg\|STARD3NL | ref\|NM_032016 | ref\|Homo sapiens STARD3 N- |
| | | | | terminal like (STARD3NL), mRNA. |
| hs\|chr7: 38270941-38271001 | A_16_P17913484 | entg\|TARP | ref\|NM_001003799\| | ref\|Homo sapiens TCR gamma |
| | | | ref\| | alternate reading frame protein |
| | | | NM_001003806 | (TARP), nuclear gene encoding |
| | | | | mitochondrial protein, transcript |
| | | | | variant 1, mRNA. |
| hs\|chr7: 38390270-38390330 | A_14_P103686 | entg\|AMPH | ref\|NM_001635\| | ref\|Homo sapiens amphiphysin |
| | | | ref\|NM_139316 | (Stiff-Man syndrome with breast |
| | | | | cancer 128 kDa autoantigen) |
| | | | | (AMPH), transcript variant 1, |
| | | | | mRNA. |
| hs\|chr7: 38745088-38745148 | A_16_P17914729 | entg\|VPS41 | ref\|NM_014396\| | ref\|Homo sapiens vacuolar protein |
| | | | ref\|NM_080631 | sorting 41 homolog (S. cerevisiae) |
| | | | | (VPS41), transcript variant 1, |
| | | | | mRNA. |
| hs\|chr7: 39012946-39013006 | A_14_P135676 | entg\|POU6F2 | ref\|NM_007252 | ref\|Homo sapiens POU domain, class |
| | | | | 6, transcription factor 2 (POU6F2), |
| | | | | mRNA. |
| hs\|chr7: 45627903-45627963 | A_16_P17931214 | entg\|ADCY1 | ref\|NM_021116 | ref\|Homo sapiens adenylate cyclase |
| | | | | 1 (brain) (ADCY1), mRNA. |
| hs\|chr7: 45895604-45895664 | A_14_P113809 | entg\|IGFBP1 | ref\|NM_000596\| | ref\|Homo sapiens insulin-like growth |
| | | | ref\|NM_001013029 | factor binding protein 1 (IGFBP1), |
| | | | | transcript variant 1, mRNA. |
| hs\|chr7: 45919783-45919843 | A_14_P135451 | entg\|IGFBP3 | ref\|NM_000598\| | ref\|Homo sapiens insulin-like growth |
| | | | ref\|NM_001013398 | factor binding protein 3 (IGFBP3), |
| | | | | transcript variant 2, mRNA. |
| hs\|chr7: 47050792-47050852 | A_16_P38015917 | entg\|LOC641980 | ref\|NM_001085413 | ref\|Homo sapiens similar to Splicing |
| | | | | factor, arginine/serine-rich, 46 kD |
| | | | | (LOC641980), mRNA. |
| hs\|chr7: 47281252-47281312 | A_14_P133390 | entg\|TNS3 | ref\|NM_022748 | ref\|Homo sapiens tensin 3 (TNS3), |
| | | | | mRNA. |
| hs\|chr7: 4913284-4913344 | A_16_P01648048 | entg\|MMD2 | ref\|NM_198403 | ref\|Homo sapiens monocyte to |
| | | | | macrophage differentiation- |
| | | | | associated 2 (MMD2), mRNA. |
| hs\|chr7: 5064769-5064815 | A_16_P17832416 | entg\|RBAK | ref\|NM_021163 | ref\|Homo sapiens RB-associated |
| | | | | KRAB zinc finger (RBAK), mRNA. |
| hs\|chr7: 5198919-5198979 | A_14_P126466 | entg\|WIPI2 | ref\|NM_001033518\| | ref\|Homo sapiens WD repeat |
| | | | ref\| | domain, phosphoinositide interacting |
| | | | NM_001033519\| | 2 (WIPI2), transcript variant 3, |
| | | | ref\|NM_015610\| | mRNA. |
| | | | ref\| | |
| | | | NM_016003 | |
| hs\|chr7: 5292244-5292289 | A_16_P17832856 | entg\|SLC29A4 | ref\|NM_001040661\| | ref\|Homo sapiens solute carrier |
| | | | ref\| | family 29 (nucleoside transporters), |
| | | | NM_153247 | member 4 (SLC29A4), transcript |
| | | | | variant 1, mRNA. |
| hs\|chr7: 5327748-5327793 | A_16_P01648366 | entg\|KIAA1856 | ref\|NM_001080495 | ref\|Homo sapiens KIAA1856 protein |
| | | | | (KIAA1856), mRNA. |
| hs\|chr7: 65025490-65025550 | A_14_P107777 | entg\|VKORC1L1 | ref\|NM_173517 | ref\|Homo sapiens vitamin K epoxide |
| | | | | reductase complex, subunit 1-like 1 |
| | | | | (VKORC1L1), mRNA. |
| hs\|chr7: 65063856-65063916 | A_14_P115643 | entg\|GUSB | ref\|NM_000181 | ref\|Homo sapiens glucuronidase, |
| | | | | beta (GUSB), mRNA. |
| hs\|chr7: 65180525-65180583 | A_14_P139837 | entg\|ASL | ref\|NM_000048\| | ref\|Homo sapiens argininosuccinate |
| | | | ref\|NM_001024943\| | lyase (ASL), transcript variant 2, |
| | | | ref\|NM_001024944\| | mRNA. |
| | | | ref\| | |
| | | | NM_001024946 | |
| hs\|chr7: 65218120-65218180 | A_14_P134347 | entg\|RCP9 | ref\|NM_001040647\| | ref\|Homo sapiens calcitonin gene- |
| | | | ref\| | related peptide-receptor component |
| | | | NM_001040648\| | protein (RCP9), transcript variant 2, |
| | | | ref\|NM_014478 | mRNA. |
| hs\|chr7: 65309603-65309663 | A_16_P17964545 | entg\|TPST1 | ref\|NM_003596 | ref\|Homo sapiens tyrosylprotein |
| | | | | sulfotransferase 1 (TPST1), mRNA. |
| hs\|chr7: 69607566-69607626 | A_16_P17974103 | entg\|AUTS2 | ref\|NM_015570 | ref\|Homo sapiens autism |
| | | | | susceptibility candidate 2 (AUTS2), |
| | | | | mRNA. |
| hs\|chr7: 74993702-74993762 | A_16_P01731202 | entg\|PMS2L3 | ref\|NM_001003686\| | ref\|Homo sapiens postmeiotic |
| | | | ref\| | segregation increased 2-like 3 |
| | | | NM_005395 | (PMS2L3), transcript variant 2, |
| | | | | mRNA. |
| hs\|chr7: 75009097-75009157 | A_16_P17984818 | entg\|HIP1 | ref\|NM_005338 | ref\|Homo sapiens huntingtin |
| | | | | interacting protein 1 (HIP1), mRNA. |
| hs\|chr7: 81182482-81182542 | A_16_P38083110 | entg\|HGF | ref\|NM_000601\| | ref\|Homo sapiens hepatocyte growth |
| | | | ref\|NM_001010932 | factor (hepapoietin A; scatter factor) |
| | | | | (HGF), transcript variant 1, mRNA. |
| hs\|chr7: 81417401-81417461 | A_14_P137334 | entg\|CACNA2D1 | ref\|NM_000722 | ref\|Homo sapiens calcium channel, |
| | | | | voltage-dependent, alpha 2/delta |
| | | | | subunit 1 (CACNA2D1), mRNA. |
| hs\|chr7: 8493301-8493361 | A_16_P17840040 | entg\|NXPH1 | ref\|NM_152745 | ref\|Homo sapiens neurexophilin 1 |
| | | | | (NXPH1), mRNA. |
| hs\|chr7: 88230877-88230937 | A_16_P18017265 | entg\|ZNF804B | ref\|NM_181646 | ref\|Homo sapiens zinc finger protein |
| | | | | 804B (ZNF804B), mRNA. |
| hs\|chr7: 97321804-97321855 | A_14_P115594 | entg\|ASNS | ref\|NM_133436\| | ref\|Homo sapiens asparagine |
| | | | ref\|NM_183356\| | synthetase (ASNS), transcript variant |
| | | | ref\| | 1, mRNA. |
| | | | NM_001673 | |
| hs\|chr7: 97578588-97578648 | A_16_P18039072 | entg\|LMTK2 | ref\|NM_014916 | ref\|Homo sapiens lemur tyrosine |
| | | | | kinase 2 (LMTK2), mRNA. |
| hs\|chr7: 97690642-97690702 | A_14_P138217 | entg\|DKFZP434B0335 | ref\|NM_015395 | ref\|Homo sapiens DKFZP434B0335 |
| | | | | protein (DKFZP434B0335), mRNA. |
| hs\|chr7: 97758070-97758130 | A_14_P109732 | entg\|BRI3 | ref\|NM_015379 | ref\|Homo sapiens brain protein I3 |
| | | | | (BRI3), mRNA. |
| hs\|chr7: 97763508-97763568 | A_16_P01763010 | entg\|BAIAP2L1 | ref\|NM_018842 | ref\|Homo sapiens BAI1-associated |
| | | | | protein 2-like 1 (BAIAP2L1), |
| | | | | mRNA. |
| hs\|chr7: 98089446-98089506 | A_14_P201599 | entg\|NPTX2 | ref\|NM_002523 | ref\|Homo sapiens neuronal pentraxin |
| | | | | II (NPTX2), mRNA. |
| hs\|chr9: 1046308-1046368 | A_14_P113138 | entg\|DMRT2 | ref\|NM_006557\| | ref\|Homo sapiens doublesex and |
| | | | ref\|NM_181872 | mab-3 related transcription factor 2 |
| | | | | (DMRT2), transcript variant 1, |
| | | | | mRNA. |
| hs\|chr9: 115680996-115681056 | A_14_P117997 | entg\|ZNF618 | ref\|NM_133374 | ref\|Homo sapiens zinc finger protein |
| | | | | 618 (ZNF618), mRNA. |
| hs\|chr9: 115862209-115862269 | A_16_P02162107 | entg\|AMBP | ref\|NM_001633 | ref\|Homo sapiens alpha-1- |
| | | | | microglobulin/bikunin precursor |
| | | | | (AMBP), mRNA. |
| hs\|chr9: 115898961-115899014 | A_14_P103846 | entg\|KIF12 | ref\|NM_138424 | ref\|Homo sapiens kinesin family |
| | | | | member 12 (KIF12), mRNA. |
| hs\|chr9: 115965465-115965525 | A_16_P02162268 | entg\|COL27A1 | ref\|NM_032888 | ref\|Homo sapiens collagen, type |
| | | | | XXVII, alpha 1 (COL27A1), |
| | | | | mRNA. |
| hs\|chr9: 116126104-116126155 | A_16_P02162547 | entg\|ORM1 | ref\|NM_000607 | ref\|Homo sapiens orosomucoid 1 |
| | | | | (ORM1), mRNA. |
| hs\|chr9: 116132838-116132892 | A_14_P128743 | entg\|ORM2 | ref\|NM_000608 | ref\|Homo sapiens orosomucoid 2 |
| | | | | (ORM2), mRNA. |
| hs\|chr9: 116138266-116138326 | A_16_P02162555 | entg\|AKNA | ref\|NM_030767 | ref\|Homo sapiens AT-hook |
| | | | | transcription factor (AKNA), |
| | | | | mRNA. |
| hs\|chr9: 116210239-116210299 | A_16_P18745720 | entg\|DFNB31 | ref\|NM_001083885\| | ref\|Homo sapiens deafness, |
| | | | ref\| | autosomal recessive 31 (DFNB31), |
| | | | NM_015404 | transcript variant 2, mRNA. |
| hs\|chr9: 116395422-116395482 | A_14_P114363 | entg\|ATP6V1G1 | ref\|NM_004888 | ref\|Homo sapiens ATPase, H+ |
| | | | | transporting, lysosomal 13 kDa, V1 |
| | | | | subunit G1 (ATP6V1G1), mRNA. |
| hs\|chr9: 122190961-122191021 | A_14_P201631 | entg\|CDK5RAP2 | ref\|NM_001011649\| | ref\|Homo sapiens CDK5 regulatory |
| | | | ref\| | subunit associated protein 2 |
| | | | NM_018249 | (CDK5RAP2), transcript variant 2, |
| | | | | mRNA. |
| hs\|chr9: 122508427-122508487 | A_16_P18761401 | entg\|MEGF9 | ref\|NM_001080497 | ref\|Homo sapiens multiple EGF-like- |
| | | | | domains 9 (MEGF9), mRNA. |
| hs\|chr9: 122563721-122563781 | A_16_P38863564 | entg\|FBXW2 | ref\|NM_012164 | ref\|Homo sapiens F-box and WD |
| | | | | repeat domain containing 2 |
| | | | | (FBXW2), mRNA. |
| hs\|chr9: 122618558-122618618 | A_14_P102384 | entg\|PSMD5 | ref\|NM_005047 | ref\|Homo sapiens proteasome |
| | | | | (prosome, macropain) 26S subunit, |
| | | | | non-ATPase, 5 (PSMD5), mRNA. |
| hs\|chr9: 122657730-122657790 | A_16_P38863797 | entg\|PHF19 | ref\|NM_015651 | ref\|Homo sapiens PHD finger protein |
| | | | | 19 (PHF19), transcript variant 1, |
| | | | | mRNA. |
| hs\|chr9: 122714143-122714203 | A_14_P138468 | entg\|TRAF1 | ref\|NM_005658 | ref\|Homo sapiens TNF receptor- |
| | | | | associated factor 1 (TRAF1), |
| | | | | mRNA. |
| hs\|chr9: 122755812-122755872 | A_14_P116555 | entg\|C5 | ref\|NM_001735 | ref\|Homo sapiens complement |
| | | | | component 5 (C5), mRNA. |
| hs\|chr9: 122892410-122892470 | A_16_P02172604 | entg\|CEP110 | ref\|NM_007018 | ref\|Homo sapiens centrosomal |
| | | | | protein 110 kDa (CEP110), mRNA. |
| hs\|chr9: 122981254-122981314 | A_16_P38864720 | entg\|RAB14 | ref\|NM_016322 | ref\|Homo sapiens RAB14, member |
| | | | | RAS oncogene family (RAB14), |
| | | | | mRNA. |
| hs\|chr9: 123079770-123079830 | A_16_P02172892 | entg\|GSN | ref\|NM_198252 | ref\|Homo sapiens gelsolin |
| | | | | (amyloidosis, Finnish type) (GSN), |
| | | | | transcript variant 2, mRNA. |
| hs\|chr9: 123146242-123146302 | A_14_P103990 | entg\|STOM | ref\|NM_004099\| | ref\|Homo sapiens stomatin (STOM), |
| | | | ref\|NM_198194 | transcript variant 1, mRNA. |
| hs\|chr9: 12688541-12688598 | A_14_P101680 | entg\|TYRP1 | ref\|NM_000550 | ref\|Homo sapiens tyrosinase-related |
| | | | | protein 1 (TYRP1), mRNA. |
| hs\|chr9: 13096805-13096865 | A_14_P102069 | entg\|MPDZ | ref\|NM_003829 | ref\|Homo sapiens multiple PDZ |
| | | | | domain protein (MPDZ), mRNA. |
| hs\|chr9: 133126723-133126775 | A_14_P129649 | entg\|FAM78A | ref\|NM_033387 | ref\|Homo sapiens family with |
| | | | | sequence similarity 78, member A |
| | | | | (FAM78A), mRNA. |
| hs\|chr9: 133158121-133158181 | A_16_P02186691 | entg\|PPAPDC3 | ref\|NM_032728 | ref\|Homo sapiens phosphatidic acid |
| | | | | phosphatase type 2 domain |
| | | | | containing 3 (PPAPDC3), mRNA. |
| hs\|chr9: 133371617-133371677 | A_14_P114470 | entg\|POMT1 | ref\|NM_001077365\| | ref\|Homo sapiens protein-O- |
| | | | ref\| | mannosyltransferase 1 (POMT1), |
| | | | NM_001077366\| | transcript variant 2, mRNA. |
| | | | ref\|NM_007171 | |
| hs\|chr9: 133391218-133391273 | A_14_P106183 | entg\|UCK1 | ref\|NM_031432 | ref\|Homo sapiens uridine-cytidine |
| | | | | kinase 1 (UCK1), mRNA. |
| hs\|chr9: 133443193-133443253 | A_14_P118711 | entg\|RAPGEF1 | ref\|NM_198679\| | ref\|Homo sapiens Rap guanine |
| | | | ref\|NM_005312 | nucleotide exchange factor (GEF) 1 |
| | | | | (RAPGEF1), transcript variant 2, |
| | | | | mRNA. |
| hs\|chr9: 19040854-19040914 | A_14_P102520 | entg\|RRAGA | ref\|NM_006570 | ref\|Homo sapiens Ras-related GTP |
| | | | | binding A (RRAGA), mRNA. |
| hs\|chr9: 19047617-19047677 | A_14_P110216 | entg\|FAM29A | ref\|NM_017645 | ref\|Homo sapiens family with |
| | | | | sequence similarity 29, member A |
| | | | | (FAM29A), mRNA. |
| hs\|chr9: 19105742-19105802 | A_16_P02072427 | entg\|ADFP | ref\|NM_001122 | ref\|Homo sapiens adipose |
| | | | | differentiation-related protein |
| | | | | (ADFP), mRNA. |
| hs\|chr9: 32456249-32456309 | A_16_P18602496 | entg\|DDX58 | ref\|NM_014314 | ref\|Homo sapiens DEAD (Asp-Glu- |
| | | | | Ala-Asp) box polypeptide 58 |
| | | | | (DDX58), mRNA. |
| hs\|chr9: 32534143-32534203 | A_16_P38700163 | entg\|TOPORS | ref\|NM_005802 | ref\|Homo sapiens topoisomerase I |
| | | | | binding, arginine/serine-rich |
| | | | | (TOPORS), mRNA. |
| hs\|chr9: 32548886-32548946 | A_14_P135984 | entg\|NDUFB6 | ref\|NM_002493\| | ref\|Homo sapiens NADH |
| | | | ref\|NM_182739 | dehydrogenase (ubiquinone) 1 beta |
| | | | | subcomplex, 6, 17 kDa (NDUFB6), |
| | | | | nuclear gene encoding mitochondrial |
| | | | | protein, transcript variant 1, mRNA. |
| hs\|chr9: 32623069-32623127 | A_14_P108455 | entg\|TAF1L | ref\|NM_153809 | ref\|Homo sapiens TAF1-like RNA |
| | | | | polymerase II, TATA box binding |
| | | | | protein (TBP)-associated factor, |
| | | | | 210 kDa (TAF1L), mRNA. |
| hs\|chr9: 34456212-34456272 | A_16_P02093220 | entg\|DNAI1 | ref\|NM_012144 | ref\|Homo sapiens dynein, axonemal, |
| | | | | intermediate chain 1 (DNAI1), |
| | | | | mRNA. |
| hs\|chr9: 34546559-34546619 | A_16_P02093356 | entg\|CNTFR | ref\|NM_001842\| | ref\|Homo sapiens ciliary |
| | | | ref\|NM_147164 | neurotrophic factor receptor |
| | | | | (CNTFR), transcript variant 2, |
| | | | | mRNA. |
| hs\|chr9: 346040 | A_14_P119846 | entg\|DCTN3 | ref\|NM_007234\| | ref\|Homo sapiens dynactin 3 (p22) |
| | | | ref\|NM_024348 | (DCTN3), transcript variant 1, |
| | | | | mRNA. |
| hs\|chr9: 5289936-5289996 | A_14_P116102 | entg\|RLN2 | ref\|NM_005059\| | ref\|Homo sapiens relaxin 2 (RLN2), |
| | | | ref\|NM_134441 | transcript variant 2, mRNA. |
| hs\|chr9: 5325064-5325124 | A_14_P114773 | entg\|RLN1 | ref\|NM_006911 | ref\|Homo sapiens relaxin 1 (RLN1), |
| | | | | mRNA. |
| hs\|chr9: 5442455-5442515 | A_16_P02052226 | entg\|CD274 | ref\|NM_014143 | ref\|Homo sapiens CD274 molecule |
| | | | | (CD274), mRNA. |
| hs\|chr9: 5500694-5500754 | A_14_P111176 | entg\|PDCD1LG2 | ref\|NM_025239 | ref\|Homo sapiens programmed cell |
| | | | | death 1 ligand 2 (PDCD1LG2), |
| | | | | mRNA. |
| hs\|chr9: 5647673-5647733 | A_16_P18538540 | entg\|KIAA1432 | ref\|NM_020829 | ref\|Homo sapiens KIAA1432 |
| | | | | (KIAA1432), mRNA. |
| hs\|chr9: 5775790-5775850 | A_16_P02052628 | entg\|KIAA1815 | ref\|NM_024896 | ref\|Homo sapiens KIAA1815 |
| | | | | (KIAA1815), mRNA. |
| hs\|chr9: 5883012-5883072 | A_16_P38635796 | entg\|MLANA | ref\|NM_005511 | ref\|Homo sapiens melan-A |
| | | | | (MLANA), mRNA. |
| hs\|chr9: 5909394-5909454 | A_16_P38635860 | entg\|KIAA2026 | ref\|NM_001017969 | ref\|Homo sapiens KIAA2026 |
| | | | | (KIAA2026), mRNA. |
| hs\|chr9: 6004773-6004833 | A_16_P02052992 | entg\|RANBP6 | ref\|NM_012416 | ref\|Homo sapiens RAN binding |
| | | | | protein 6 (RANBP6), mRNA. |
| hs\|chr9: 74466388-74466448 | A_16_P38747153 | entg\|TMC1 | ref\|NM_138691 | ref\|Homo sapiens transmembrane |
| | | | | channel-like 1 (TMC1), mRNA. |
| hs\|chr9: 74714433-74714493 | A_14_P115606 | entg\|ALDH1A1 | ref\|NM_000689 | ref\|Homo sapiens aldehyde |
| | | | | dehydrogenase 1 family, member A1 |
| | | | | (ALDH1A1), mRNA. |
| hs\|chr9: 84795145-84795200 | A_14_P109470 | entg\|RASEF | ref\|NM_152573 | ref\|Homo sapiens RAS and EF-hand |
| | | | | domain containing (RASEF), |
| | | | | mRNA. |
| hs\|chr9: 95266909-95266969 | A_16_P02134013 | entg\|FAM120A | ref\|NM_014612 | ref\|Homo sapiens family with |
| | | | | sequence similarity 120A |
| | | | | (FAM120A), mRNA. |
| hs\|chr9: 95380940-95381000 | A_16_P02134237 | entg\|PHF2 | ref\|NM_005392 | ref\|Homo sapiens PHD finger protein |
| | | | | 2 (PHF2), mRNA. |
| hs\|chr9: 95754117-95754177 | A_14_P128493 | entg\|BARX1 | ref\|NM_021570 | ref\|Homo sapiens BarH-like |
| | | | | homeobox 1 (BARX1), mRNA. |
| hs\|chr9: 973203-973263 | A_14_P115828 | entg\|DMRT3 | ref\|NM_021240 | ref\|Homo sapiens doublesex and |
| | | | | mab-3 related transcription factor 3 |
| | | | | (DMRT3), mRNA. |
| hs\|chr10: 108327011-108327071 | A_14_P111028 | entg\|SORCS1 | ref\|NM_001013031\| | ref\|Homo sapiens sortilin-related |
| | | | ref\| | VPS10 domain containing receptor 1 |
| | | | NM_052918 | (SORCS1), transcript variant 2, |
| | | | | mRNA. |
| hs\|chr10: 7248810-7248870 | A_14_P125204 | entg\|SFMBT2 | ref\|NM_001029880 | ref\|Homo sapiens Scm-like with four |
| | | | | mbt domains 2 (SFMBT2), mRNA. |
| hs\|chr10: 80638633-80638693 | A_16_P02300882 | entg\|ZMIZ1 | ref\|NM_020338 | ref\|Homo sapiens zinc finger, MIZ- |
| | | | | type containing 1 (ZMIZ1), mRNA. |
| hs\|chr10: 80779982-80780039 | A_14_P131576 | entg\|PPIF | ref\|NM_005729 | ref\|Homo sapiens peptidylprolyl |
| | | | | isomerase F (cyclophilin F) (PPIF), |
| | | | | nuclear gene encoding mitochondrial |
| | | | | protein, mRNA. |
| hs\|chr10: 80813618-80813678 | A_16_P39101109 | entg\|C10orf56 | ref\|NM_153367 | ref\|Homo sapiens chromosome 10 |
| | | | | open reading frame 56 (C10orf56), |
| | | | | mRNA. |
| hs\|chr10: 81687480-81687531 | A_14_P139642 | entg\|SFTPD | ref\|NM_003019 | ref\|Homo sapiens surfactant, |
| | | | | pulmonary-associated protein D |
| | | | | (SFTPD), mRNA. |
| hs\|chr10: 81885475-81885535 | A_16_P02301616 | entg\|PLAC9 | ref\|NM_001012973 | ref\|Homo sapiens placenta-specific 9 |
| | | | | (PLAC9), mRNA. |
| hs\|chr10: 81915876-81915936 | A_16_P39103644 | entg\|ANXA11 | ref\|NM_001157\| | ref\|Homo sapiens annexin A11 |
| | | | ref\|NM_145868\| | (ANXA11), transcript variant a, |
| | | | ref\| | mRNA. |
| | | | NM_145869 | |
| hs\|chr10: 82021610-82021670 | A_16_P39103937 | entg\|MAT1A | ref\|NM_000429 | ref\|Homo sapiens methionine |
| | | | | adenosyltransferase I, alpha |
| | | | | (MAT1A), mRNA. |
| hs\|chr10: 82109832-82109885 | A_14_P116526 | entg\|DYDC2 | ref\|NM_032372 | ref\|Homo sapiens DPY30 domain |
| | | | | containing 2 (DYDC2), mRNA. |
| hs\|chr10: 82211903-82211963 | A_16_P18994582 | entg\|TSPAN14 | ref\|NM_030927 | ref\|Homo sapiens tetraspanin 14 |
| | | | | (TSPAN14), mRNA. |
| hs\|chr11: 40094067-40094127 | A_16_P02433770 | entg\|LRRC4C | ref\|NM_020929 | ref\|Homo sapiens leucine rich repeat |
| | | | | containing 4C (LRRC4C), mRNA. |
| hs\|chr11: 4060785-4060845 | A_16_P19134535 | entg\|STIM1 | ref\|NM_003156 | ref\|Homo sapiens stromal interaction |
| | | | | molecule 1 (STIM1), mRNA. |
| hs\|chr11: 4083821-4083881 | A_14_P117324 | entg\|RRM1 | ref\|NM_001033 | ref\|Homo sapiens ribonucleotide |
| | | | | reductase M1 polypeptide (RRM1), |
| | | | | mRNA. |
| hs\|chr11: 4362794-4362854 | A_14_P201124 | entg\|TRIM21 | ref\|NM_003141 | ref\|Homo sapiens tripartite motif- |
| | | | | containing 21 (TRIM21), mRNA. |
| hs\|chr11: 4564618-4564678 | A_16_P02383787 | entg\|OR52I2 | ref\|NM_001005170 | ref\|nomo sapiens olfactory receptor, |
| | | | | family 52, subfamily I, member 2 |
| | | | | (OR52I2), mRNA. |
| hs\|chr11: 4580158-4580214 | A_14_P132863 | entg\|TRIM68 | ref\|NM_018073 | ref\|Homo sapiens tripartite motif- |
| | | | | containing 68 (TRIM68), mRNA. |
| hs\|chr11: 4631306-4631366 | A_14_P121111 | entg\|OR51E1 | ref\|NM_152430 | ref\|Homo sapiens olfactory receptor, |
| | | | | family 51, subfamily E, member 1 |
| | | | | (OR51E1), mRNA. |
| hs\|chr11: 4800123-4800183 | A_16_P02384155 | entg\|OR51F2 | ref\|NM_001004753 | ref\|Homo sapiens olfactory receptor, |
| | | | | family 51, subfamily F, member 2 |
| | | | | (OR51F2), mRNA. |
| hs\|chr11: 4826070-4826130 | A_16_P39251123 | entg\|OR51S1 | ref\|NM_001004758 | ref\|Homo sapiens olfactory receptor, |
| | | | | family 51, subfamily S, member 1 |
| | | | | (OR51S1), mRNA. |
| hs\|chr11: 4892946-4893006 | A_16_P02384301 | entg\|OR51G2 | ref\|NM_001005238 | ref\|Homo sapiens olfactory receptor, |
| | | | | family 51, subfamily G, member 2 |
| | | | | (OR51G2), mRNA. |
| hs\|chr11: 4967429-4967485 | A_14_P201783 | entg\|MMP26 | ref\|NM_021801 | ref\|Homo sapiens matrix |
| | | | | metallopeptidase 26 (MMP26), |
| | | | | mRNA. |
| hs\|chr11: 4977379-4977439 | A_16_P19136601 | entg\|OR51L1 | ref\|NM_001004755 | ref\|Homo sapiens olfactory receptor, |
| | | | | family 51, subfamily L, member 1 |
| | | | | (OR51L1), mRNA. |
| hs\|chr11: 5024325-5024385 | A_16_P02384493 | entg\|OR52J3 | ref\|NM_001001916 | ref\|Homo sapiens olfactory receptor, |
| | | | | family 52, subfamily J, member 3 |
| | | | | (OR52J3), mRNA. |
| hs\|chr11: 72784964-72785022 | A_14_P201861 | entg\|TNFRSF19L | ref\|NM_152222\| | ref\|Homo sapiens tumor necrosis |
| | | | ref\|NM_032871 | factor receptor superfamily, member |
| | | | | 19-like (TNFRSF19L), transcript |
| | | | | variant 2, mRNA. |
| hs\|chr11: 72803772-72803832 | A_16_P02468705 | entg\|KIAA0280 | ref\|NM_015159 | ref\|Homo sapiens KIAA0280 |
| | | | | (KIAA0280), mRNA. |
| hs\|chr11: 73036040-73036100 | A_14_P112326 | entg\|PLEKHB1 | ref\|NM_021200 | ref\|Homo sapiens pleckstrin |
| | | | | homology domain containing, family |
| | | | | B (evectins) member 1 (PLEKHB1), |
| | | | | mRNA. |
| hs\|chr11: 73068322-73068382 | A_14_P112013 | entg\|RAB6A | ref\|NM_002869\| | ref\|Homo sapiens RAB6A, member |
| | | | ref\|NM_198896 | RAS oncogene family (RAB6A), |
| | | | | transcript variant 1, mRNA. |
| hs\|chr11: 73177046-73177106 | A_14_P124013 | entg\|MRPL48 | ref\|NM_016055 | ref\|Homo sapiens mitochondrial |
| | | | | ribosomal protein L48 (MRPL48), |
| | | | | nuclear gene encoding mitochondrial |
| | | | | protein, mRNA. |
| hs\|chr11: 8370101-8370161 | A_14_P104176 | entg\|STK33 | ref\|NM_030906 | ref\|Homo sapiens serine/threonine |
| | | | | kinase 33 (STK33), mRNA. |
| hs\|chr11: 8663250-8663310 | A_14_P100322 | entg\|RPL27A | ref\|NM_000990 | ref\|Homo sapiens ribosomal protein |
| | | | | L27a (RPL27A), mRNA. |
| hs\|chr11: 8671715-8671775 | A_14_P114318 | entg\|ST5 | ref\|NM_213618\| | ref\|Homo sapiens suppression of |
| | | | ref\|NM_139157\| | tumorigenicity 5 (ST5), transcript |
| | | | ref\| | variant 3, mRNA. |
| | | | NM_005418 | |
| hs\|chr12: 116961616-116961676 | A_16_P19698214 | entg\|WSB2 | ref\|NM_018639 | ref\|Homo sapiens WD repeat and |
| | | | | SOCS box-containing 2 (WSB2), |
| | | | | mRNA. |
| hs\|chr12: 116987912-116987972 | A_14_P121974 | entg\|FLJ20674 | ref\|NM_019086 | ref\|Homo sapiens hypothetical |
| | | | | protein FLJ20674 (FLJ20674), |
| | | | | mRNA. |
| hs\|chr12: 117066210-117066270 | A_14_P135050 | entg\|PEBP1 | ref\|NM_002567 | ref\|Homo sapiens |
| | | | | phosphatidylethanolamine binding |
| | | | | protein 1 (PEBP1), mRNA. |
| hs\|chr12: 117074739-117074791 | A_14_P102661 | entg\|TAOK3 | ref\|NM_016281 | ref\|Homo sapiens TAO kinase 3 |
| | | | | (TAOK3), mRNA. |
| hs\|chr12: 117305180-117305240 | A_16_P19698995 | entg\|SUDS3 | ref\|NM_022491 | ref\|Homo sapiens suppressor of |
| | | | | defective silencing 3 homolog (S. cerevisiae) |
| | | | | (SUDS3), mRNA. |
| hs\|chr12: 117913638-117913698 | A_14_P136339 | entg\|KIAA1853 | ref\|NM_194286 | ref\|Homo sapiens KIAA1853 |
| | | | | (KIAA1853), mRNA. |
| hs\|chr12: 118104106-118104166 | A_16_P02713084 | entg\|HSPB8 | ref\|NM_014365 | ref\|Homo sapiens heat shock 22 kDa |
| | | | | protein 8 (HSPB8), mRNA. |
| hs\|chr12: 118257097-118257157 | A_14_P103699 | entg\|CCDC60 | ref\|NM_178499 | ref\|Homo sapiens coiled-coil domain |
| | | | | containing 60 (CCDC60), mRNA. |
| hs\|chr12: 13824676-13824736 | A_16_P19463489 | entg\|GRIN2B | ref\|NM_000834 | ref\|Homo sapiens glutamate receptor, |
| | | | | ionotropic, N-methyl D-aspartate 2B |
| | | | | (GRIN2B), mRNA. |
| hs\|chr12: 18729777-18729832 | A_14_P131918 | entg\|PLCZ1 | ref\|NM_033123 | ref\|Homo sapiens phospholipase C, |
| | | | | zeta 1 (PLCZ1), mRNA. |
| hs\|chr12: 18783301-18783361 | A_14_P133697 | entg\|CAPZA3 | ref\|NM_033328 | ref\|Homo sapiens capping protein |
| | | | | (actin filament) muscle Z-line, alpha |
| | | | | 3 (CAPZA3), mRNA. |
| hs\|chr12: 19175789-19175849 | A_14_P201066 | entg\|PLEKHA5 | ref\|NM_019012 | ref\|Homo sapiens pleckstrin |
| | | | | homology domain containing, family |
| | | | | A member 5 (PLEKHA5), mRNA. |
| hs\|chr12: 2449246-2449306 | A_16_P19436966 | entg\|CACNA1C | ref\|NM_000719 | ref\|Homo sapiens calcium channel, |
| | | | | voltage-dependent, L type, alpha 1C |
| | | | | subunit (CACNA1C), mRNA. |
| hs\|chr12: 2776792-2776852 | A_14_P109319 | entg\|FKBP4 | ref\|NM_002014 | ref\|Homo sapiens FK506 binding |
| | | | | protein 4, 59 kDa (FKBP4), mRNA. |
| hs\|chr12: 2795003-2795063 | A_14_P138527 | entg\|ITFG2 | ref\|NM_018463 | ref\|Homo sapiens integrin alpha FG- |
| | | | | GAP repeat containing 2 (ITFG2), |
| | | | | mRNA. |
| hs\|chr12: 2807919-2807979 | A_14_P126511 | entg\|NRIP2 | ref\|NM_031474 | ref\|Homo sapiens nuclear receptor |
| | | | | interacting protein 2 (NRIP2), |
| | | | | mRNA. |
| hs\|chr12: 2837382-2837442 | A_16_P02559502 | entg\|FOXM1 | ref\|NM_021953\| | ref\|Homo sapiens forkhead box M1 |
| | | | ref\|NM_202002\| | (FOXM1), transcript variant 2, |
| | | | ref\| | mRNA. |
| | | | NM_202003 | |
| hs\|chr12: 2874871-2874931 | A_16_P02559551 | entg\|TULP3 | ref\|NM_003324 | ref\|Homo sapiens tubby like protein |
| | | | | 3 (TULP3), mRNA. |
| hs\|chr12: 2940552-2940612 | A_16_P02559631 | entg\|TEAD4 | ref\|NM_003213\| | ref\|Homo sapiens TEA domain |
| | | | ref\|NM_201441\| | family member 4 (TEAD4), |
| | | | ref\| | transcript variant 1, mRNA. |
| | | | NM_201443 | |
| hs\|chr12: 33419670-33419730 | A_16_P19509071 | entg\|SYT10 | ref\|NM_198992 | ref\|Homo sapiens synaptotagmin X |
| | | | | (SYT10), mRNA. |
| hs\|chr12: 48383961-48384021 | A_16_P02617401 | entg\|FMNL3 | ref\|NM_175736\| | ref\|Homo sapiens formin-like 3 |
| | | | ref\|NM_198900 | (FMNL3), transcript variant 1, |
| | | | | mRNA. |
| hs\|chr12: 48432549-48432609 | A_14_P138138 | entg\|TEGT | ref\|NM_003217 | ref\|Homo sapiens testis enhanced |
| | | | | gene transcript (BAX inhibitor 1) |
| | | | | (TEGT), mRNA. |
| hs\|chr12: 48484284-48484343 | A_16_P02617498 | entg\|LOC283331 | ref\|NM_001037806 | ref\|Homo sapiens hypothetical |
| | | | | protein LOC283331 (LOC283331), |
| | | | | mRNA. |
| hs\|chr12: 48520124-48520184 | A_14_P127523 | entg\|BCDIN3D | ref\|NM_181708 | ref\|Homo sapiens BCDIN3 domain |
| | | | | containing (BCDIN3D), mRNA. |
| hs\|chr12: 48548907-48548967 | A_16_P02617570 | entg\|FAIM2 | ref\|NM_012306 | ref\|Homo sapiens Fas apoptotic |
| | | | | inhibitory molecule 2 (FAIM2), |
| | | | | mRNA. |
| hs\|chr12: 48637051-48637111 | A_14_P122083 | entg\|AQP2 | ref\|NM_000486 | ref\|Homo sapiens aquaporin 2 |
| | | | | (collecting duct) (AQP2), mRNA. |
| hs\|chr12: 48656650-48656700 | A_14_P115654 | entg\|AQP6 | ref\|NM_001652 | ref\|Homo sapiens aquaporin 6, |
| | | | | kidney specific (AQP6), mRNA. |
| hs\|chr12: 48677046-48677104 | A_16_P19538589 | entg\|RACGAP1 | ref\|NM_013277 | ref\|Homo sapiens Rac GTPase |
| | | | | activating protein 1 (RACGAP1), |
| | | | | mRNA. |
| hs\|chr12: 48739098-48739147 | A_16_P02617871 | entg\|ACCN2 | ref\|NM_001095\| | ref\|Homo sapiens amiloride-sensitive |
| | | | ref\|NM_020039 | cation channel 2, neuronal (ACCN2), |
| | | | | transcript variant 2, mRNA. |
| hs\|chr12: 48766640-48766700 | A_14_P118192 | entg\|SMARCD1 | ref\|NM_003076\| | ref\|Homo sapiens SWI/SNF related, |
| | | | ref\|NM_139071 | matrix associated, actin dependent |
| | | | | regulator of chromatin, subfamily d, |
| | | | | member 1 (SMARCD1), transcript |
| | | | | variant 1, mRNA. |
| hs\|chr12: 48787349-48787409 | A_14_P135604 | entg\|GPD1 | ref\|NM_005276 | ref\|Homo sapiens glycerol-3- |
| | | | | phosphate dehydrogenase 1 (soluble) |
| | | | | (GPD1), mRNA. |
| hs\|chr12: 48810433-48810493 | A_14_P128293 | entg\|LASS5 | ref\|NM_147190 | ref\|Homo sapiens LAG1 homolog, |
| | | | | ceramide synthase 5 (S. cerevisiae) |
| | | | | (LASS5), mRNA. |
| hs\|chr12: 48856779-48856839 | A_14_P100531 | entg\|LIMA1 | ref\|NM_016357 | ref\|Homo sapiens LIM domain and |
| | | | | actin binding 1 (LIMA1), mRNA. |
| hs\|chr12: 57554140-57554200 | A_14_P201282 | entg\|LRIG3 | ref\|NM_153377 | ref\|Homo sapiens leucine-rich |
| | | | | repeats and immunoglobulin-like |
| | | | | domains 3 (LRIG3), mRNA. |
| hs\|chr12: 68933447-68933507 | A_14_P139238 | entg\|CNOT2 | ref\|NM_014515 | ref\|Homo sapiens CCR4-NOT |
| | | | | transcription complex, subunit 2 |
| | | | | (CNOT2), mRNA. |
| hs\|chr12: 69047969-69048029 | A_14_P103659 | entg\|KCNMB4 | ref\|NM_014505 | ref\|Homo sapiens potassium large |
| | | | | conductance calcium-activated |
| | | | | channel, subfamily M, beta member |
| | | | | 4 (KCNMB4), mRNA. |
| hs\|chr12: 69204519-69204579 | A_16_P02645741 | entg\|PTPRB | ref\|NM_002837 | ref\|Homo sapiens protein tyrosine |
| | | | | phosphatase, receptor type, B |
| | | | | (PTPRB), mRNA. |
| hs\|chr12: 69318739-69318799 | A_14_P128178 | entg\|PTPRR | ref\|NM_130846\| | ref\|Homo sapiens protein tyrosine |
| | | | ref\|NM_002849 | phosphatase, receptor type, R |
| | | | | (PTPRR), transcript variant 2, |
| | | | | mRNA. |
| hs\|chr12: 69805406-69805466 | A_16_P19587963 | entg\|TSPAN8 | ref\|NM_004616 | ref\|Homo sapiens tetraspanin 8 |
| | | | | (TSPAN8), mRNA. |
| hs\|chr12: 7773440-7773500 | A_16_P02566432 | entg\|CLEC4C | ref\|NM_130441\| | ref\|Homo sapiens C-type lectin |
| | | | ref\|NM_203503 | domain family 4, member C |
| | | | | (CLEC4C), transcript variant 1, |
| | | | | mRNA. |
| hs\|chr12: 7837177-7837237 | A_14_P123398 | entg\|NANOG | ref\|NM_024865 | ref\|Homo sapiens Nanog homeobox |
| | | | | (NANOG), mRNA. |
| hs\|chr12: 7859301-7859361 | A_16_P39576369 | entg\|SLC2A14 | ref\|NM_153449 | ref\|Homo sapiens solute carrier |
| | | | | family 2 (facilitated glucose |
| | | | | transporter), member 14 (SLC2A14), |
| | | | | mRNA. |
| hs\|chr12: 7963158-7963208 | A_14_P129931 | entg\|SLC2A3 | ref\|NM_006931 | ref\|Homo sapiens solute carrier |
| | | | | family 2 (facilitated glucose |
| | | | | transporter), member 3 (SLC2A3), |
| | | | | mRNA. |
| hs\|chr12: 8084969-8085029 | A_16_P19450362 | entg\|FOXJ2 | ref\|NM_018416 | ref\|Homo sapiens forkhead box J2 |
| | | | | (FOXJ2), mRNA. |
| hs\|chr12: 8129279-8129339 | A_14_P119437 | entg\|NECAP1 | ref\|NM_015509 | ref\|Homo sapiens NECAP |
| | | | | endocytosis associated 1 (NECAP1), |
| | | | | mRNA. |
| hs\|chr12: 8173176-8173236 | A_14_P101395 | entg\|CLEC4A | ref\|NM_016184\| | ref\|Homo sapiens C-type lectin |
| | | | ref\|NM_194447\| | domain family 4, member A |
| | | | ref\| | (CLEC4A), transcript variant 1, |
| | | | NM_194448\| | mRNA. |
| | | | ref\|NM_194450 | |
| hs\|chr12: 87414961-87415021 | A_14_P107977 | entg\|KITLG | ref\|NM_000899\| | ref\|Homo sapiens KIT ligand |
| | | | ref\|NM_003994 | (KITLG), transcript variant b, |
| | | | | mRNA. |
| hs\|chr13: 111773394-111773454 | A_14_P110385 | entg\|SOX1 | ref\|NM_005986 | ref\|Homo sapiens SRY (sex |
| | | | | determining region Y)-box 1 |
| | | | | (SOX1), mRNA. |
| hs\|chr13: 24246993-24247053 | A_16_P02739242 | entg\|RNF17 | ref\|NM_031277 | ref\|Homo sapiens ring finger protein |
| | | | | 17 (RNF17), mRNA. |
| hs\|chr13: 24356587-24356647 | A_16_P39886291 | entg\|CENPJ | ref\|NM_018451 | ref\|Homo sapiens centromere protein |
| | | | | J (CENPJ), mRNA. |
| hs\|chr13: 24641061-24641121 | A_14_P104159 | entg\|FAM123A | ref\|NM_152704\| | ref\|Homo sapiens family with |
| | | | ref\|NM_199138 | sequence similarity 123A |
| | | | | (FAM123A), transcript variant 1, |
| | | | | mRNA. |
| hs\|chr13: 24718602-24718662 | A_16_P19749709 | entg\|MTMR6 | ref\|NM_004685 | ref\|Homo sapiens myotubularin |
| | | | | related protein 6 (MTMR6), mRNA. |
| hs\|chr13: 24774961-24775021 | A_16_P39887322 | entg\|NUPL1 | ref\|NM_001008565\| | ref\|Homo sapiens nucleoporin like 1 |
| | | | ref\| | (NUPL1), transcript variant 3, |
| | | | NM_001008564\| | mRNA. |
| | | | ref\|NM_014089 | |
| hs\|chr13: 24851253-24851313 | A_16_P02740008 | entg\|ATP8A2 | ref\|NM_016529 | ref\|Homo sapiens ATPase, |
| | | | | aminophospholipid transporter-like, |
| | | | | Class I, type 8A, member 2 |
| | | | | (ATP8A2), mRNA. |
| hs\|chr13: 31893609-31893669 | A_16_P02750271 | entg\|CG018 | ref\|NM_001079691\| | ref\|Homo sapiens hypothetical gene |
| | | | ref\| | CG018 (CG018), transcript variant |
| | | | NM_052818 | 2, mRNA. |
| hs\|chr13: 31990096-31990156 | A_16_P39905438 | entg\|PFAAP5 | ref\|NM_014887 | ref\|Homo sapiens phosphonoformate |
| | | | | immuno-associated protein 5 |
| | | | | (PFAAP5), mRNA. |
| hs\|chr13: 40602940-40602995 | A_14_P121163 | entg\|KBTBD6 | ref\|NM_152903 | ref\|Homo sapiens kelch repeat and |
| | | | | BTB (POZ) domain containing 6 |
| | | | | (KBTBD6), mRNA. |
| hs\|chr13: 44657420-44657480 | A_16_P02769040 | entg\|GTF2F2 | ref\|NM_004128 | ref\|Homo sapiens general |
| | | | | transcription factor IIF, polypeptide |
| | | | | 2 (30 kD subunit) (GTF2F2), mRNA. |
| hs\|chr13: 44810878-44810938 | A_14_P139052 | entg\|TPT1 | ref\|NM_003295 | ref\|Homo sapiens tumor protein, |
| | | | | translationally-controlled 1 (TPT1), |
| | | | | mRNA. |
| hs\|chr13: 44876458-44876518 | A_16_P02769366 | entg\|SLC25A30 | ref\|NM_001010875 | ref\|Homo sapiens solute carrier |
| | | | | family 25, member 30 (SLC25A30), |
| | | | | mRNA. |
| hs\|chr13: 44946064-44946124 | A_16_P02769452 | entg\|COG3 | ref\|NM_031431 | ref\|Homo sapiens component of |
| | | | | oligomeric golgi complex 3 (COG3), |
| | | | | mRNA. |
| hs\|chr13: 45175772-45175831 | A_14_P104243 | entg\|SPERT | ref\|NM_152719 | ref\|Homo sapiens spermatid |
| | | | | associated (SPERT), mRNA. |
| hs\|chr13: 45256466-45256523 | A_16_P19800028 | entg\|LOC283514 | ref\|NM_198849 | ref\|Homo sapiens similar to seven in |
| | | | | absentia 2 (LOC283514), mRNA. |
| hs\|chr13: 45434467-45434527 | A_16_P19800508 | entg\|ZC3H13 | ref\|NM_015070 | ref\|Homo sapiens zinc finger CCCH- |
| | | | | type containing 13 (ZC3H13), |
| | | | | mRNA. |
| hs\|chr13: 60881928-60881988 | A_14_P100254 | entg\|PCDH20 | ref\|NM_022843 | ref\|Homo sapiens protocadherin 20 |
| | | | | (PCDH20), mRNA. |
| hs\|chr13: 73160850-73160910 | A_14_P126532 | entg\|KLF12 | ref\|NM_007249 | ref\|Homo sapiens Kruppel-like factor |
| | | | | 12 (KLF12), mRNA. |
| hs\|chr13: 93347774-93347834 | A_16_P19915260 | entg\|GPC6 | ref\|NM_005708 | ref\|Homo sapiens glypican 6 |
| | | | | (GPC6), mRNA. |
| hs\|chr14: 18624382-18624442 | A_16_P02870240 | entg\|ACTBL1 | ref\|NM_001005356 | ref\|Homo sapiens ACTBL1 protein |
| | | | | (ACTBL1), transcript variant POTE- |
| | | | | 14A, mRNA. |
| hs\|chr14: 41151632-41151692 | A_16_P20021229 | entg\|LRFN5 | ref\|NM_152447 | ref\|Homo sapiens leucine rich repeat |
| | | | | and fibronectin type III domain |
| | | | | containing 5 (LRFN5), mRNA. |
| hs\|chr14: 51037524-51037584 | A_16_P40185330 | entg\|FRMD6 | ref\|NM_001042481 | ref\|Homo sapiens FERM domain |
| | | | | containing 6 (FRMD6), transcript |
| | | | | variant 1, mRNA. |
| hs\|chr14: 51402028-51402088 | A_16_P20043525 | entg\|GNG2 | ref\|NM_053064 | ref\|Homo sapiens guanine nucleotide |
| | | | | binding protein (G protein), gamma |
| | | | | 2 (GNG2), mRNA. |
| hs\|chr14: 51809818-51809878 | A_14_P102113 | entg\|PTGDR | ref\|NM_000953 | ref\|Homo sapiens prostaglandin D2 |
| | | | | receptor (DP) (PTGDR), mRNA. |
| hs\|chr14: 51852545-51852605 | A_16_P40187454 | entg\|PTGER2 | ref\|NM_000956 | ref\|Homo sapiens prostaglandin E |
| | | | | receptor 2 (subtype EP2), 53 kDa |
| | | | | (PTGER2), mRNA. |
| hs\|chr14: 51967479-51967539 | A_14_P118876 | entg\|KIAA1344 | ref\|NM_020784 | ref\|Homo sapiens KIAA1344 |
| | | | | (KIAA1344), mRNA. |
| hs\|chr14: 52178964-52179024 | A_14_P139028 | entg\|ERO1L | ref\|NM_014584 | ref\|Homo sapiens ERO1-like |
| | | | | (S. cerevisiae) (ERO1L), mRNA. |
| hs\|chr14: 52247459-52247519 | A_16_P40188360 | entg\|PSMC6 | ref\|NM_002806 | ref\|Homo sapiens proteasome |
| | | | | (prosome, macropain) 26S subunit, |
| | | | | ATPase, 6 (PSMC6), mRNA. |
| hs\|chr14: 52269683-52269743 | A_16_P20045531 | entg\|STYX | ref\|NM_145251 | ref\|Homo sapiens |
| | | | | serine/threonine/tyrosine interacting |
| | | | | protein (STYX), mRNA. |
| hs\|chr14: 52315755-52315815 | A_14_P112387 | entg\|GNPNAT1 | ref\|NM_198066 | ref\|Homo sapiens glucosamine- |
| | | | | phosphate N-acetyltransferase 1 |
| | | | | (GNPNAT1), mRNA. |
| hs\|chr14: 52395987-52396047 | A_14_P114129 | entg\|PLEKHC1 | ref\|NM_006832 | ref\|Homo sapiens pleckstrin |
| | | | | homology domain containing, family |
| | | | | C (with FERM domain) member 1 |
| | | | | (PLEKHC1), mRNA. |
| hs\|chr14: 52582809-52582869 | A_16_P20046268 | entg\|DDHD1 | ref\|NM_030637 | ref\|Homo sapiens DDHD domain |
| | | | | containing 1 (DDHD1), mRNA. |
| hs\|chr14: 69909230-69909290 | A_16_P20087518 | entg\|SYNJ2BP | ref\|NM_018373 | ref\|Homo sapiens synaptojanin 2 |
| | | | | binding protein (SYNJ2BP), mRNA. |
| hs\|chr14: 69996010-69996069 | A_14_P137791 | entg\|ADAM21 | ref\|NM_003813 | ref\|Homo sapiens ADAM |
| | | | | metallopeptidase domain 21 |
| | | | | (ADAM21), mRNA. |
| hs\|chr14: 70060228-70060288 | A_14_P133878 | entg\|ADAM20 | ref\|NM_003814 | ref\|Homo sapiens ADAM |
| | | | | metallopeptidase domain 20 |
| | | | | (ADAM20), mRNA. |
| hs\|chr14: 70121389-70121449 | A_16_P40232055 | entg\|MED6 | ref\|NM_005466 | ref\|Homo sapiens mediator of RNA |
| | | | | polymerase II transcription, subunit |
| | | | | 6 homolog (S. cerevisiae) (MED6), |
| | | | | mRNA. |
| hs\|chr14: 70266111-70266171 | A_16_P02940090 | entg\|MAP3K9 | ref\|NM_033141 | ref\|Homo sapiens mitogen-activated |
| | | | | protein kinase kinase kinase 9 |
| | | | | (MAP3K9), mRNA. |
| hs\|chr14: 70445875-70445935 | A_16_P40232863 | entg\|PCNX | ref\|NM_014982 | ref\|Homo sapiens pecanex homolog |
| | | | | (Drosophila) (PCNX), mRNA. |
| hs\|chr14: 90251952-90252012 | A_16_P02969763 | entg\|TTC7B | ref\|NM_001010854 | ref\|Homo sapiens tetratricopeptide |
| | | | | repeat domain 7B (TTC7B), mRNA. |
| hs\|chr14: 90407970-90408030 | A_16_P20138158 | entg\|RPS6KA5 | ref\|NM_004755 | ref\|Homo sapiens ribosomal protein |
| | | | | S6 kinase, 90 kDa, polypeptide 5 |
| | | | | (RPS6KA5), transcript variant 1, |
| | | | | mRNA. |
| hs\|chr15: 18864581-18864641 | A_16_P20178423 | entg\|LOC283755 | ref\|NM_001024682 | ref\|Homo sapiens hypothetical |
| | | | | protein LOC283755 (LOC283755), |
| | | | | mRNA. |
| hs\|chr15: 30113327-30113387 | A_14_P111224 | entg\|CHRNA7 | ref\|NM_000746 | ref\|Homo sapiens cholinergic |
| | | | | receptor, nicotinic, alpha 7 |
| | | | | (CHRNA7), mRNA. |
| hs\|chr16: 10141332-10141391 | A_16_P20399197 | entg\|GRIN2A | ref\|NM_000833 | ref\|Homo sapiens glutamate receptor, |
| | | | | ionotropic, N-methyl D-aspartate 2A |
| | | | | (GRIN2A), mRNA. |
| hs\|chr16: 18701946-18702006 | A_14_P116370 | entg\|RPS15A | ref\|NM_001019\| | ref\|Homo sapiens ribosomal protein |
| | | | ref\|NM_001030009 | S15a (RPS15A), transcript variant 2, |
| | | | | mRNA. |
| hs\|chr16: 18714369-18714429 | A_14_P128547 | entg\|ARL6IP1 | ref\|NM_015161 | ref\|Homo sapiens ADP-ribosylation |
| | | | | factor-like 6 interacting protein 1 |
| | | | | (ARL6IP1), mRNA. |
| hs\|chr16: 18724679-18724739 | A_16_P20418428 | entg\|SMG1 | ref\|NM_015092 | ref\|Homo sapiens PI-3-kinase-related |
| | | | | kinase SMG-1 (SMG1), mRNA. |
| hs\|chr16: 18903692-18903751 | A_14_P132624 | entg\|TMC7 | ref\|NM_024847 | ref\|Homo sapiens transmembrane |
| | | | | channel-like 7 (TMC7), mRNA. |
| hs\|chr16: 18988533-18988593 | A_14_P100700 | entg\|COQ7 | ref\|NM_016138 | ref\|Homo sapiens coenzyme Q7 |
| | | | | homolog, ubiquinone (yeast) |
| | | | | (COQ7), mRNA. |
| hs\|chr16: 1902697-1902750 | A_16_P03102699 | entg\|HS3ST6 | ref\|NM_001009606 | ref\|Homo sapiens heparan sulfate |
| | | | | (glucosamine) 3-O-sulfotransferase 6 |
| | | | | (HS3ST6), mRNA. |
| hs\|chr16: 19040117-19040177 | A_16_P20419106 | entg\|LOC162073 | ref\|NM_001034841 | ref\|Homo sapiens hypothetical |
| | | | | protein LOC162073 (LOC162073), |
| | | | | mRNA. |
| hs\|chr16: 19092408-19092468 | A_16_P40576766 | entg\|SYT17 | ref\|NM_016524 | ref\|Homo sapiens synaptotagmin |
| | | | | XVII (SYT17), mRNA. |
| hs\|chr16: 1928263-1928318 | A_14_P134786 | entg\|SEPX1 | ref\|NM_016332 | ref\|Homo sapiens selenoprotein X, 1 |
| | | | | (SEPX1), mRNA. |
| hs\|chr16: 1935020-1935070 | A_16_P03102742 | entg\|RPL3L | ref\|NM_005061 | ref\|Homo sapiens ribosomal protein |
| | | | | L3-like (RPL3L), mRNA. |
| hs\|chr16: 1951481-1951536 | A_14_P111192 | entg\|NDUFB10 | ref\|NM_004548 | ref\|Homo sapiens NADH |
| | | | | dehydrogenase (ubiquinone) 1 beta |
| | | | | subcomplex, 10, 22 kDa |
| | | | | (NDUFB10), mRNA. |
| hs\|chr16: 1953238-1953298 | A_14_P116640 | entg\|RPS2 | ref\|NM_002952 | ref\|Homo sapiens ribosomal protein |
| | | | | S2 (RPS2), mRNA. |
| hs\|chr16: 1957723-1957772 | A_14_P136338 | entg\|RNF151 | ref\|NM_174903 | ref\|Homo sapiens ring finger protein |
| | | | | 151 (RNF151), mRNA. |
| hs\|chr16: 1966786-1966831 | A_16_P03102782 | entg\|TBL3 | ref\|NM_006453 | ref\|Homo sapiens transducin (beta)- |
| | | | | like 3 (TBL3), mRNA. |
| hs\|chr16: 31804883-31804943 | A_14_P109355 | entg\|ZNF267 | ref\|NM_003414 | ref\|Homo sapiens zinc finger protein |
| | | | | 267 (ZNF267), transcript variant |
| | | | | 498723, mRNA. |
| hs\|chr16: 46814197-46814257 | A_14_P136640 | entg\|ABCC11 | ref\|NM_033151\| | ref\|Homo sapiens ATP-binding |
| | | | ref\|NM_032583\| | cassette, sub-family C (CFTR/MRP), |
| | | | ref\| | member 11 (ABCC11), transcript |
| | | | NM_145186 | variant 2, mRNA. |
| hs\|chr16: 46844137-46844197 | A_16_P20456275 | entg\|LONP2 | ref\|NM_031490 | ref\|Homo sapiens lon peptidase 2, |
| | | | | peroxisomal (LONP2), mRNA. |
| hs\|chr16: 46953806-46953863 | A_14_P125219 | entg\|SIAH1 | ref\|NM_001006610\| | ref\|Homo sapiens seven in absentia |
| | | | ref\| | homolog 1 (Drosophila) (SIAH1), |
| | | | NM_003031 | transcript variant 2, mRNA. |
| hs\|chr16: 47132319-47132368 | A_14_P134205 | entg\|N4BP1 | ref\|NM_153029 | ref\|Homo sapiens Nedd4 binding |
| | | | | protein 1 (N4BP1), mRNA. |
| hs\|chr16: 7372669-7372729 | A_16_P03110154 | entg\|A2BP1 | ref\|NM_018723\| | ref\|Homo sapiens ataxin 2-binding |
| | | | ref\|NM_145891\| | protein 1 (A2BP1), transcript variant |
| | | | ref\| | 4, mRNA. |
| | | | NM_145892\| | |
| | | | ref\|NM_145893 | |
| hs\|chr16: 75782613-75782672 | A_14_P135769 | entg\|MON1B | ref\|NM_014940 | ref\|Homo sapiens MON1 homolog B |
| | | | | (yeast) (MON1B), mRNA. |
| hs\|chr16: 75874927-75874987 | A_16_P20526604 | entg\|ADAMTS18 | ref\|NM_199355 | ref\|Homo sapiens ADAM |
| | | | | metallopeptidase with |
| | | | | thrombospondin type 1 motif, 18 |
| | | | | (ADAMTS18), transcript variant 1, |
| | | | | mRNA. |
| hs\|chr16: 79257308-79257368 | A_14_P110836 | entg\|CDYL2 | ref\|NM_152342 | ref\|Homo sapiens chromodomain |
| | | | | protein, Y-like 2 (CDYL2), mRNA. |
| hs\|chr16: 79600615-79600674 | A_16_P20536795 | entg\|CENPN | ref\|NM_018455 | ref\|Homo sapiens centromere protein |
| | | | | N (CENPN), mRNA. |
| hs\|chr16: 79633847-79633907 | A_14_P102407 | entg\|ASCIZ | ref\|NM_015251 | ref\|Homo sapiens ATM/ATR- |
| | | | | Substrate Chk2-Interacting Zn2+- |
| | | | | finger protein (ASCIZ), mRNA. |
| hs\|chr16: 79676478-79676538 | A_14_P100251 | entg\|GCSH | ref\|NM_004483 | ref\|Homo sapiens glycine cleavage |
| | | | | system protein H (aminomethyl |
| | | | | carrier) (GCSH), mRNA. |
| hs\|chr16: 79700375-79700434 | A_16_P20537042 | entg\|PKD1L2 | ref\|NM_052892 | ref\|Homo sapiens polycystic kidney |
| | | | | disease 1-like 2 (PKD1L2), |
| | | | | transcript variant 1, mRNA. |
| hs\|chr16: 79830511-79830571 | A_14_P124389 | entg\|BCMO1 | ref\|NM_017429 | ref\|Homo sapiens beta-carotene |
| | | | | 15,15′-monooxygenase 1 (BCMO1), |
| | | | | mRNA. |
| hs\|chr16: 79911710-79911770 | A_16_P20537502 | entg\|GAN | ref\|NM_022041 | ref\|Homo sapiens giant axonal |
| | | | | neuropathy (gigaxonin) (GAN), |
| | | | | mRNA. |
| hs\|chr16: 80039370-80039430 | A_16_P20537807 | entg\|CMIP | ref\|NM_198390 | ref\|Homo sapiens c-Maf-inducing |
| | | | | protein (CMIP), transcript variant C- |
| | | | | mip, mRNA. |
| hs\|chr16: 80377384-80377444 | A_14_P103643 | entg\|PLCG2 | ref\|NM_002661 | ref\|Homo sapiens phospholipase C, |
| | | | | gamma 2 (phosphatidylinositol- |
| | | | | specific) (PLCG2), mRNA. |
| hs\|chr16: 80590033-80590093 | A_14_P120814 | entg\|HSPC105 | ref\|NM_145168 | ref\|Homo sapiens NAD(P) |
| | | | | dependent steroid dehydrogenase- |
| | | | | like (HSPC105), mRNA. |
| hs\|chr16: 80626347-80626407 | A_14_P112039 | entg\|HSD17B2 | ref\|NM_002153 | ref\|Homo sapiens hydroxysteroid |
| | | | | (17-beta) dehydrogenase 2 |
| | | | | (HSD17B2), mRNA. |
| hs\|chr16: 80742547-80742607 | A_16_P03187927 | entg\|MPHOSPH6 | ref\|NM_005792 | ref\|Homo sapiens M-phase |
| | | | | phosphoprotein 6 (MPHOSPH6), |
| | | | | mRNA. |
| hs\|chr17: 1613875-1613934 | A_14_P132429 | entg\|SERPINF1 | ref\|NM_002615 | ref\|Homo sapiens serpin peptidase |
| | | | | inhibitor, clade F (alpha-2 |
| | | | | antiplasmin, pigment epithelium |
| | | | | derived factor), member 1 |
| | | | | (SERPINF1), mRNA. |
| hs\|chr17: 1629727-1629787 | A_16_P03201775 | entg\|SMYD4 | ref\|NM_052928 | ref\|Homo sapiens SET and MYND |
| | | | | domain containing 4 (SMYD4), |
| | | | | mRNA. |
| hs\|chr17: 1684634-1684694 | A_16_P03201824 | entg\|RPA1 | ref\|NM_002945 | ref\|Homo sapiens replication protein |
| | | | | A1, 70 kDa (RPA1), mRNA. |
| hs\|chr17: 1784695-1784755 | A_14_P117472 | entg\|RTN4RL1 | ref\|NM_178568 | ref\|Homo sapiens reticulon 4 |
| | | | | receptor-like 1 (RTN4RL1), mRNA. |
| hs\|chr17: 1884967-1885027 | A_14_P109496 | entg\|DPH1 | ref\|NM_001383 | ref\|Homo sapiens DPH1 homolog |
| | | | | (S. cerevisiae) (DPH1), mRNA. |
| hs\|chr17: 1906351-1906407 | A_16_P03202129 | entg\|HIC1 | ref\|NM_006497 | ref\|Homo sapiens hypermethylated |
| | | | | in cancer 1 (HIC1), mRNA. |
| hs\|chr17: 1912423-1912483 | A_16_P40730036 | entg\|SMG6 | ref\|NM_017575 | ref\|Homo sapiens Smg-6 homolog, |
| | | | | nonsense mediated mRNA decay |
| | | | | factor (C. elegans) (SMG6), mRNA. |
| hs\|chr17: 19654761-19654821 | A_16_P20607805 | entg\|ULK2 | ref\|NM_014683 | ref\|Homo sapiens unc-51-like kinase |
| | | | | 2 (C. elegans) (ULK2), mRNA. |
| hs\|chr17: 19749897-19749957 | A_14_P127035 | entg\|AKAP10 | ref\|NM_007202 | ref\|Homo sapiens A kinase (PRKA) |
| | | | | anchor protein 10 (AKAP10), |
| | | | | nuclear gene encoding mitochondrial |
| | | | | protein, mRNA. |
| hs\|chr17: 19939012-19939072 | A_14_P134326 | entg\|SPECC1 | ref\|NM_152904\| | ref\|Homo sapiens sperm antigen with |
| | | | ref\|NM_001033553 | calponin homology and coiled-coil |
| | | | | domains 1 (SPECC1), transcript |
| | | | | variant NSP5beta3alpha, mRNA. |
| hs\|chr17: 20974662-20974722 | A_14_P111115 | entg\|DHRS7B | ref\|NM_015510 | ref\|Homo sapiens |
| | | | | dehydrogenase/reductase (SDR |
| | | | | family) member 7B (DHRS7B), |
| | | | | mRNA. |
| hs\|chr17: 21042200-21042260 | A_16_P03225976 | entg\|TMEM11 | ref\|NM_003876 | ref\|Homo sapiens transmembrane |
| | | | | protein 11 (TMEM11), mRNA. |
| hs\|chr17: 21088749-21088809 | A_16_P20610978 | entg\|MGC33894 | ref\|NM_152914 | ref\|Homo sapiens transcript |
| | | | | expressed during hematopoiesis 2 |
| | | | | (MGC33894), mRNA. |
| hs\|chr17: 21130610-21130664 | A_16_P03226092 | entg\|MAP2K3 | ref\|NM_145109 | ref\|Homo sapiens mitogen-activated |
| | | | | protein kinase kinase 3 (MAP2K3), |
| | | | | transcript variant B, mRNA. |
| hs\|chr17: 21221644-21221703 | A_16_P20611320 | entg\|KCNJ12 | ref\|NM_021012 | ref\|Homo sapiens potassium |
| | | | | inwardly-rectifying channel, |
| | | | | subfamily J, member 12 (KCNJ12), |
| | | | | mRNA. |
| hs\|chr17: 23115967-23116019 | A_14_P119698 | entg\|NOS2A | ref\|NM_000625\| | ref\|Homo sapiens nitric oxide |
| | | | ref\|NM_153292 | synthase 2A (inducible, hepatocytes) |
| | | | | (NOS2A), transcript variant 1, |
| | | | | mRNA. |
| hs\|chr17: 30772407-30772467 | A_16_P03237885 | entg\|SLFN12 | ref\|NM_018042 | ref\|Homo sapiens schlafen family |
| | | | | member 12 (SLFN12), mRNA. |
| hs\|chr17: 30787395-30787455 | A_16_P40801937 | entg\|SLFN13 | ref\|NM_144682 | ref\|Homo sapiens schlafen family |
| | | | | member 13 (SLFN13), mRNA. |
| hs\|chr17: 30926420-30926480 | A_14_P131358 | entg\|PEX12 | ref\|NM_000286 | ref\|Homo sapiens peroxisomal |
| | | | | biogenesis factor 12 (PEX12), |
| | | | | mRNA. |
| hs\|chr17: 30945164-30945224 | A_14_P121424 | entg\|AP2B1 | ref\|NM_001030006\| | ref\|Homo sapiens adaptor-related |
| | | | ref\| | protein complex 2, beta 1 subunit |
| | | | NM_001282 | (AP2B1), transcript variant 1, |
| | | | | mRNA. |
| hs\|chr17: 31087715-31087775 | A_16_P03238336 | entg\|RASL10B | ref\|NM_033315 | ref\|Homo sapiens RAS-like, family |
| | | | | 10, member B (RASL10B), mRNA. |
| hs\|chr17: 31096790-31096839 | A_14_P106138 | entg\|GAS2L2 | ref\|NM_139285 | ref\|Homo sapiens growth arrest- |
| | | | | specific 2 like 2 (GAS2L2), mRNA. |
| hs\|chr17: 31118123-31118181 | A_14_P136665 | entg\|MMP28 | ref\|NM_024302 | ref\|Homo sapiens matrix |
| | | | | metallopeptidase 28 (MMP28), |
| | | | | transcript variant 1, mRNA. |
| hs\|chr17: 31161335-31161395 | A_14_P115859 | entg\|TAF15 | ref\|NM_003487\| | ref\|Homo sapiens TAF15 RNA |
| | | | ref\|NM_139215 | polymerase II, TATA box binding |
| | | | | protein (TBP)-associated factor, |
| | | | | 68 kDa (TAF15), transcript variant 2, |
| | | | | mRNA. |
| hs\|chr17: 41483739-41483793 | A_14_P110538 | entg\|KIAA1267 | ref\|NM_015443 | ref\|Homo sapiens KIAA1267 |
| | | | | (KIAA1267), mRNA. |
| hs\|chr17: 41983406-41983466 | A_16_P20659819 | entg\|LRRC37A2 | ref\|NM_001006607 | ref\|Homo sapiens leucine rich repeat |
| | | | | containing 37, member A2 |
| | | | | (LRRC37A2), mRNA. |
| hs\|chr17: 42049539-42049599 | A_16_P03251360 | entg\|NSF | ref\|NM_006178 | ref\|Homo sapiens N-ethylmaleimide- |
| | | | | sensitive factor (NSF), mRNA. |
| hs\|chr17: 60961613-60961673 | A_14_P139966 | entg\|AXIN2 | ref\|NM_004655 | ref\|Homo sapiens axin 2 (conductin, |
| | | | | axil) (AXIN2), mRNA. |
| hs\|chr17: 61062371-61062431 | A_14_P117155 | entg\|CCDC46 | ref\|NM_001037325\| | ref\|Homo sapiens coiled-coil domain |
| | | | ref\| | containing 46 (CCDC46), transcript |
| | | | NM_145036 | variant 2, mRNA. |
| hs\|chr18: 10451918-10451978 | A_16_P20774368 | entg\|APCDD1 | ref\|NM_153000 | ref\|Homo sapiens adenomatosis |
| | | | | polyposis coli down-regulated 1 |
| | | | | (APCDD1), mRNA. |
| hs\|chr18: 10520811-10520871 | A_16_P20774562 | entg\|NAPG | ref\|NM_003826 | ref\|Homo sapiens N-ethylmaleimide- |
| | | | | sensitive factor attachment protein, |
| | | | | gamma (NAPG), mRNA. |
| hs\|chr18: 10662791-10662851 | A_14_P109290 | entg\|FAM38B | ref\|NM_022068 | ref\|Homo sapiens family with |
| | | | | sequence similarity 38, member B |
| | | | | (FAM38B), mRNA. |
| hs\|chr18: 18007094-18007154 | A_16_P20788527 | entg\|GATA6 | ref\|NM_005257 | ref\|Homo sapiens GATA binding |
| | | | | protein 6 (GATA6), mRNA. |
| hs\|chr18: 18248552-18248612 | A_14_P201238 | entg\|CTAGE1 | ref\|NM_172241 | ref\|Homo sapiens cutaneous T-cell |
| | | | | lymphoma-associated antigen 1 |
| | | | | (CTAGE1), transcript variant 1, |
| | | | | mRNA. |
| hs\|chr18: 2553837-2553897 | A_16_P20755246 | entg\|METTL4 | ref\|NM_022840 | ref\|Homo sapiens methyltransferase |
| | | | | like 4 (METTL4), mRNA. |
| hs\|chr18: 2565012-2565072 | A_16_P03305216 | entg\|NDC80 | ref\|NM_006101 | ref\|Homo sapiens NDC80 homolog, |
| | | | | kinetochore complex component |
| | | | | (S. cerevisiae) (NDC80), mRNA. |
| hs\|chr18: 27369253-27369313 | A_14_P200506 | entg\|DSG2 | ref\|NM_001943 | ref\|Homo sapiens desmoglein 2 |
| | | | | (DSG2), mRNA. |
| hs\|chr18: 27425938-27425998 | A_16_P20811562 | entg\|TTR | ref\|NM_000371 | ref\|Homo sapiens transthyretin |
| | | | | (prealbumin, amyloidosis type I) |
| | | | | (TTR), mRNA. |
| hs\|chr18: 27458074-27458134 | A_16_P40989277 | entg\|B4GALT6 | ref\|NM_004775 | ref\|Homo sapiens UDP- |
| | | | | Gal:betaGlcNAc beta 1,4- |
| | | | | galactosyltransferase, polypeptide 6 |
| | | | | (B4GALT6), mRNA. |
| hs\|chr18: 27664619-27664679 | A_14_P202525 | entg\|KIAA1012 | ref\|NM_014939 | ref\|Homo sapiens KIAA1012 |
| | | | | (KIAA1012), mRNA. |
| hs\|chr18: 27855808-27855868 | A_14_P130700 | entg\|RNF125 | ref\|NM_017831 | ref\|Homo sapiens ring finger protein |
| | | | | 125 (RNF125), mRNA. |
| hs\|chr18: 27929522-27929582 | A_14_P121996 | entg\|RNF138 | ref\|NM_016271\| | ref\|Homo sapiens ring finger protein |
| | | | ref\|NM_198128 | 138 (RNF138), transcript variant 1, |
| | | | | mRNA. |
| hs\|chr18: 32693151-32693211 | A_16_P20823911 | entg\|KIAA1328 | ref\|NM_020776 | ref\|Homo sapiens KIAA1328 |
| | | | | (KIAA1328), mRNA. |
| hs\|chr18: 33082621-33082681 | A_16_P03345423 | entg\|BRUNOL4 | ref\|NM_020180 | ref\|Homo sapiens bruno-like 4, RNA |
| | | | | binding protein (Drosophila) |
| | | | | (BRUNOL4), mRNA. |
| hs\|chr18: 70073944-70074004 | A_16_P03402184 | entg\|CYB5A | ref\|NM_001914\| | ref\|Homo sapiens cytochrome b5 |
| | | | ref\|NM_148923 | type A (microsomal) (CYB5A), |
| | | | | transcript variant 2, mRNA. |
| hs\|chr18: 70316045-70316105 | A_14_P133122 | entg\|CNDP2 | ref\|NM_018235 | ref\|Homo sapiens CNDP dipeptidase |
| | | | | 2 (metallopeptidase M20 family) |
| | | | | (CNDP2), mRNA. |
| hs\|chr18: 70353477-70353537 | A_16_P03402618 | entg\|CNDP1 | ref\|NM_032649 | ref\|Homo sapiens carnosine |
| | | | | dipeptidase 1 (metallopeptidase M20 |
| | | | | family) (CNDP1), mRNA. |
| hs\|chr18: 70411563-70411623 | A_16_P20919551 | entg\|LOC400657 | ref\|NM_001008234 | ref\|Homo sapiens hypothetical gene |
| | | | | supported by BC036588 |
| | | | | (LOC400657), mRNA. |
| hs\|chr18: 70905729-70905783 | A_14_P134173 | entg\|ZNF407 | ref\|NM_017757 | ref\|Homo sapiens zinc finger protein |
| | | | | 407 (ZNF407), mRNA. |
| hs\|chr18: 75235681-75235741 | A_14_P111672 | entg\|ATP9B | ref\|NM_198531 | ref\|Homo sapiens ATPase, Class II, |
| | | | | type 9B (ATP9B), mRNA. |
| hs\|chr18: 75259663-75259723 | A_16_P03410611 | entg\|NFATC1 | ref\|NM_172390\| | ref\|Homo sapiens nuclear factor of |
| | | | ref\|NM_006162\| | activated T-cells, cytoplasmic, |
| | | | ref\| | calcineurin-dependent 1 (NFATC1), |
| | | | NM_172388 | transcript variant 1, mRNA. |
| hs\|chr18: 7560828-7560888 | A_16_P03312395 | entg\|PTPRM | ref\|NM_002845 | ref\|Homo sapiens protein tyrosine |
| | | | | phosphatase, receptor type, M |
| | | | | (PTPRM), mRNA. |
| hs\|chr19: 19154706-19154766 | A_14_P125162 | entg\|MEF2B | ref\|NM_005919 | ref\|Homo sapiens myocyte enhancer |
| | | | | factor 2B (MEF2B), mRNA. |
| hs\|chr19: 19165678-19165738 | A_16_P03431888 | entg\|RFXANK | ref\|NM_003721\| | ref\|Homo sapiens regulatory factor |
| | | | ref\|NM_134440 | X-associated ankyrin-containing |
| | | | | protein (RFXANK), transcript |
| | | | | variant 1, mRNA. |
| hs\|chr19: 19188967-19189027 | A_16_P20975002 | entg\|NCAN | ref\|NM_004386 | ref\|Homo sapiens neurocan (NCAN), |
| | | | | mRNA. |
| hs\|chr19: 19232502-19232547 | A_14_P129282 | entg\|HAPLN4 | ref\|NM_023002 | ref\|Homo sapiens hyaluronan and |
| | | | | proteoglycan link protein 4 |
| | | | | (HAPLN4), mRNA. |
| hs\|chr19: 19243641-19243699 | A_14_P123568 | entg\|TM6SF2 | ref\|NM_001001524 | ref\|Homo sapiens transmembrane 6 |
| | | | | superfamily member 2 (TM6SF2), |
| | | | | mRNA. |
| hs\|chr19: 19253722-19253782 | A_16_P03432007 | entg\|SF4 | ref\|NM_172231 | ref\|Homo sapiens splicing factor 4 |
| | | | | (SF4), mRNA. |
| hs\|chr19: 19294613-19294673 | A_14_P100631 | entg\|KIAA0892 | ref\|NM_015329 | ref\|Homo sapiens KIAA0892 |
| | | | | (KIAA0892), mRNA. |
| hs\|chr19: 19437236-19437294 | A_14_P118620 | entg\|GATAD2A | ref\|NM_017660 | ref\|Homo sapiens GATA zinc finger |
| | | | | domain containing 2A (GATAD2A), |
| | | | | mRNA. |
| hs\|chr19: 19491430-19491480 | A_14_P101725 | entg\|NDUFA13 | ref\|NM_015965 | ref\|Homo sapiens NADH |
| | | | | dehydrogenase (ubiquinone) 1 alpha |
| | | | | subcomplex, 13 (NDUFA13), |
| | | | | mRNA. |
| hs\|chr19: 19502263-19502318 | A_16_P20975783 | entg\|FLJ44968 | ref\|NM_198537 | ref\|Homo sapiens FLJ44968 protein |
| | | | | (FLJ44968), mRNA. |
| hs\|chr19: 19514805-19514859 | A_14_P116539 | entg\|CILP2 | ref\|NM_153221 | ref\|Homo sapiens cartilage |
| | | | | intermediate layer protein 2 (CILP2), |
| | | | | mRNA. |
| hs\|chr19: 19598166-19598215 | A_14_P104996 | entg\|EDG4 | ref\|NM_004720 | ref\|Homo sapiens endothelial |
| | | | | differentiation, lysophosphatidic acid |
| | | | | G-protein-coupled receptor, 4 |
| | | | | (EDG4), mRNA. |
| hs\|chr19: 19601588-19601646 | A_14_P116930 | entg\|GMIP | ref\|NM_016573 | ref\|Homo sapiens GEM interacting |
| | | | | protein (GMIP), mRNA. |
| hs\|chr19: 19618616-19618666 | A_14_P108120 | entg\|ATP13A1 | ref\|NM_020410 | ref\|Homo sapiens ATPase type 13A1 |
| | | | | (ATP13A1), mRNA. |
| hs\|chr19: 19643662-19643722 | A_16_P41161207 | entg\|ZNF101 | ref\|NM_033204 | ref\|Homo sapiens zinc finger protein |
| | | | | 101 (ZNF101), mRNA. |
| hs\|chr19: 19687039-19687095 | A_14_P115484 | entg\|ZNF14 | ref\|NM_021030 | ref\|Homo sapiens zinc finger protein |
| | | | | 14 (ZNF14), mRNA. |
| hs\|chr19: 19847024-19847084 | A_16_P03432734 | entg\|ZNF253 | ref\|NM_021047 | ref\|Homo sapiens zinc finger protein |
| | | | | 253 (ZNF253), mRNA. |
| hs\|chr19: 19875243-19875291 | A_16_P41161602 | entg\|ZNF93 | ref\|NM_031218 | ref\|Homo sapiens zinc finger protein |
| | | | | 93 (ZNF93), mRNA. |
| hs\|chr19: 22156551-22156611 | A_16_P41164705 | entg\|ZNF676 | ref\|NM_001001411 | ref\|Homo sapiens zinc finger protein |
| | | | | 676 (ZNF676), mRNA. |
| hs\|chr19: 2272497-2272557 | A_14_P109751 | entg\|LSM7 | ref\|NM_016199 | ref\|Homo sapiens LSM7 homolog, |
| | | | | U6 small nuclear RNA associated |
| | | | | (S. cerevisiae) (LSM7), mRNA. |
| hs\|chr19: 2280485-2280545 | A_14_P127655 | entg\|SPPL2B | ref\|NM_001077238\| | ref\|Homo sapiens signal peptide |
| | | | ref\| | peptidase-like 2B (SPPL2B), |
| | | | NM_152988 | transcript variant 3, mRNA. |
| hs\|chr19: 2345664-2345724 | A_16_P20940811 | entg\|TMPRSS9 | ref\|NM_182973 | ref\|Homo sapiens transmembrane |
| | | | | protease, serine 9 (TMPRSS9), |
| | | | | mRNA. |
| hs\|chr19: 2377534-2377584 | A_14_P107939 | entg\|TIMM13 | ref\|NM_012458 | ref\|Homo sapiens translocase of |
| | | | | inner mitochondrial membrane 13 |
| | | | | homolog (yeast) (TIMM13), nuclear |
| | | | | gene encoding mitochondrial protein, |
| | | | | mRNA. |
| hs\|chr19: 2379724-2379784 | A_14_P128231 | entg\|LMNB2 | ref\|NM_032737 | ref\|Homo sapiens lamin B2 |
| | | | | (LMNB2), mRNA. |
| hs\|chr19: 2429106-2429166 | A_14_P119132 | entg\|GADD45B | ref\|NM_015675 | ref\|Homo sapiens growth arrest and |
| | | | | DNA-damage-inducible, beta |
| | | | | (GADD45B), mRNA. |
| hs\|chr19: 2462310-2462369 | A_14_P106243 | entg\|GNG7 | ref\|NM_052847 | ref\|Homo sapiens guanine nucleotide |
| | | | | binding protein (G protein), gamma |
| | | | | 7 (GNG7), mRNA. |
| hs\|chr19: 39357485-39357545 | A_14_P106635 | entg\|LSM14A | ref\|NM_015578 | ref\|Homo sapiens LSM14A, SCD6 |
| | | | | homolog A (S. cerevisiae) |
| | | | | (LSM14A), mRNA. |
| hs\|chr19: 43460441-43460501 | A_16_P21005414 | entg\|SPINT2 | ref\|NM_021102 | ref\|Homo sapiens serine peptidase |
| | | | | inhibitor, Kunitz type, 2 (SPINT2), |
| | | | | mRNA. |
| hs\|chr19: 43490574-43490629 | A_14_P139417 | entg\|YIF1B | ref\|NM_033557\| | ref\|Homo sapiens Yip1 interacting |
| | | | ref\|NM_001039671\| | factor homolog B (S. cerevisiae) |
| | | | ref\|NM_001039672\| | (YIF1B), transcript variant 2, |
| | | | ref\| | mRNA. |
| | | | NM_001039673 | |
| hs\|chr19: 43504066-43504114 | A_14_P117281 | entg\|KCNK6 | ref\|NM_004823 | ref\|Homo sapiens potassium channel, |
| | | | | subfamily K, member 6 (KCNK6), |
| | | | | mRNA. |
| hs\|chr19: 43558108-43558165 | A_16_P03448763 | entg\|PSMD8 | ref\|NM_002812 | ref\|Homo sapiens proteasome |
| | | | | (prosome, macropain) 26S subunit, |
| | | | | non-ATPase, 8 (PSMD8), mRNA. |
| hs\|chr19: 43573381-43573441 | A_16_P03448788 | entg\|SPRED3 | ref\|NM_001039616\| | ref\|Homo sapiens sprouty-related, |
| | | | ref\| | EVH1 domain containing 3 |
| | | | NM_001042522 | (SPRED3), transcript variant 2, |
| | | | | mRNA. |
| hs\|chr19: 43588218-43588272 | A_14_P113152 | entg\|FAM98C | ref\|NM_174905 | ref\|Homo sapiens family with |
| | | | | sequence similarity 98, member C |
| | | | | (FAM98C), mRNA. |
| hs\|chr19: 43594465-43594525 | A_14_P124175 | entg\|RASGRP4 | ref\|NM_170602\| | ref\|Homo sapiens RAS guanyl |
| | | | ref\|NM_170603\| | releasing protein 4 (RASGRP4), |
| | | | ref\| | transcript variant 2, mRNA. |
| | | | NM_170604 | |
| hs\|chr19: 43619830-43619889 | A_14_P110331 | entg\|RYR1 | ref\|NM_000540\| | ref\|Homo sapiens ryanodine receptor |
| | | | ref\|NM_001042723 | 1 (skeletal) (RYR1), transcript |
| | | | | variant 1, mRNA. |
| hs\|chr19: 43774027-43774087 | A_14_P130348 | entg\|MAP4K1 | ref\|NM_001042600\| | ref\|Homo sapiens mitogen-activated |
| | | | ref\| | protein kinase kinase kinase kinase 1 |
| | | | NM_007181 | (MAP4K1), transcript variant 1, |
| | | | | mRNA. |
| hs\|chr19: 43803970-43804030 | A_16_P21006181 | entg\|EIF3S12 | ref\|NM_013234 | ref\|Homo sapiens eukaryotic |
| | | | | translation initiation factor 3, subunit |
| | | | | 12 (EIF3S12), mRNA. |
| hs\|chr19: 43831414-43831474 | A_16_P21006220 | entg\|ACTN4 | ref\|NM_004924 | ref\|Homo sapiens actinin, alpha 4 |
| | | | | (ACTN4), mRNA. |
| hs\|chr19: 43914023-43914083 | A_16_P03449258 | entg\|CAPN12 | ref\|NM_144691 | ref\|Homo sapiens calpain 12 |
| | | | | (CAPN12), mRNA. |
| hs\|chr19: 43986039-43986096 | A_14_P111700 | entg\|LGALS4 | ref\|NM_006149 | ref\|Homo sapiens lectin, galactoside- |
| | | | | binding, soluble, 4 (galectin 4) |
| | | | | (LGALS4), mRNA. |
| hs\|chr19: 43997948-43998008 | A_16_P03449320 | entg\|ECH1 | ref\|NM_001398 | ref\|Homo sapiens enoyl Coenzyme A |
| | | | | hydratase 1, peroxisomal (ECH1), |
| | | | | mRNA. |
| hs\|chr19: 44024263-44024323 | A_14_P138127 | entg\|HNRPL | ref\|NM_001533\| | ref\|Homo sapiens heterogeneous |
| | | | ref\|NM_001005335 | nuclear ribonucleoprotein L |
| | | | | (HNRPL), transcript variant 1, |
| | | | | mRNA. |
| hs\|chr19: 58596259-58596319 | A_16_P21036109 | entg\|ZNF765 | ref\|NM_001040185 | ref\|Homo sapiens zinc finger protein |
| | | | | 765 (ZNF765), mRNA. |
| hs\|chr19: 58652486-58652538 | A_16_P03463766 | entg\|ZNF761 | ref\|NM_001008401 | ref\|Homo sapiens zinc finger protein |
| | | | | 761 (ZNF761), mRNA. |
| hs\|chr19: 58663139-58663184 | A_16_P41226481 | entg\|ZNF813 | ref\|NM_001004301 | ref\|Homo sapiens zinc finger protein |
| | | | | 813 (ZNF813), mRNA. |
| hs\|chr19: 58717687-58717742 | A_14_P102510 | entg\|ZNF331 | ref\|NM_018555 | ref\|Homo sapiens zinc finger protein |
| | | | | 331 (ZNF331), transcript variant 1, |
| | | | | mRNA. |
| hs\|chr19: 58829751-58829811 | A_16_P21036530 | entg\|DPRX | ref\|NM_001012728 | ref\|Homo sapiens divergent-paired |
| | | | | related homeobox (DPRX), mRNA. |
| hs\|chr19: 58989173-58989233 | A_16_P21036862 | entg\|NLRP12 | ref\|NM_144687\| | ref\|Homo sapiens NLR family, pyrin |
| | | | ref\|NM_033297 | domain containing 12 (NLRP12), |
| | | | | transcript variant 2, mRNA. |
| hs\|chr19: 59069708-59069759 | A_14_P112678 | entg\|MYADM | ref\|NM_001020820\| | ref\|Homo sapiens myeloid-associated |
| | | | ref\| | differentiation marker (MYADM), |
| | | | NM_001020819\| | transcript variant 4, mRNA. |
| | | | ref\|NM_138373\| | |
| | | | ref\| | |
| | | | NM_001020821\| | |
| | | | ref\|NM_001020818 | |
| hs\|chr19: 59082056-59082116 | A_16_P21036989 | entg\|PRKCG | ref\|NM_002739 | ref\|Homo sapiens protein kinase C, |
| | | | | gamma (PRKCG), mRNA. |
| hs\|chr19: 59108290-59108349 | A_16_P41227373 | entg\|CACNG7 | ref\|NM_031896 | ref\|Homo sapiens calcium channel, |
| | | | | voltage-dependent, gamma subunit 7 |
| | | | | (CACNG7), mRNA. |
| hs\|chr19: 59164790-59164845 | A_16_P03464185 | entg\|CACNG8 | ref\|NM_031895 | ref\|Homo sapiens calcium channel, |
| | | | | voltage-dependent, gamma subunit 8 |
| | | | | (CACNG8), mRNA. |
| hs\|chr19: 59194401-59194461 | A_14_P107943 | entg\|CACNG6 | ref\|NM_031897\| | ref\|Homo sapiens calcium channel, |
| | | | ref\|NM_145814\| | voltage-dependent, gamma subunit 6 |
| | | | ref\| | (CACNG6), transcript variant 3, |
| | | | NM_145815 | mRNA. |
| hs\|chr19: 59237251-59237309 | A_16_P21037291 | entg\|VSTM1 | ref\|NM_198481 | ref\|Homo sapiens V-set and |
| | | | | transmembrane domain containing 1 |
| | | | | (VSTM1), mRNA. |
| hs\|chr19: 59294757-59294809 | A_14_P105349 | entg\|OSCAR | ref\|NM_130771\| | ref\|Homo sapiens osteoclast- |
| | | | ref\|NM_133168\| | associated receptor (OSCAR), |
| | | | ref\| | transcript variant 3, mRNA. |
| | | | NM_133169\| | |
| | | | ref\|NM_206818 | |
| hs\|chr19: 59300843-59300897 | A_14_P133007 | entg\|NDUFA3 | ref\|NM_004542 | ref\|Homo sapiens NADH |
| | | | | dehydrogenase (ubiquinone) 1 alpha |
| | | | | subcomplex, 3, 9 kDa (NDUFA3), |
| | | | | mRNA. |
| hs\|chr19: 59306164-59306215 | A_16_P03464303 | entg\|TFPT | ref\|NM_013342 | ref\|Homo sapiens TCF3 (E2A) |
| | | | | fusion partner (in childhood |
| | | | | Leukemia) (TFPT), mRNA. |
| hs\|chr19: 59310831-59310881 | A_14_P135834 | entg\|PRPF31 | ref\|NM_015629 | ref\|Homo sapiens PRP31 pre-mRNA |
| | | | | processing factor 31 homolog (S. cerevisiae) |
| | | | | (PRPF31), mRNA. |
| hs\|chr19: 59337765-59337825 | A_14_P100437 | entg\|CNOT3 | ref\|NM_014516 | ref\|Homo sapiens CCR4-NOT |
| | | | | transcription complex, subunit 3 |
| | | | | (CNOT3), mRNA. |
| hs\|chr19: 59352589-59352646 | A_14_P120931 | entg\|LENG1 | ref\|NM_024316 | ref\|Homo sapiens leukocyte receptor |
| | | | | cluster (LRC) member 1 (LENG1), |
| | | | | mRNA. |
| hs\|chr19: 59358295-59358344 | A_14_P126333 | entg\|TMC4 | ref\|NM_144686 | ref\|Homo sapiens transmembrane |
| | | | | channel-like 4 (TMC4), mRNA. |
| hs\|chr19: 59370362-59370422 | A_16_P21037606 | entg\|LENG4 | ref\|NM_024298 | ref\|Homo sapiens leukocyte receptor |
| | | | | cluster (LRC) member 4 (LENG4), |
| | | | | mRNA. |
| hs\|chr19: 59389151-59389211 | A_14_P127989 | entg\|TSEN34 | ref\|NM_024075\| | ref\|Homo sapiens tRNA splicing |
| | | | ref\|NM_001077446 | endonuclease 34 homolog (S. cerevisiae) |
| | | | | (TSEN34), transcript |
| | | | | variant 1, mRNA. |
| hs\|chr19: 59398678-59398737 | A_14_P128385 | entg\|RPS9 | ref\|NM_001013 | ref\|Homo sapiens ribosomal protein |
| | | | | S9 (RPS9), mRNA. |
| hs\|chr19: 59414644-59414704 | A_16_P41228137 | entg\|LILRB3 | ref\|NM_001081450\| | ref\|Homo sapiens leukocyte |
| | | | ref\| | immunoglobulin-like receptor, |
| | | | NM_006864 | subfamily B (with TM and ITIM |
| | | | | domains), member 3 (LILRB3), |
| | | | | transcript variant 1, mRNA. |
| hs\|chr19: 59434158-59434216 | A_16_P03464474 | entg\|LILRA6 | ref\|NM_024318 | ref\|Homo sapiens leukocyte |
| | | | | immunoglobulin-like receptor, |
| | | | | subfamily A (with TM domain), |
| | | | | member 6 (LILRA6), mRNA. |
| hs\|chr19: 59446273-59446327 | A_14_P137001 | entg\|LILRB5 | ref\|NM_001081442\| | ref\|Homo sapiens leukocyte |
| | | | ref\| | immunoglobulin-like receptor, |
| | | | NM_001081443\| | subfamily B (with TM and ITIM |
| | | | ref\|NM_006840 | domains), member 5 (LILRB5), |
| | | | | transcript variant 1, mRNA. |
| hs\|chr19: 637652-637712 | A_14_P200510 | entg\|PRSSL1 | ref\|NM_214710 | ref\|Homo sapiens protease, serine- |
| | | | | like 1 (PRSSL1), mRNA. |
| hs\|chr19: 662117-662177 | A_16_P20936373 | entg\|PALM | ref\|NM_001040134\| | ref\|Homo sapiens paralemmin |
| | | | ref\| | (PALM), transcript variant 2, |
| | | | NM_002579 | mRNA. |
| hs\|chr19: 753833-753893 | A_14_P132300 | entg\|PTBP1 | ref\|NM_002819\| | ref\|Homo sapiens polypyrimidine |
| | | | ref\|NM_031990\| | tract binding protein 1 (PTBP1), |
| | | | ref\| | transcript variant 1, mRNA. |
| | | | NM_031991\| | |
| | | | ref\|NM_175847 | |
| hs\|chr19: 766729-766774 | A_16_P03412397 | entg\|PRG2 | ref\|NM_024888 | ref\|Homo sapiens plasticity-related |
| | | | | gene 2 (PRG2), mRNA. |
| hs\|chr19: 781585-781639 | A_14_P137724 | entg\|AZU1 | ref\|NM_001700 | ref\|Homo sapiens azurocidin 1 |
| | | | | (cationic antimicrobial protein 37) |
| | | | | (AZU1), mRNA. |
| hs\|chr19: 794977-795024 | A_16_P03412416 | entg\|PRTN3 | ref\|NM_002777 | ref\|Homo sapiens proteinase 3 |
| | | | | (serine proteinase, neutrophil, |
| | | | | Wegener granulomatosis |
| | | | | autoantigen) (PRTN3), mRNA. |
| hs\|chr19: 806290-806342 | A_14_P200511 | entg\|ELA2 | ref\|NM_001972 | ref\|Homo sapiens elastase 2, |
| | | | | neutrophil (ELA2), mRNA. |
| hs\|chr19: 810850-810907 | A_14_P120706 | entg\|CFD | ref\|NM_001928 | ref\|Homo sapiens complement factor |
| | | | | D (adipsin) (CFD), mRNA. |
| hs\|chr19: 820454-820514 | A_16_P03412441 | entg\|THRAP5 | ref\|NM_005481 | ref\|Homo sapiens thyroid hormone |
| | | | | receptor associated protein 5 |
| | | | | (THRAP5), mRNA. |
| hs\|chr19: 871877-871937 | A_14_P107164 | entg\|KISS1R | ref\|NM_032551 | ref\|Homo sapiens KISS1 receptor |
| | | | | (KISS1R), mRNA. |
| hs\|chr19: 877497-877557 | A_16_P03412515 | entg\|ARID3A | ref\|NM_005224 | ref\|Homo sapiens AT rich interactive |
| | | | | domain 3A (BRIGHT-like) |
| | | | | (ARID3A), mRNA. |
| hs\|chr19: 938552-938607 | A_14_P134978 | entg\|WDR18 | ref\|NM_024100 | ref\|Homo sapiens WD repeat domain |
| | | | | 18 (WDR18), mRNA. |
| hs\|chr19: 957814-957862 | A_14_P103121 | entg\|GRIN3B | ref\|NM_138690 | ref\|Homo sapiens glutamate receptor, |
| | | | | ionotropic, N-methyl-D-aspartate 3B |
| | | | | (GRIN3B), mRNA. |
| hs\|chr20: 10342146-10342206 | A_14_P101152 | entg\|MKKS | ref\|NM_018848\| | ref\|Homo sapiens McKusick- |
| | | | ref\|NM_170784 | Kaufman syndrome (MKKS), |
| | | | | transcript variant 1, mRNA. |
| hs\|chr20: 17870420-17870480 | A_14_P122032 | entg\|SNX5 | ref\|NM_014426\| | ref\|Homo sapiens sorting nexin 5 |
| | | | ref\|NM_152227 | (SNX5), transcript variant 2, mRNA. |
| hs\|chr20: 17952879-17952939 | A_16_P21090191 | entg\|OVOL2 | ref\|NM_021220 | ref\|Homo sapiens ovo-like 2 |
| | | | | (Drosophila) (OVOL2), mRNA. |
| hs\|chr20: 21233373-21233433 | A_14_P108632 | entg\|XRN2 | ref\|NM_012255 | ref\|Homo sapiens 5′-3′ |
| | | | | exoribonuclease 2 (XRN2), mRNA. |
| hs\|chr20: 21635879-21635939 | A_14_P125602 | entg\|PAX1 | ref\|NM_006192 | ref\|Homo sapiens paired box gene 1 |
| | | | | (PAX1), mRNA. |
| hs\|chr20: 2247499-2247559 | A_14_P134667 | entg\|TGM3 | ref\|NM_003245 | ref\|Homo sapiens transglutaminase 3 |
| | | | | (E polypeptide, protein-glutamine- |
| | | | | gamma-glutamyltransferase) |
| | | | | (TGM3), mRNA. |
| hs\|chr20: 2317441-2317501 | A_16_P21052139 | entg\|TGM6 | ref\|NM_198994 | ref\|Homo sapiens transglutaminase 6 |
| | | | | (TGM6), mRNA. |
| hs\|chr20: 23754211-23754257 | A_16_P41296952 | entg\|CST2 | ref\|NM_001322 | ref\|Homo sapiens cystatin SA |
| | | | | (CST2), mRNA. |
| hs\|chr20: 23805886-23805946 | A_14_P125592 | entg\|CST5 | ref\|NM_001900 | ref\|Homo sapiens cystatin D (CST5), |
| | | | | mRNA. |
| hs\|chr20: 2390989-2391049 | A_16_P03471936 | entg\|SNRPB | ref\|NM_003091\| | ref\|Homo sapiens small nuclear |
| | | | ref\|NM_198216 | ribonucleoprotein polypeptides B |
| | | | | and B1 (SNRPB), transcript variant |
| | | | | 2, mRNA. |
| hs\|chr20: 2412866-2412926 | A_14_P104271 | entg\|ZNF343 | ref\|NM_024325 | ref\|Homo sapiens zinc finger protein |
| | | | | 343 (ZNF343), mRNA. |
| hs\|chr20: 2476329-2476389 | A_16_P21052442 | entg\|TMC2 | ref\|NM_080751 | ref\|Homo sapiens transmembrane |
| | | | | channel-like 2 (TMC2), mRNA. |
| hs\|chr20: 2585974-2586034 | A_14_P133992 | entg\|NOL5A | ref\|NM_006392 | ref\|Homo sapiens nucleolar protein |
| | | | | 5A (56 kDa with KKE/D repeat) |
| | | | | (NOL5A), mRNA. |
| hs\|chr20: 2587404-2587451 | A_14_P125369 | entg\|IDH3B | ref\|NM_006899\| | ref\|Homo sapiens isocitrate |
| | | | ref\|NM_174855\| | dehydrogenase 3 (NAD+) beta |
| | | | ref\| | (IDH3B), nuclear gene encoding |
| | | | NM_174856 | mitochondrial protein, transcript |
| | | | | variant 1, mRNA. |
| hs\|chr20: 29311017-29311077 | A_16_P21110147 | entg\|DEFB115 | ref\|NM_001037730 | ref\|Homo sapiens defensin, beta 115 |
| | | | | (DEFB115), mRNA. |
| hs\|chr20: 29423640-29423700 | A_14_P132767 | entg\|DEFB118 | ref\|NM_054112 | ref\|Homo sapiens defensin, beta 118 |
| | | | | (DEFB118), mRNA. |
| hs\|chr20: 36066536-36066595 | A_16_P41318982 | entg\|KIAA0406 | ref\|NM_014657 | ref\|Homo sapiens KIAA0406 |
| | | | | (KIAA0406), mRNA. |
| hs\|chr20: 36202093-36202153 | A_14_P102647 | entg\|TGM2 | ref\|NM_004613\| | ref\|Homo sapiens transglutaminase 2 |
| | | | ref\|NM_198951 | (C polypeptide, protein-glutamine- |
| | | | | gamma-glutamyltransferase) |
| | | | | (TGM2), transcript variant 1, |
| | | | | mRNA. |
| hs\|chr20: 38748030-38748090 | A_14_P100486 | entg\|MAFB | ref\|NM_005461 | ref\|Homo sapiens v-maf |
| | | | | musculoaponeurotic fibrosarcoma |
| | | | | oncogene homolog B (avian) |
| | | | | (MAFB), mRNA. |
| hs\|chr20: 40136919-40136979 | A_14_P128414 | entg\|PTPRT | ref\|NM_007050\| | ref\|Homo sapiens protein tyrosine |
| | | | ref\|NM_133170 | phosphatase, receptor type, T |
| | | | | (PTPRT), transcript variant 2, |
| | | | | mRNA. |
| hs\|chr20: 56663799-56663859 | A_14_P138998 | entg\|STX16 | ref\|NM_001001433\| | ref\|Homo sapiens syntaxin 16 |
| | | | ref\| | (STX16), transcript variant 1, |
| | | | NM_003763 | mRNA. |
| hs\|chr20: 56704228-56704287 | A_16_P03541605 | entg\|NPEPL1 | ref\|NM_024663 | ref\|Homo sapiens aminopeptidase- |
| | | | | like 1 (NPEPL1), mRNA. |
| hs\|chr20: 60552910-60552955 | A_16_P41380117 | entg\|FLJ30313 | ref\|NM_152757 | ref\|Homo sapiens hypothetical |
| | | | | protein FLJ30313 (FLJ30313), |
| | | | | mRNA. |
| hs\|chr20: 60753459-60753516 | A_16_P03547933 | entg\|SLCO4A1 | ref\|NM_016354 | ref\|Homo sapiens solute carrier |
| | | | | organic anion transporter family, |
| | | | | member 4A1 (SLCO4A1), mRNA. |
| hs\|chr20: 60814249-60814309 | A_16_P03548043 | entg\|NTSR1 | ref\|NM_002531 | ref\|Homo sapiens neurotensin |
| | | | | receptor 1 (high affinity) (NTSR1), |
| | | | | mRNA. |
| hs\|chr20: 60911384-60911434 | A_16_P03548202 | entg\|OGFR | ref\|NM_007346 | ref\|Homo sapiens opioid growth |
| | | | | factor receptor (OGFR), mRNA. |
| hs\|chr20: 60920275-60920320 | A_16_P41380946 | entg\|COL9A3 | ref\|NM_001853 | ref\|Homo sapiens collagen, type IX, |
| | | | | alpha 3 (COL9A3), mRNA. |
| hs\|chr20: 6700675-6700735 | A_14_P118128 | entg\|BMP2 | ref\|NM_001200 | ref\|Homo sapiens bone |
| | | | | morphogenetic protein 2 (BMP2), |
| | | | | mRNA. |
| hs\|chr21: 16026984-16027044 | A_16_P03553415 | entg\|USP25 | ref\|NM_013396 | ref\|Homo sapiens ubiquitin specific |
| | | | | peptidase 25 (USP25), mRNA. |
| hs\|chr21: 21301277-21301337 | A_14_P136854 | entg\|NCAM2 | ref\|NM_004540 | ref\|Homo sapiens neural cell |
| | | | | adhesion molecule 2 (NCAM2), |
| | | | | mRNA. |
| hs\|chr21: 25883439-25883499 | A_16_P03567193 | entg\|MRPL39 | ref\|NM_017446\| | ref\|Homo sapiens mitochondrial |
| | | | ref\|NM_080794 | ribosomal protein L39 (MRPL39), |
| | | | | nuclear gene encoding mitochondrial |
| | | | | protein, transcript variant 1, mRNA. |
| hs\|chr21: 25937744-25937804 | A_16_P21219885 | entg\|JAM2 | ref\|NM_021219 | ref\|Homo sapiens junctional |
| | | | | adhesion molecule 2 (JAM2), |
| | | | | mRNA. |
| hs\|chr21: 26020409-26020469 | A_14_P129661 | entg\|ATP5J | ref\|NM_001003696\| | ref\|Homo sapiens ATP synthase, H+ |
| | | | ref\| | transporting, mitochondrial F0 |
| | | | NM_001003697\| | complex, subunit F6 (ATP5J), |
| | | | ref\|NM_001003701\| | nuclear gene encoding mitochondrial |
| | | | ref\|NM_001003703\| | protein, transcript variant 3, mRNA. |
| | | | ref\| | |
| | | | NM_001685 | |
| hs\|chr21: 26034503-26034563 | A_16_P03567438 | entg\|GABPA | ref\|NM_002040 | ref\|Homo sapiens GA binding |
| | | | | protein transcription factor, alpha |
| | | | | subunit 60 kDa (GABPA), mRNA. |
| hs\|chr21: 26175054-26175112 | A_16_P21220493 | entg\|APP | ref\|NM_000484\| | ref\|Homo sapiens amyloid beta (A4) |
| | | | ref\|NM_201413\| | precursor protein (peptidase nexin-II, |
| | | | ref\| | Alzheimer disease) (APP), transcript |
| | | | NM_201414 | variant 1, mRNA. |
| hs\|chr21: 30614342-30614402 | A_16_P03574153 | entg\|KRTAP26-1 | ref\|NM_203405 | ref\|Homo sapiens keratin associated |
| | | | | protein (KRTAP26-1), mRNA. |
| hs\|chr21: 30665869-30665920 | A_14_P114884 | entg\|KRTAP13-2 | ref\|NM_181621 | ref\|Homo sapiens keratin associated |
| | | | | protein 13-2 (KRTAP13-2), nuclear |
| | | | | gene encoding mitochondrial protein, |
| | | | | mRNA. |
| hs\|chr21: 30690772-30690832 | A_14_P111688 | entg\|KRTAP13-1 | ref\|NM_181599 | ref\|Homo sapiens keratin associated |
| | | | | protein 13-1 (KRTAP13-1), mRNA. |
| hs\|chr21: 30734699-30734746 | A_14_P123396 | entg\|KRTAP15-1 | ref\|NM_181623 | ref\|Homo sapiens keratin associated |
| | | | | protein 15-1 (KRTAP15-1), mRNA. |
| hs\|chr21: 30785733-30785793 | A_14_P200585 | entg\|KRTAP19-3 | ref\|NM_181609 | ref\|Homo sapiens keratin associated |
| | | | | protein 19-3 (KRTAP19-3), mRNA. |
| hs\|chr21: 30791066-30791126 | A_14_P104353 | entg\|KRTAP19-4 | ref\|NM_181610 | ref\|Homo sapiens keratin associated |
| | | | | protein 19-4 (KRTAP19-4), mRNA. |
| hs\|chr21: 30835781-30835829 | A_14_P139606 | entg\|KRTAP19-6 | ref\|NM_181612 | ref\|Homo sapiens keratin associated |
| | | | | protein 19-6 (KRTAP19-6), mRNA. |
| hs\|chr21: 34206536-34206595 | A_16_P03579493 | entg\|ATP5O | ref\|NM_001697 | ref\|Homo sapiens ATP synthase, H+ |
| | | | | transporting, mitochondrial F1 |
| | | | | complex, O subunit (oligomycin |
| | | | | sensitivity conferring protein) |
| | | | | (ATP5O), nuclear gene encoding |
| | | | | mitochondrial protein, mRNA. |
| hs\|chr21: 34370842-34370902 | A_16_P21240974 | entg\|MRPS6 | ref\|NM_032476 | ref\|Homo sapiens mitochondrial |
| | | | | ribosomal protein S6 (MRPS6), |
| | | | | nuclear gene encoding mitochondrial |
| | | | | protein, mRNA. |
| hs\|chr21: 34662787-34662842 | A_14_P106199 | entg\|KCNE2 | ref\|NM_172201 | ref\|Homo sapiens potassium voltage- |
| | | | | gated channel, Isk-related family, |
| | | | | member 2 (KCNE2), mRNA. |
| hs\|chr21: 34810803-34810863 | A_14_P139150 | entg\|DSCR1 | ref\|NM_203418\| | ref\|Homo sapiens Down syndrome |
| | | | ref\|NM_203417\| | critical region gene 1 (DSCR1), |
| | | | ref\| | transcript variant 3, mRNA. |
| | | | NM_004414 | |
| hs\|chr21: 34965868-34965928 | A_16_P21242477 | entg\|CLIC6 | ref\|NM_053277 | ref\|Homo sapiens chloride |
| | | | | intracellular channel 6 (CLIC6), |
| | | | | mRNA. |
| hs\|chr21: 35084119-35084179 | A_14_P136022 | entg\|RUNX1 | ref\|NM_001001890\| | ref\|Homo sapiens runt-related |
| | | | ref\| | transcription factor 1 (acute myeloid |
| | | | NM_001754 | leukemia 1; aml1 oncogene) |
| | | | | (RUNX1), transcript variant 2, |
| | | | | mRNA. |
| hs\|chr21: 37665997-37666057 | A_16_P41446925 | entg\|DYRK1A | ref\|NM_101395 | ref\|Homo sapiens dual-specificity |
| | | | | tyrosine-(Y)-phosphorylation |
| | | | | regulated kinase 1A (DYRK1A), |
| | | | | transcript variant 3, mRNA. |
| hs\|chr21: 41672339-41672399 | A_16_P03590910 | entg\|MX2 | ref\|NM_002463 | ref\|Homo sapiens myxovirus |
| | | | | (influenza virus) resistance 2 |
| | | | | (mouse) (MX2), mRNA. |
| hs\|chr21: 41725577-41725624 | A_14_P116424 | entg\|MX1 | ref\|NM_002462 | ref\|Homo sapiens myxovirus |
| | | | | (influenza virus) resistance 1, |
| | | | | interferon-inducible protein p78 |
| | | | | (mouse) (MX1), mRNA. |
| hs\|chr21: 41760060-41760112 | A_14_P120220 | entg\|TMPRSS2 | ref\|NM_005656 | ref\|Homo sapiens transmembrane |
| | | | | protease, serine 2 (TMPRSS2), |
| | | | | mRNA. |
| hs\|chr21: 42033471-42033531 | A_14_P107193 | entg\|RIPK4 | ref\|NM_020639 | ref\|Homo sapiens receptor- |
| | | | | interacting serine-threonine kinase 4 |
| | | | | (RIPK4), mRNA. |
| hs\|chr21: 44215182-44215242 | A_16_P21266122 | entg\|AGPAT3 | ref\|NM_020132\| | ref\|Homo sapiens 1-acylglycerol-3- |
| | | | ref\|NM_001037553 | phosphate O-acyltransferase 3 |
| | | | | (AGPAT3), transcript variant 1, |
| | | | | mRNA. |
| hs\|chr21: 44260675-44260735 | A_16_P21266236 | entg\|TMEM1 | ref\|NM_001001723\| | ref\|Homo sapiens transmembrane |
| | | | ref\| | protein 1 (TMEM1), transcript |
| | | | NM_003274 | variant 2, mRNA. |
| hs\|chr21: 44353235-44353295 | A_16_P21266472 | entg\|PWP2 | ref\|NM_005049 | ref\|Homo sapiens PWP2 periodic |
| | | | | tryptophan protein homolog (yeast) |
| | | | | (PWP2), mRNA. |
| hs\|chr21: 44471769-44471829 | A_16_P03595043 | entg\|ICOSLG | ref\|NM_015259 | ref\|Homo sapiens inducible T-cell |
| | | | | co-stimulator ligand (ICOSLG), |
| | | | | mRNA. |
| hs\|chr21: 46109255-46109315 | A_16_P41469289 | entg\|PCBP3 | ref\|NM_020528 | ref\|Homo sapiens poly(rC) binding |
| | | | | protein 3 (PCBP3), mRNA. |
| hs\|chr21: 46229852-46229897 | A_16_P21271209 | entg\|COL6A1 | ref\|NM_001848 | ref\|Homo sapiens collagen, type VI, |
| | | | | alpha 1 (COL6A1), mRNA. |
| hs\|chr21: 46352738-46352798 | A_16_P41469934 | entg\|COL6A2 | ref\|NM_058174\| | ref\|Homo sapiens collagen, type VI, |
| | | | ref\|NM_058175\| | alpha 2 (COL6A2), transcript variant |
| | | | ref\| | 2C2a, mRNA. |
| | | | NM_001849 | |
| hs\|chr21: 46386086-46386146 | A_14_P116823 | entg\|FTCD | ref\|NM_006657\| | ref\|Homo sapiens |
| | | | ref\|NM_206965 | formiminotransferase |
| | | | | cyclodeaminase (FTCD), transcript |
| | | | | variant B, mRNA. |
| hs\|chr21: 46433456-46433516 | A_14_P138469 | entg\|LSS | ref\|NM_001001438\| | ref\|Homo sapiens lanosterol synthase |
| | | | ref\| | (2,3-oxidosqualene-lanosterol |
| | | | NM_002340 | cyclase) (LSS), transcript variant 2, |
| | | | | mRNA. |
| hs\|chr21: 46479771-46479831 | A_14_P137127 | entg\|MCM3AP | ref\|NM_003906 | ref\|Homo sapiens minichromosome |
| | | | | maintenance complex component 3 |
| | | | | associated protein (MCM3AP), |
| | | | | mRNA. |
| hs\|chr21: 9931865-9931925 | A_16_P21189519 | entg\|TPTE | ref\|NM_199259\| | ref\|Homo sapiens transmembrane |
| | | | ref\|NM_199260\| | phosphatase with tensin homology |
| | | | ref\| | (TPTE), transcript variant 2, mRNA. |
| | | | NM_199261 | |
| hs\|chr22: 17718800-17718860 | A_16_P41478766 | entg\|HIRA | ref\|NM_003325 | ref\|Homo sapiens HIR histone cell |
| | | | | cycle regulation defective homolog |
| | | | | A (S. cerevisiae) (HIRA), mRNA. |
| hs\|chr22: 17801220-17801280 | A_14_P102175 | entg\|MRPL40 | ref\|NM_003776 | ref\|Homo sapiens mitochondrial |
| | | | | ribosomal protein L40 (MRPL40), |
| | | | | nuclear gene encoding mitochondrial |
| | | | | protein, mRNA. |
| hs\|chr22: 17813833-17813893 | A_14_P200597 | entg\|LOC128977 | ref\|NM_173793 | ref\|Homo sapiens hypothetical |
| | | | | protein LOC128977 (LOC128977), |
| | | | | mRNA. |
| hs\|chr22: 17818735-17818795 | A_16_P21280007 | entg\|UFD1L | ref\|NM_001035247\| | ref\|Homo sapiens ubiquitin fusion |
| | | | ref\| | degradation 1 like (yeast) (UFD1L), |
| | | | NM_005659 | transcript variant 2, mRNA. |
| hs\|chr22: 17851380-17851440 | A_14_P127995 | entg\|CDC45L | ref\|NM_003504 | ref\|Homo sapiens CDC45 cell |
| | | | | division cycle 45-like (S. cerevisiae) |
| | | | | (CDC45L), mRNA. |
| hs\|chr22: 17890543-17890594 | A_14_P116836 | entg\|CLDN5 | ref\|NM_003277 | ref\|Homo sapiens claudin 5 |
| | | | | (transmembrane protein deleted in |
| | | | | velocardiofacial syndrome) |
| | | | | (CLDN5), mRNA. |
| hs\|chr22: 18082773-18082820 | A_16_P03601258 | entg\|SEPT5 | ref\|NM_002688 | ref\|Homo sapiens septin 5 (SEPT5), |
| | | | | mRNA. |
| hs\|chr22: 18129193-18129247 | A_16_P03601342 | entg\|TBX1 | ref\|NM_080647\| | ref\|Homo sapiens T-box 1 (TBX1), |
| | | | ref\|NM_080646\| | transcript variant C, mRNA. |
| | | | ref\| | |
| | | | NM_005992 | |
| hs\|chr22: 18159338-18159398 | A_16_P03601387 | entg\|GNB1L | ref\|NM_053004 | ref\|Homo sapiens guanine nucleotide |
| | | | | binding protein (G protein), beta |
| | | | | polypeptide 1-like (GNB1L), |
| | | | | mRNA. |
| hs\|chr22: 18246605-18246665 | A_14_P111851 | entg\|TXNRD2 | ref\|NM_006440 | ref\|Homo sapiens thioredoxin |
| | | | | reductase 2 (TXNRD2), nuclear gene |
| | | | | encoding mitochondrial protein, |
| | | | | mRNA. |
| hs\|chr22: 18318926-18318986 | A_16_P03601591 | entg\|COMT | ref\|NM_000754 | ref\|Homo sapiens catechol-O- |
| | | | | methyltransferase (COMT), |
| | | | | transcript variant MB-COMT, |
| | | | | mRNA. |
| hs\|chr22: 18343623-18343669 | A_16_P03601631 | entg\|ARVCF | ref\|NM_001670 | ref\|Homo sapiens armadillo repeat |
| | | | | gene deletes in velocardiofacial |
| | | | | syndrome (ARVCF), mRNA. |
| hs\|chr22: 18457133-18457191 | A_14_P114411 | entg\|DGCR8 | ref\|NM_022720 | ref\|Homo sapiens DiGeorge |
| | | | | syndrome critical region gene 8 |
| | | | | (DGCR8), mRNA. |
| hs\|chr22: 18481911-18481964 | A_14_P103991 | entg\|HTF9C | ref\|NM_022727\| | ref\|Homo sapiens HpaII tiny |
| | | | ref\|NM_182984 | fragments locus 9C (HTF9C), |
| | | | | transcript variant 1, mRNA. |
| hs\|chr22: 18485842-18485902 | A_16_P21281628 | entg\|RANBP1 | ref\|NM_002882 | ref\|Homo sapiens RAN binding |
| | | | | protein 1 (RANBP1), mRNA. |
| hs\|chr22: 18503384-18503442 | A_14_P139807 | entg\|ZDHHC8 | ref\|NM_013373 | ref\|Homo sapiens zinc finger, |
| | | | | DHHC-type containing 8 |
| | | | | (ZDHHC8), mRNA. |
| hs\|chr22: 22445703-22445755 | A_14_P112121 | entg\|MMP11 | ref\|NM_005940 | ref\|Homo sapiens matrix |
| | | | | metallopeptidase 11 (stromelysin 3) |
| | | | | (MMP11), mRNA. |
| hs\|chr22: 22464009-22464068 | A_14_P111527 | entg\|SMARCB1 | ref\|NM_001007468\| | ref\|Homo sapiens SWI/SNF related, |
| | | | ref\| | matrix associated, actin dependent |
| | | | NM_003073 | regulator of chromatin, subfamily b, |
| | | | | member 1 (SMARCB1), transcript |
| | | | | variant 2, mRNA. |
| hs\|chr22: 22508118-22508173 | A_16_P21291296 | entg\|DERL3 | ref\|NM_001002862\| | ref\|Homo sapiens Der1-like domain |
| | | | ref\| | family, member 3 (DERL3), |
| | | | NM_198440 | transcript variant 2, mRNA. |
| hs\|chr22: 22532019-22532079 | A_16_P41491267 | entg\|SLC2A11 | ref\|NM_001024938\| | ref\|Homo sapiens solute carrier |
| | | | ref\| | family 2 (facilitated glucose |
| | | | NM_030807\| | transporter), member 11 (SLC2A11), |
| | | | ref\|NM_001024939 | transcript variant 3, mRNA. |
| hs\|chr22: 22641434-22641479 | A_16_P21291586 | entg\|LOC100037417 | ref\|NM_001084393 | ref\|Homo sapiens D-dopachrome |
| | | | | tautomerase-like (LOC100037417), |
| | | | | mRNA. |
| hs\|chr22: 22706165-22706225 | A_16_P03605972 | entg\|GSTT1 | ref\|NM_000853 | ref\|Homo sapiens glutathione S- |
| | | | | transferase theta 1 (GSTT1), mRNA. |
| hs\|chr22: 26474238-26474298 | A_14_P135858 | entg\|MN1 | ref\|NM_002430 | ref\|Homo sapiens meningioma |
| | | | | (disrupted in balanced translocation) |
| | | | | 1 (MN1), mRNA. |
| hs\|chr22: 26577775-26577828 | A_14_P112007 | entg\|PITPNB | ref\|NM_012399 | ref\|Homo sapiens |
| | | | | phosphatidylinositol transfer protein, |
| | | | | beta (PITPNB), mRNA. |
| hs\|chr22: 30483637-30483697 | A_16_P41511230 | entg\|DEPDC5 | ref\|NM_001007188\| | ref\|Homo sapiens DEP domain |
| | | | ref\| | containing 5 (DEPDC5), transcript |
| | | | NM_014662 | variant 2, mRNA. |
| hs\|chr22: 30671273-30671324 | A_14_P112008 | entg\|YWHAH | ref\|NM_003405 | ref\|Homo sapiens tyrosine 3- |
| | | | | monooxygenase/tryptophan 5- |
| | | | | monooxygenase activation protein, |
| | | | | eta polypeptide (YWHAH), mRNA. |
| hs\|chr22: 30771611-30771671 | A_14_P131156 | entg\|SLC5A1 | ref\|NM_000343 | ref\|Homo sapiens solute carrier |
| | | | | family 5 (sodium/glucose |
| | | | | cotransporter), member 1 (SLC5A1), |
| | | | | mRNA. |
| hs\|chr22: 30876138-30876198 | A_16_P41512178 | entg\|LOC150297 | ref\|NM_001010859 | ref\|Homo sapiens hypothetical |
| | | | | protein LOC150297 (LOC150297), |
| | | | | mRNA. |
| hs\|chr22: 30917672-30917732 | A_16_P03616889 | entg\|RFPL2 | ref\|NM_006605 | ref\|Homo sapiens ret finger protein- |
| | | | | like 2 (RFPL2), mRNA. |
| hs\|chr22: 37021686-37021739 | A_16_P03625176 | entg\|CSNK1E | ref\|NM_152221\| | ref\|Homo sapiens casein kinase 1, |
| | | | ref\|NM_001894 | epsilon (CSNK1E), transcript variant |
| | | | | 1, mRNA. |
| hs\|chr22: 39098465-39098525 | A_16_P03627864 | entg\|RUTBC3 | ref\|NM_015705 | ref\|Homo sapiens RUN and TBC1 |
| | | | | domain containing 3 (RUTBC3), |
| | | | | mRNA. |
| hs\|chr22: 39141102-39141154 | A_16_P03627917 | entg\|MKL1 | ref\|NM_020831 | ref\|Homo sapiens megakaryoblastic |
| | | | | leukemia (translocation) 1 (MKL1), |
| | | | | mRNA. |
| hs\|chr22: 39405345-39405398 | A_14_P117741 | entg\|MCHR1 | ref\|NM_005297 | ref\|Homo sapiens melanin- |
| | | | | concentrating hormone receptor 1 |
| | | | | (MCHR1), mRNA. |
| hs\|chr22: 39495859-39495919 | A_16_P21331597 | entg\|SLC25A17 | ref\|NM_006358 | ref\|Homo sapiens solute carrier |
| | | | | family 25 (mitochondrial carrier; |
| | | | | peroxisomal membrane protein, |
| | | | | 34 kDa), member 17 (SLC25A17), |
| | | | | nuclear gene encoding mitochondrial |
| | | | | protein, mRNA. |
| hs\|chr22: 39552993-39553053 | A_16_P21331714 | entg\|ST13 | ref\|NM_003932 | ref\|Homo sapiens suppression of |
| | | | | tumorigenicity 13 (colon carcinoma) |
| | | | | (Hsp70 interacting protein) (ST13), |
| | | | | mRNA. |
| hs\|chr22: 39586378-39586438 | A_14_P123506 | entg\|XPNPEP3 | ref\|NM_022098\| | ref\|Homo sapiens X-prolyl |
| | | | ref\|NM_145174 | aminopeptidase (aminopeptidase P) |
| | | | | 3, putative (XPNPEP3), mRNA. |
| hs\|chr22: 42428563-42428623 | A_16_P41540805 | entg\|FLJ23588 | ref\|NM_022785\| | ref\|Homo sapiens CAP-binding |
| | | | ref\|NM_198856 | protein complex interacting protein 1 |
| | | | | (FLJ23588), transcript variant 1, |
| | | | | mRNA. |
| hs\|chr22: 42554803-42554850 | A_14_P127520 | entg\|SULT4A1 | ref\|NM_014351 | ref\|Homo sapiens sulfotransferase |
| | | | | family 4A, member 1 (SULT4A1), |
| | | | | mRNA. |
| hs\|chr22: 48578748-48578802 | A_16_P03640757 | entg\|BRD1 | ref\|NM_014577 | ref\|Homo sapiens bromodomain |
| | | | | containing 1 (BRD1), mRNA. |
| hs\|chr22: 48634916-48634976 | A_16_P21353790 | entg\|ZBED4 | ref\|NM_014838 | ref\|Homo sapiens zinc finger, BED- |
| | | | | type containing 4 (ZBED4), mRNA. |
| hs\|chr22: 48682858-48682918 | A_16_P41556699 | entg\|ALG12 | ref\|NM_024105 | ref\|Homo sapiens asparagine-linked |
| | | | | glycosylation 12 homolog (S. cerevisiae, |
| | | | | alpha-1,6- |
| | | | | mannosyltransferase) (ALG12), |
| | | | | mRNA. |
| hs\|chr22: 48699807-48699863 | A_14_P116178 | entg\|CRELD2 | ref\|NM_024324 | ref\|Homo sapiens cysteine-rich with |
| | | | | EGF-like domains 2 (CRELD2), |
| | | | | mRNA. |
| hs\|chr22: 48742058-48742103 | A_16_P21354055 | entg\|PIM3 | ref\|NM_001001852 | ref\|Homo sapiens pim-3 oncogene |
| | | | | (PIM3), mRNA. |
| hs\|chr22: 48785453-48785513 | A_14_P107287 | entg\|FLJ41993 | ref\|NM_001001694 | ref\|Homo sapiens FLJ41993 protein |
| | | | | (FLJ41993), mRNA. |
| hs\|chr22: 48798354-48798413 | A_16_P21354142 | entg\|LOC164714 | ref\|NM_001080447 | ref\|Homo sapiens similar to RIKEN |
| | | | | cDNA 1700019P01 (LOC164714), |
| | | | | mRNA. |
| hs\|chr22: 48839988-48840048 | A_16_P03641053 | entg\|MLC1 | ref\|NM_139202\| | ref\|Homo sapiens megalencephalic |
| | | | ref\|NM_015166 | leukoencephalopathy with |
| | | | | subcortical cysts 1 (MLC1), |
| | | | | transcript variant 2, mRNA. |
| hs\|chr22: 48872720-48872776 | A_16_P41557230 | entg\|MOV10L1 | ref\|NM_018995 | ref\|Homo sapiens Mov1011, |
| | | | | Moloney leukemia virus 10-like 1, |
| | | | | homolog (mouse) (MOV10L1), |
| | | | | mRNA. |
| hs\|chrX: 10006847-10006907 | A_14_P112163 | entg\|WWC3 | ref\|NM_015691 | ref\|Homo sapiens WWC family |
| | | | | member 3 (WWC3), mRNA. |
| hs\|chrX: 10085077-10085133 | A_14_P108116 | entg\|CLCN4 | ref\|NM_001830 | ref\|Homo sapiens chloride channel 4 |
| | | | | (CLCN4), mRNA. |
| hs\|chrX: 10382854-10382914 | A_16_P21379401 | entg\|MID1 | ref\|NM_000381\| | ref\|Homo sapiens midline 1 |
| | | | ref\|NM_033291\| | (Opitz/BBB syndrome) (MID1), |
| | | | ref\| | transcript variant 1, mRNA. |
| | | | NM_033290 | |
| hs\|chrX: 125511403-125511463 | A_14_P201080 | entg\|WDR40B | ref\|NM_178470 | ref\|Homo sapiens WD repeat domain |
| | | | | 40B (WDR40B), mRNA. |
| hs\|chrX: 140097588-140097648 | A_14_P134104 | entg\|LDOC1 | ref\|NM_012317 | ref\|Homo sapiens leucine zipper, |
| | | | | down-regulated in cancer 1 |
| | | | | (LDOC1), mRNA. |
| hs\|chrX: 150318683-150318743 | A_16_P21631742 | entg\|LOC203547 | ref\|NM_001017980 | ref\|Homo sapiens hypothetical |
| | | | | protein LOC203547 (LOC203547), |
| | | | | mRNA. |
| hs\|chrX: 150483644-150483704 | A_16_P03792974 | entg\|PASD1 | ref\|NM_173493 | ref\|Homo sapiens PAS domain |
| | | | | containing 1 (PASD1), mRNA. |
| hs\|chrX: 150618776-150618836 | A_14_P125206 | entg\|PRRG3 | ref\|NM_024082 | ref\|Homo sapiens proline rich Gla |
| | | | | (G-carboxyglutamic acid) 3 |
| | | | | (transmembrane) (PRRG3), mRNA. |
| hs\|chrX: 150639246-150639303 | A_14_P128319 | entg\|FATE1 | ref\|NM_033085 | ref\|Homo sapiens fetal and adult |
| | | | | testis expressed 1 (FATE1), mRNA. |
| hs\|chrX: 150654305-150654365 | A_16_P03793221 | entg\|CNGA2 | ref\|NM_005140 | ref\|Homo sapiens cyclic nucleotide |
| | | | | gated channel alpha 2 (CNGA2), |
| | | | | mRNA. |
| hs\|chrX: 150842025-150842075 | A_16_P03793454 | entg\|MAGEA4 | ref\|NM_001011548\| | ref\|Homo sapiens melanoma antigen |
| | | | ref\| | family A, 4 (MAGEA4), transcript |
| | | | NM_002362\| | variant 1, mRNA. |
| | | | ref\|NM_001011549\| | |
| | | | ref\| | |
| | | | NM_001011550 | |
| hs\|chrX: 2961012-2961072 | A_16_P21360756 | entg\|ARSH | ref\|NM_001011719 | ref\|Homo sapiens arylsulfatase |
| | | | | family, member H (ARSH), mRNA. |
| hs\|chrX: 2996343-2996403 | A_16_P03642253 | entg\|ARSF | ref\|NM_004042 | ref\|Homo sapiens arylsulfatase F |
| | | | | (ARSF), mRNA. |
| hs\|chrX: 3244040-3244100 | A_16_P03642569 | entg\|MXRA5 | ref\|NM_015419 | ref\|Homo sapiens matrix- |
| | | | | remodelling associated 5 (MXRA5), |
| | | | | mRNA. |
| hs\|chrX: 35854112-35854172 | A_14_P135257 | entg\|CXorf22 | ref\|NM_152632 | ref\|Homo sapiens chromosome X |
| | | | | open reading frame 22 (CXorf22), |
| | | | | mRNA. |
| hs\|chrX: 48510536-48510596 | A_16_P03702707 | entg\|GLOD5 | ref\|NM_001080489 | ref\|Homo sapiens glyoxalase domain |
| | | | | containing 5 (GLOD5), mRNA. |
| hs\|chrX: 48533175-48533227 | A_14_P116627 | entg\|GATA1 | ref\|NM_002049 | ref\|Homo sapiens GATA binding |
| | | | | protein 1 (globin transcription factor |
| | | | | 1) (GATA1), mRNA. |
| hs\|chrX: 48550049-48550109 | A_14_P105698 | entg\|HDAC6 | ref\|NM_006044 | ref\|Homo sapiens histone |
| | | | | deacetylase 6 (HDAC6), mRNA. |
| hs\|chrX: 48573322-48573378 | A_14_P110723 | entg\|ERAS | ref\|NM_181532 | ref\|Homo sapiens ES cell expressed |
| | | | | Ras (ERAS), mRNA. |
| hs\|chrX: 48577626-48577686 | A_14_P137697 | entg\|PCSK1N | ref\|NM_013271 | ref\|Homo sapiens proprotein |
| | | | | convertase subtilisin/kexin type 1 |
| | | | | inhibitor (PCSK1N), mRNA. |
| hs\|chrX: 48635653-48635707 | A_14_P121741 | entg\|TIMM17B | ref\|NM_005834 | ref\|Homo sapiens translocase of |
| | | | | inner mitochondrial membrane 17 |
| | | | | homolog B (yeast) (TIMM17B), |
| | | | | mRNA. |
| hs\|chrX: 48641997-48642057 | A_14_P104114 | entg\|PQBP1 | ref\|NM_001032381\| | ref\|Homo sapiens polyglutamine |
| | | | ref\| | binding protein 1 (PQBP1), |
| | | | NM_001032382\| | transcript variant 2, mRNA. |
| | | | ref\|NM_001032383\| | |
| | | | ref\|NM_001032385\| | |
| | | | ref\|NM_001032384\| | |
| | | | ref\|NM_005710 | |
| hs\|chrX: 48645821-48645881 | A_14_P139896 | entg\|SLC35A2 | ref\|NM_005660\| | ref\|Homo sapiens solute carrier |
| | | | ref\|NM_001042498\| | family 35 (UDP-galactose |
| | | | ref\|NM_001032289 | transporter), member A2 |
| | | | | (SLC35A2), transcript variant 1, |
| | | | | mRNA. |
| hs\|chrX: 48655377-48655436 | A_14_P138194 | entg\|PIM2 | ref\|NM_006875 | ref\|Homo sapiens pim-2 oncogene |
| | | | | (PIM2), mRNA. |
| hs\|chrX: 48669353-48669413 | A_16_P21465590 | entg\|OTUD5 | ref\|NM_017602 | ref\|Homo sapiens OTU domain |
| | | | | containing 5 (OTUD5), mRNA. |
| hs\|chrX: 48707898-48707948 | A_14_P136799 | entg\|KCND1 | ref\|NM_004979 | ref\|Homo sapiens potassium voltage- |
| | | | | gated channel, Shal-related |
| | | | | subfamily, member 1 (KCND1), |
| | | | | mRNA. |
| hs\|chrX: 48716139-48716199 | A_14_P134628 | entg\|GRIPAP1 | ref\|NM_020137 | ref\|Homo sapiens GRIP1 associated |
| | | | | protein 1 (GRIPAP1), transcript |
| | | | | variant 1, mRNA. |
| hs\|chrX: 48780269-48780329 | A_16_P41671520 | entg\|TFE3 | ref\|NM_006521 | ref\|Homo sapiens transcription factor |
| | | | | binding to IGHM enhancer 3 |
| | | | | (TFE3), mRNA. |
| hs\|chrX: 48804049-48804102 | A_14_P129172 | entg\|CCDC120 | ref\|NM_033626 | ref\|Homo sapiens coiled-coil domain |
| | | | | containing 120 (CCDC120), mRNA. |
| hs\|chrX: 48815768-48815821 | A_14_P121088 | entg\|PRAF2 | ref\|NM_007213 | ref\|Homo sapiens PRA1 domain |
| | | | | family, member 2 (PRAF2), mRNA. |
| hs\|chrX: 48822688-48822741 | A_14_P130534 | entg\|WDR45 | ref\|NM_001029896\| | ref\|Homo sapiens WD repeat domain |
| | | | ref\| | 45 (WDR45), transcript variant 2, |
| | | | NM_007075 | mRNA. |
| hs\|chrX: 48860125-48860182 | A_16_P41671742 | entg\|GPKOW | ref\|NM_015698 | ref\|Homo sapiens G patch domain |
| | | | | and KOW motifs (GPKOW), |
| | | | | mRNA. |
| hs\|chrX: 48907774-48907834 | A_14_P102088 | entg\|MAGIX | ref\|NM_024859 | ref\|Homo sapiens MAGI family |
| | | | | member, X-linked (MAGIX), |
| | | | | mRNA. |
| hs\|chrX: 48917891-48917951 | A_14_P111766 | entg\|PLP2 | ref\|NM_002668 | ref\|Homo sapiens proteolipid protein |
| | | | | 2 (colonic epithelium-enriched) |
| | | | | (PLP2), mRNA. |
| hs\|chrX: 48922105-48922157 | A_14_P104048 | entg\|LMO6 | ref\|NM_006150 | ref\|Homo sapiens LIM domain only |
| | | | | 6 (LMO6), mRNA. |
| hs\|chrX: 48931721-48931766 | A_14_P118756 | entg\|SYP | ref\|NM_003179 | ref\|Homo sapiens synaptophysin |
| | | | | (SYP), mRNA. |
| hs\|chrX: 48950714-48950774 | A_16_P21466170 | entg\|CACNA1F | ref\|NM_005183 | ref\|Homo sapiens calcium channel, |
| | | | | voltage-dependent, L type, alpha 1F |
| | | | | subunit (CACNA1F), mRNA. |
| hs\|chrX: 48981071-48981131 | A_14_P119323 | entg\|CCDC22 | ref\|NM_014008 | ref\|Homo sapiens coiled-coil domain |
| | | | | containing 22 (CCDC22), mRNA. |
| hs\|chrX: 48998290-48998348 | A_16_P03703270 | entg\|FOXP3 | ref\|NM_014009 | ref\|Homo sapiens forkhead box P3 |
| | | | | (FOXP3), mRNA. |
| hs\|chrX: 49015453-49015508 | A_16_P03703298 | entg\|PPP1R3F | ref\|NM_033215 | ref\|Homo sapiens protein |
| | | | | phosphatase 1, regulatory (inhibitor) |
| | | | | subunit 3F (PPP1R3F), mRNA. |
| hs\|chrX: 5818687-5818747 | A_14_P132284 | entg\|NLGN4X | ref\|NM_020742\| | ref\|Homo sapiens neuroligin 4, X- |
| | | | ref\|NM_181332 | linked (NLGN4X), transcript variant |
| | | | | 1, mRNA. |
| hs\|chrX: 74656164-74656224 | A_16_P21497890 | entg\|ZDHHC15 | ref\|NM_144969 | ref\|Homo sapiens zinc finger, |
| | | | | DHHC-type containing 15 |
| | | | | (ZDHHC15), mRNA. |
| hs\|chrX: 92812815-92812875 | A_14_P102722 | entg\|NAP1L3 | ref\|NM_004538 | ref\|Homo sapiens nucleosome |
| | | | | assembly protein 1-like 3 (NAP1L3), |
| | | | | mRNA. |
| hs\|chrX: 92816555-92816615 | A_16_P41728873 | entg\|FAM133A | ref\|NM_173698 | ref\|Homo sapiens family with |
| | | | | sequence similarity 133, member A |
| | | | | (FAM133A), mRNA. |
| hs\|chrY: 15146520-15146571 | A_16_P21662698 | entg\|NLGN4Y | ref\|NM_014893 | ref\|Homo sapiens neuroligin 4, Y- |
| | | | | linked (NLGN4Y), mRNA. |
| hs\|chrY: 2715687-2715747 | A_16_P41855990 | entg\|SRY | ref\|NM_003140 | ref\|Homo sapiens sex determining |
| | | | | region Y (SRY), mRNA. |
| hs\|chrY: 2771454-2771510 | A_16_P03797050 | entg\|RPS4Y1 | ref\|NM_001008 | ref\|Homo sapiens ribosomal protein |
| | | | | S4, Y-linked 1 (RPS4Y1), mRNA. |
| hs\|chrY: 2868107-2868167 | A_16_P41856247 | entg\|ZFY | ref\|NM_003411 | ref\|Homo sapiens zinc finger protein, |
| | | | | Y-linked (ZFY), mRNA. |

TABLE 2

| | | | |
|---|---|---|---|
| | | CHROMOSOMAL | ASSOCIATED |
| GENE NAME | GEN BANK ID | LOCATION | CONDITION |

Chromosome 1

| | | | |
|---|---|---|---|
| AGL | GDB: 132644 | 1p21-1p21 | GLYCOGEN STORAGE DISEASE III |
| ALDH4A1 | GDB: 9958827 | 1p36-1p36 | HYPERPROLINEMIA, TYPE II |
| CHS1 | GDB: 4568202 | 1q42.1-1q42.2 | CHEDIAK-HIGASHI SYNDROME; |
| | | | CHS1 |
| CRB1 | GDB: 333930 | 1q31-1q32.1 | RETINITIS PIGMENTOSA-12; RP12 |
| F5 | GDB: 119896 | 1q21-1q25 1q23-1q23 | FACTOR V DEFICIENCY |
| GBA | GDB: 119262 | 1q21-1q21 | GAUCHER DISEASE, TYPE I; GD I |
| KIF1B | GDB: 128645 | 1p36-1p36 | CHARCOT-MARIE-TOOTH DISEASE, |
| | | 1p36.22-1p36.22 | NEURONAL TYPE, A; CMT2A |

Chromosome 2

| | | | |
|---|---|---|---|
| AHHR | GDB: 118984 | 2pter-2q31 | CYTOCHROME P450, SUBFAMILY I, |
| | | | POLYPEPTIDE 1; CYP1A1 |
| DYSF | GDB: 340831 | 2p-2p 2p13-2p13 | MUSCULAR DYSTROPHY, LIMB- |
| | | 2pter-2p12 | GIRDLE, TYPE 2B; LGMD2B |
| | | | MUSCULAR DYSTROPHY, LATE- |
| | | | ONSET DISTAL |
| IGKC | GDB: 120088 | 2p12-2p12 2p11.2-2p11.2 | IMMUNOGLOBULIN KAPPA |
| | | | CONSTANT REGION; IGKC |
| SLC3A1 | GDB: 202968 | 2p16.3-2p16.3 | SOLUTE CARRIER FAMILY 3, |
| | | 2p21-2p21 | MEMBER 1; SLC3A1 CYSTINURIA; |
| | | | CSNU |
| HOXD13 | GDB: 127225 | 2q31-2q31 | HOMEO BOX-D13; HOXD13 |

Chromosome 3

| | | | |
|---|---|---|---|
| ACAA1 | GDB: 119643 | 3p23-3p22 | PEROXISOMAL 3-OXOACYL- |
| | | | COENZYME A THIOLASE |
| | | | DEFICIENCY |
| CMT2B | GDB: 604021 | 3q13-3q22 | CHARCOT-MARIE-TOOTH DISEASE, |
| | | | NEURONAL TYPE, B; CMT2B |
| GBE1 | GDB: 138442 | 3p12-3p12 | GLYCOGEN STORAGE DISEASE IV |
| SLC2A2 | GDB: 119995 | 3q26.2-3q27 | SOLUTE CARRIER FAMILY 2, |
| | | 3q26.1-3q26.3 | MEMBER 2; |
| VHL | GDB: 120488 | 3p26-3p25 | VON HIPPEL-LINDAU SYNDROME; |
| | | | VHL |

Chromosome 4

| | | | |
|---|---|---|---|
| GNPTA | GDB: 119280 | 4q21-4q23 | MUCOLIPIDOSIS II; ML2; ML II |
| IDUA | GDB: 119327 | 4p16.3-4p16.3 | MUCOPOLYSACCHARIDOSIS TYPE |
| | | | I; MPS I |
| SGCB | GDB: 702072 | 4q12-4q12 | MUSCULAR DYSTROPHY, LIMB- |
| | | | GIRDLE, TYPE 2E; LGMD2E |
| WHCR | GDB: 125355 | 4p16.3-4p16.3 | WOLF-HIRSCHHORN SYNDROME; |
| | | | WHS |

Chromosome 5

| | | | |
|---|---|---|---|
| CSF1R | GDB: 120600 | 5q33.3-5q34 | COLONY-STIMULATING FACTOR-1 |
| | | 5q33.2-5q33.3 | RECEPTOR; CSF1R |
| F12 | GDB: 119892 | 5q33-5qter 5q34-5qter | HAGEMAN FACTOR DEFICIENCY |
| GM2A | GDB: 120000 | 5q32-5q33 5q31.3-5q33.1 | TAY-SACHS DISEASE, AB VARIANT |
| HEXB | GDB: 119308 | 5q13-5q13 | SANDHOFF DISEASE |
| LGMD1A | GDB: 118832 | 5q22-5q34 | MUSCULAR DYSTROPHY, LIMB- |
| | | | GIRDLE, TYPE 1A; LGMD1A |
| SMN1 | GDB: 5215173 | 5q13-5q13 | SPINAL MUSCULAR ATROPHY I; |
| | | | SMA I SURVIVAL OF MOTOR |
| | | | NEURON 1, TELOMERIC; SMN1 |
| SLC6A3 | GDB: 132445 | 5p15.3-5p15.3 | SOLUTE CARRIER FAMILY 6, |
| | | | MEMBER 3; SLC6A3 |

Chromosome 6

| | | | |
|---|---|---|---|
| AS | GDB: 135697 | 6p21.3-6p21.3 | ANKYLOSING SPONDYLITIS; AS |
| EJM1 | GDB: 119864 | 6p21.1-6p11 | MYOCLONIC EPILEPSY, JUVENILE; |
| | | 6p21.2-6q13 | EJM1 |
| FANCE | GDB: 1220236 | 6p22-6p21 | FANCONI ANEMIA, |
| | | | COMPLEMENTATION GROUP E; |
| | | | FACE |
| IDDM1 | GDB: 9953173 | 6p21.3-6p21.3 | DIABETES MELLITUS, JUVENILE- |
| | | | ONSET INSULIN-DEPENDENT; IDDM |
| NEU1 | GDB: 120230 | 10pter-10q23 6p21-6p21 | NEURAMINIDASE DEFICIENCY |
| | | 6pter-6qter | |
| | | 6p21.3-6p21.3 | |
| PKHD1 | GDB: 433910 | 6p21.2-6p12 | POLYCYSTIC KIDNEY AND |
| | | 6p12.3-6p12.3 | HEPATIC DISEASE-1; PKHD1 |
| SCA1 | GDB: 119588 | 6p23-6p23 | SPINOCEREBELLAR ATAXIA 1; |
| | | | SCA1 |
| TNDM | GDB: 9956265 | 6q22-6q23 | DIABETES MELLITUS, TRANSIENT |
| | | | NEONATAL |
| TNF | GDB: 120441 | 6p21.3-6p21.3 | TUMOR NECROSIS FACTOR; TNF |

Chromosome 7

| | | | |
|---|---|---|---|
| AASS | GDB: 11502144 | 7q31.3-7q31.3 | HYPERLYSINEMIA |
| CCM1 | GDB: 580824 | 7q11.2-7q21 | CEREBRAL CAVERNOUS |
| | | | MALFORMATIONS 1; CCM1 |
| CMT2D | GDB: 9953232 | 7p14-7p14 | CHARCOT-MARIE-TOOTH DISEASE, |
| | | | NEURONAL TYPE, D |
| GUSB | GDB: 120025 | 7q11.21-7q11.22 | MUCOPOLYSACCHARIDOSIS TYPE |
| | | 7q21.11-7q21.11 | VII |
| | | 7q22-7q22 | |
| HOXA13 | GDB: 120656 | 7p15-7p14 7p15.3-7p15.3 | HOMEO BOX A13; HOXA13 |
| LEP | GDB: 136420 | 7q31.3-7q31.3 | LEPTIN; LEP |
| | | 7q32.1-7q32.1 | |
| SMAD1 | GDB: 3763345 | 7p14-7p14 7pter-7pter | SPINAL MUSCULAR ATROPHY, |
| | | 7p15.2-7p14.3 | DISTAL, WITH UPPER LIMB |
| | | | PREDOMINANCE; SMAD1 |
| ZWS1 | GDB: 120511 | 7q11-7q11 | ZELLWEGER SYNDROME; ZS |

Chromosome 8

| | | | |
|---|---|---|---|
| ADRB3 | GDB: 203869 | 8p12-8p11.1 8p12-8p11.2 | BETA-3-ADRENERGIC RECEPTOR; |
| | | | ADRB3 |
| ANK1 | GDB: 118737 | 8p11.2-8p11.2 | SPHEROCYTOSIS, HEREDITARY; HS |
| | | 8p12-8p11.2 | |
| CMT4A | GDB: 138755 | 8q-8q 8q13-8q21.1 | CHARCOT-MARIE-TOOTH |
| | | | NEUROPATHY 4A; CMT4A |
| FGFR1 | GDB: 119913 | 8p12-8p12 8p11.2-8p11.1 | ACROCEPHALOSYNDACTYLY TYPE |
| | | | V FIBROBLAST GROWTH FACTOR |
| | | | RECEPTOR-1; FGFR1 |
| PLAT | GDB: 119496 | 8p12-8p11 8p12-8p12 | PLASMINOGEN ACTIVATOR, |
| | | | TISSUE; PLAT |
| SGM1 | GDB: 135350 | 8q-8q 8q22.2-8q22.2 | KLIPPEL-FEIL SYNDROME; KFS; |
| | | | KFM |
| WRN | GDB: 128446 | 8p12-8p12 | WERNER SYNDROME; WRN |

Chromosome 9

| | | | |
|---|---|---|---|
| ABO | GDB: 118956 | 9q34.1-9q34.2 | ABO BLOOD GROUP; ABO |
| DYT1 | GDB: 119854 | 9q34-9q34 | DYSTONIA 1, TORSION; DYT1 |
| HSD17B3 | GDB: 347487 | 9q22-9q22 | PSEUDOHERMAPHRODITISM, |
| | | | MALE, WITH GYNECOMASTIA |
| MLLT3 | GDB: 138172 | 9p22-9p22 | MYELOID/LYMPHOID OR MIXED |
| | | | LINEAGE LEUKEMIA, |
| | | | TRANSLOCATED TO, 3; MLLT3 |

Chromosome 10

| | | | |
|---|---|---|---|
| CUBN | GDB: 636049 | 10p12.1-10p12.1 | MEGALOBLASTIC ANEMIA 1; MGA1 |
| CYP2C9 | GDB: 131455 | 10q24.1-10q24.1 | CYTOCHROME P450, SUBFAMILY |
| | | | IIC, POLYPEPTIDE 9; CYP2C9 |
| SFTPA1 | GDB: 119593 | 10q22-10q23 | PULMONARY SURFACTANT |
| | | | APOPROTEIN PSP-A; PSAP |
| SIAL | GDB: 6549924 | 10pter-10q23 | NEURAMINIDASE DEFICIENCY |
| THC2 | GDB: 10794765 | 10p12-10p11.1 | THROMBOCYTOPENIA |
| UROS | GDB: 128112 | 10q25.2-10q26.3 | PORPHYRIA, CONGENITAL |
| | | | ERYTHROPOIETIC; CEP |

Chromosome 11

| | | | |
|---|---|---|---|
| ABCC8 | GDB: 591370 | 11p15.1-11p15.1 | SULFONYLUREA RECEPTOR; SUR |
| | | | PERSISTENT HYPERINSULINEMIC |
| | | | HYPOGLYCEMIA OF INFANCY |
| ATM | GDB: 593364 | 11q22-11q23 | ATAXIA-TELANGIECTASIA; AT |
| | | 11q22.3-11q22.3 | |
| BSCL2 | GDB: 9963996 | 11q13.1-11q13.5 | SEIP SYNDROME |
| | | 11q13.1-11q13.1 | |
| BWS | GDB: 120567 | 11p15.5-11p15.5 | BECKWITH-WIEDEMANN |
| | | | SYNDROME; BWS |
| DHCR7 | GDB: 9835302 | 11q13.2-11q13.5 | SMITH-LEMLI-OPITZ SYNDROME |
| G6PT1 | GDB: 9862966 | 11q23-11q23 | GLYCOGEN STORAGE DISEASE Ib |
| | | 11q23.3-11q23.3 | |
| IDDM2 | GDB: 128530 | 11p15.5-11p15.5 | DIABETES MELLITUS, INSULIN- |
| | | | DEPENDENT, 2 DIABETES |
| | | | MELLITUS, JUVENILE-ONSET |
| | | | INSULIN-DEPENDENT; IDDM |
| INS | GDB: 119349 | 11p15.5-11p15.5 | INSULIN; INS |
| SCA5 | GDB: 378219 | 11p12-11q12 | SPINOCEREBELLAR ATAXIA 5; |
| | | 11q13.1-11q13.3 | SCA5 |
| SMPD1 | GDB: 128144 | 11p15.3-11p15.3 | NIEMANN-PICK DISEASE |
| | | 11p15.4-11p15.4 | |

Chromosome 12

| | | | |
|---|---|---|---|
| AAAS | GDB: 9954498 | 12q13-12q13 | GLUCOCORTICOID DEFICIENCY |
| | | | AND ACHALASIA |
| ACVRL1 | GDB: 230240 | 12q11-12q14 | OSLER-RENDU-WEBER SYNDROME |
| | | 12cen-12qter | 2; ORW2 ACTIVIN A RECEPTOR, |
| | | 12q13.12-12q13.13 | TYPE II-LIKE KINASE 1; ACVRL1 |
| AOM | GDB: 118998 | 12q12-12q13.1 | STICKLER SYNDROME, TYPE I; |
| | | | STL1 |
| FGF23 | GDB: 10450034 | 12p13.3-12p13.3 | VITAMIN D-RESISTANT RICKETS, |
| | | | AUTOSOMAL DOMINANT |
| IGF1 | GDB: 120081 | 12q22-12q23 | INSULINLIKE GROWTH FACTOR 1; |
| | | | IGF1 |
| LDHB | GDB: 120147 | 12p12.2-12p12.1 | LACTATE DEHYDROGENASE-B; |
| | | 12p12.1-12p12.1 | LDHB |
| PXR1 | GDB: 433739 | 12p13-12p13 | ZELLWEGER SYNDROME; ZS |
| | | | PEROXISOME RECEPTOR 1; PXR1 |
| SMAL | GDB: 9954506 | 12q23-12q24 | SPINAL MUSCULAR ATROPHY, |
| | | | CONGENITAL NONPROGRESSIVE, |
| | | | OF LOWER LIMBS |
| VDR | GDB: 120487 | 12q12-12q14 | VITAMIN D-RESISTANT RICKETS |
| | | | WITH END-ORGAN |
| | | | UNRESPONSIVENESS TO 1,25- |
| | | | DIHYDROXYCHOLECALCIFEROL |
| | | | VITAMIN D RECEPTOR; VDR |
| VWF | GDB: 119125 | 12p13.3-12p13.2 | VON WILLEBRAND DISEASE; VWD |

Chromosome 13

| | | | |
|---|---|---|---|
| BRCA2 | GDB: 387848 | 13q12-13q13 | BREAST CANCER 2, EARLY-ONSET; |
| | | 13q12.3-13q12.3 | BRCA2 |
| F10 | GDB: 119890 | 13q34-13q34 | X, QUANTITATIVE VARIATION IN |
| | | | FACTOR X DEFICIENCY; F10 |
| MBS1 | GDB: 128365 | 13q12.2-13q12.2 | MOEBIUS SYNDROME; MBS |
| SLC10A2 | GDB: 677534 | 13q33-13q33 | SOLUTE CARRIER FAMILY 10, |
| | | | MEMBER 2; SLC10A2 |

Chromosome 14

| | | | |
|---|---|---|---|
| ARVD1 | GDB: 371339 | 14q23-14q24 | ARRHYTHMOGENIC RIGHT |
| | | | VENTRICULAR DYSPLASIA, |
| | | | FAMILIAL, 1; ARVD1 |
| BCH | GDB: 118758 | 14q13.1-14q21.1 | CHOREA, HEREDITARY BENIGN; |
| | | | BCH THYROID TRANSCRIPTION |
| | | | FACTOR 1; TITF1 |
| DFNB5 | GDB: 636176 | 14q12-14q13 | DEAFNESS, NEUROSENSORY, |
| | | | AUTOSOMAL RECESSIVE, 5; DFNB5 |
| MJD | GDB: 118840 | 14q21-14q21 | MACHADO-JOSEPH DISEASE; MJD |
| | | 14q32.1-14q32.1 | |
| MPD1 | GDB: 230271 | 14q11-14q13 | MYOPATHY, LATE DISTAL |
| | | | HEREDITARY |
| PYGL | GDB: 120328 | 14q21-14q21 | GLYCOGEN STORAGE DISEASE VI |
| SPG3A | GDB: 230126 | 14q12-14q21 | SPASTIC PARAPLEGIA-3, |
| | | | AUTOSOMAL DOMINANT; SPG3A |
| USH1A | GDB: 118885 | 14q32-14q32 | USHER SYNDROME, TYPE IA; |
| | | | USH1A |

Chromosome 15

| | | | |
|---|---|---|---|
| ANCR | GDB: 119678 | 15q11-15q12 | ANGELMAN SYNDROME |
| BBS4 | GDB: 511199 | 15q22.3-15q23 | BARDET-BIEDL SYNDROME, TYPE |
| | | | 4; BBS4 |
| CDAN1 | GDB: 9823267 | 15q15.1-15q15.3 | DYSERYTHROPOIETIC ANEMIA, |
| | | | CONGENITAL, TYPE I |
| CYP1A1 | GDB: 120604 | 15q22-15q24 | CYTOCHROME P450, SUBFAMILY I, |
| | | | POLYPEPTIDE 1; CYP1A1 |
| HEXA | GDB: 120040 | 15q23-15q24 | TAY-SACHS DISEASE; TSD |
| PWCR | GDB: 120325 | 15q11-15q12 | PRADER-WILLI SYNDROME |
| WMS | GDB: 5583902 | 15q21.1-15q21.1 | WEILL-MARCHESANI SYNDROME |

Chromosome 16

| | | | |
|---|---|---|---|
| LA3 | GDB: 128453 | 16q22.1-16q22.1 | CEREBELLAR ATAXIA, |
| | | | AUTOSOMAL DOMINANT PURE |
| | | | CEREBELLOPARENCHYMAL |
| | | | DISORDER I; CPD I |
| CLN3 | GDB: 120593 | 16p12.1-16p12.1 | CEROID-LIPOFUSCINOSIS, |
| | | 16p12.1-16p11.2 | NEURONAL 3, JUVENILE; CLN3 |
| FANCA | GDB: 701221 | 16q24.3-16q24.3 | FANCONI ANEMIA, |
| | | | COMPLEMENTATION GROUP A; |
| | | | FACA |
| GALNS | GDB: 129085 | 16q24-16q24 | MUCOPOLYSACCHARIDOSIS TYPE |
| | | | IVA |
| PKDTS | GDB: 9954545 | 16p13.3-16p13.3 | POLYCYSTIC KIDNEY DISEASE, |
| | | | INFANTILE SEVERE, WITH |
| | | | TUBEROUS SCLEROSIS; |
| PKD1 | GDB: 120293 | 16p13.3-16p13.3 | POLYCYSTIC KIDNEYS |
| | | | POLYCYSTIC KIDNEY DISEASE 1; |
| | | | PKD1 |
| SLC12A3 | GDB: 642135 | 16q13-16q13 | SOLUTE CARRIER FAMILY 12, |
| | | | MEMBER 3; SLC12A3 |

Chromosome 17

| | | | |
|---|---|---|---|
| ACACA | GDB: 120534 | 17q21-17q21 | ACETYL-CoA CARBOXYLASE |
| | | 17q12-17q12 | DEFICIENCY |
| ASPA | GDB: 231014 | 17pter-17p13 | SPONGY DEGENERATION OF |
| | | | CENTRAL NERVOUS SYSTEM |
| CMT1A | GDB: 119785 | 17p12-17p11.2 | CHARCOT-MARIE-TOOTH DISEASE, |
| | | 17p11.2-17p11.2 | TYPE 1A; CMT1A NEUROPATHY, |
| | | | HEREDITARY, WITH LIABILITY TO |
| | | | PRESSURE PALSIES; HNPP |
| G6PC | GDB: 231927 | 17q21-17q21 | GLYCOGEN STORAGE DISEASE I; |
| | | | GSD-I |
| GH1 | GDB: 119982 | 17q22-17q24 | GROWTH HORMONE 1; GH1 |
| | | 17q23.1-17q23.3 | |
| MGI | GDB: 9954550 | 17p13-17p13 | MYASTHENIA GRAVIS, FAMILIAL |
| | | | INFANTILE; FIMG |
| MYO15A | GDB: 9838006 | 17p11.2-17p11.2 | DEAFNESS, NEUROSENSORY, |
| | | | AUTOSOMAL RECESSIVE, 3; DFNB3 |
| NAGLU | GDB: 636533 | 17q21.1-17q21.1 | MUCOPOLYSACCHARIDOSIS TYPE |
| | | | IIIB |
| NF1 | GDB: 120231 | 17q11.2-17q11.2 | NEUROFIBROMATOSIS, TYPE I; NF1 |
| PMP22 | GDB: 134190 | 17p11.2-17p11.2 | CHARCOT-MARIE-TOOTH DISEASE, |
| | | 17p12-17p11.2 | TYPE 1A; CMT1A HYPERTROPHIC |
| | | | NEUROPATHY OF DEJERINE- |
| | | | SOTTAS PERIPHERAL MYELIN |
| | | | PROTEIN 22; PMP22 |
| SLC2A4 | GDB: 119997 | 17p13-17p13 | SOLUTE CARRIER FAMILY 2, |
| | | | MEMBER 4; SLC2A4 |
| SMCR | GDB: 120379 | 17p11.2-17p11.2 | SMITH-MAGENIS SYNDROME; SMS |

Chromosome 18

| | | | |
|---|---|---|---|
| F5F8D | GDB: 6919858 | 18q21-18q21 | FACTOR V AND FACTOR VIII, |
| | | | COMBINED DEFICIENCY OF; F5F8D |
| NPC1 | GDB: 138178 | 18q11-18q11 | NIEMANN-PICK DISEASE, TYPE C1; |
| | | | NPC1 |
| TGIF | GDB: 9787150 | 18p11.3-18p11.3 | HOLOPROSENCEPHALY, TYPE 4; |
| | | | HPE4 |
| CORD1 | GDB: 118773 | 18q21.1-18q21.3 | CONE-ROD DYSTROPHY-1; CORD1 |

Chromosome 19

| | | | |
|---|---|---|---|
| APOC2 | GDB: 119689 | 19q13.2-19q13.2 | APOLIPOPROTEIN C-II DEFICIENCY, |
| | | | TYPE I HYPERLIPOPROTEINEMIA |
| | | | DUE TO |
| DBA | GDB: 9600353 | 19q13.2-19q13.2 | ANEMIA, CONGENITAL |
| | | | HYPOPLASTIC, OF BLACKFAN AND |
| | | | DIAMOND |
| DFNA4 | GDB: 606540 | 19q13-19q13 | DEAFNESS, AUTOSOMAL |
| | | | DOMINANT NONSYNDROMIC |
| | | | SENSORINEURAL, 4; DFNA4 |
| EPOR | GDB: 125242 | 19p13.2-19p13.2 | ERYTHROPOIETIN RECEPTOR; |
| | | | EPOR |
| MDRV | GDB: 6306714 | 19p13.3-19p13.3 | MUSCULAR DYSTROPHY, |
| | | | AUTOSOMAL DOMINANT, WITH |
| | | | RIMMED VACUOLES; MDRV |
| NPHS1 | GDB: 342105 | 19q12-19q13.1 | NEPHROSIS 1, CONGENITAL, |
| | | | FINNISH TYPE; NPHS1 |
| OPA3 | GDB: 9954590 | 19q13.2-19q13.3 | OPTIC ATROPHY, INFANTILE, WITH |
| | | | CHOREA AND SPASTIC |
| | | | PARAPLEGIA |
| SLC7A9 | GDB: 9958852 | 19q13.1-19q13.1 | CYSTINURIA, TYPE III; CSNU3 |
| STK11 | GDB: 9732383 | 19p13.3-19p13.3 | PEUTZ-JEGHERS SYNDROME |
| | | | SERINE/THREONINE PROTEIN |
| | | | KINASE 11; STK11 |

Chromosome 20

| | | | |
|---|---|---|---|
| CDPD1 | GDB: 11505748 | 20p13-20p13 | DYSTROPHY AND PERCEPTIVE |
| | | | DEAFNESS |
| HNF4A | GDB: 393281 | 20q12-20q13.1 | DIABETES MELLITUS, AUTOSOMAL |
| | | | DOMINANT TRANSCRIPTION |
| | | | FACTOR 14, HEPATIC NUCLEAR |
| | | | FACTOR; TCF14 |
| PRNP | GDB: 120720 | 20pter-20p12 | GERSTMANN-STRAUSSLER |
| | | | DISEASE; GSD PRION PROTEIN; |
| | | | PRNP |
| NBIA1 | GDB: 4252819 | 20p13-20p12.3 | HALLERVORDEN-SPATZ DISEASE |

Chromosome 21

| | | | |
|---|---|---|---|
| CBS | GDB: 119754 | 21q22.3-21q22.3 | HOMOCYSTINURIA |
| DCR | GDB: 125354 | 21q22.2-21q22.3 | TRISOMY 21 |
| KNO | GDB: 4073044 | 21q22.3-21q22.3 | KNOBLOCH SYNDROME; |
| | | | KNOAMYOTROPHIC LATERAL |
| | | | SCLEROSIS |
| SOD1 | GDB: 119596 | 21q22.1-21q22.1 | SUPEROXIDE DISMUTASE-1; SOD1 |
| | | | MUSCULAR ATROPHY, |
| | | | PROGRESSIVE, WITH |
| | | | AMYOTROPHIC LATERAL |
| | | | SCLEROSIS |

Chromosome 22

| | | | |
|---|---|---|---|
| CECR | GDB: 119772 | 22pter-22q11 | CAT EYE SYNDROME; CES |
| CYP2D7P1 | GDB: 119832 | 22q13-22q13 | CYTOCHROME P450, SUBFAMILY |
| | | 22q13.1-22q13.31 | IID; CYP2D |
| DGCR | GDB: 119843 | 22q11.21-22q11.23 | DIGEORGE SYNDROME; DGS |
| GGT1 | GDB: 120623 | 22q11.2-22q12.1 | GLUTATHIONURIA |
| SLC5A1 | GDB: 120375 | 22q13.1-22q13.1 | SOLUTE CARRIER FAMILY 5, |
| | | 22q12.3-22q13.1 | MEMBER 1; SLC5A1 |
| | | 22q12.3-22q12.3 | |
| PRODH | GDB: 5215168 | 22q11.2-22q11.2 | HYPERPROLINEMIA, TYPE I |

Chromosome X

| | | | |
|---|---|---|---|
| ADFN | GDB: 118977 | Xq25-Xq26 | ALBINISM-DEAFNESS SYNDROME; |
| | | | ADFN; ALDS |
| AHDS | GDB: 125899 | Xq21.1-Xq21.1 | MENTAL RETARDATION, X- |
| | | Xq21-Xq21 | LINKED, WITH HYPOTONIA |
| AVPR2 | GDB: 131475 | Xq28-Xq28 | DIABETES INSIPIDUS, |
| | | | NEPHROGENIC |
| BFLS | GDB: 120566 | Xq26-Xq27.1 | BORJESON SYNDROME; BORJ |
| CMTX2 | GDB: 128311 | Xp22-Xp22 | CHARCOT-MARIE-TOOTH |
| | | | NEUROPATHY, X-LINKED |
| | | | RECESSIVE, 2; CMTX2 |
| CPX | GDB: 120598 | Xq21.3-Xq22 | CLEFT PALATE, X-LINKED; CPX |
| | | Xq21.3-Xq21.3 | |
| DMD | GDB: 119850 | Xp21.3-Xp21.2 | MUSCULAR DYSTROPHY, |
| | | Xp21.2-Xp21.2 | PSEUDOHYPERTROPHIC |
| | | | PROGRESSIVE, DUCHENNE AND |
| | | | BECKER |
| F9 | GDB: 119900 | Xq26.3-Xq27.1 | HEMOPHILIA B; HEMB |
| | | Xq27.1-Xq27.2 | |
| KAL1 | GDB: 120116 | Xp22.32-Xp22.32 | KALLMANN SYNDROME 1; KAL1 |
| MID1 | GDB: 9772232 | Xp22-Xp22 | OPITZ SYNDROME |
| | | Xp22.3-Xp22.3 | |
| MRX20 | GDB: 217050 | Xp11.3-Xp11.23 | MENTAL RETARDATION, X-LINKED |
| | | | 20; MRX20 |
| PGS | GDB: 128372 | Xq25-Xq27 | DANDY-WALKER MALFORMATION |
| | | | WITH MENTAL RETARDATION, |
| | | | BASAL GANGLIA DISEASE, |
| SMAX2 | GDB: 9954643 | Xp-Xp | SPINAL MUSCULAR ATROPHY, X- |
| | | | LINKED LETHAL INFANTILE |
| WWS | GDB: 120497 | Xq11-Xq22 | WIEACKER SYNDROME |

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein as well as all accession numbers, Agilent probe IDs and GenBank IDs, particularly those referenced in Tables 1 and 2, are hereby incorporated by reference in their entirety for all purposes.

### EXAMPLES

In order to identify conserved regions of cell free or free floating DNA of fetal origin in maternal whole blood the following experimental design was employed. The culmination of the process described below has yielded both regional and sequence specific targets that are used for the identification of fetal DNA in the context of maternal DNA. The experimental process has four major components including: (1) gentle lysis of maternal whole blood DNA and size specific bead-based DNA extraction, (2) fetal DNA enrichment and detection using size selection and digital PCR, (3) subtractive hybridization of maternal, fetal fractionated and fetal DNA using array CGH to identify conserved genomic regions in cell free fetal DNA and (4) target specific next generation sequencing to identify condition/disease related loci for diagnostic assay development.

### Example I

### Dx Lysis for Fetal DNA Extraction

Isolation of free floating fetal DNA from whole blood presents unique challenges. The two confounding variables in maximizing the yield of fetal DNA from whole blood is the selective lysis and disaggregation of target specific cells and DNA in order to efficiently extract them in the background of maternal genomic DNA. To accomplish this task a buffer and protocol that accomplishes two critical goals was formulated. First, the gentle lysis procedure selectively lyses cells that are not in their optimal growth environment (i.e. fetal trophoblasts) allowing for the release of nucleic acid from this cells that are otherwise not present in the non-cellular DNA fraction and secondly disaggregate small DNA molecules that are not available for efficient extraction in its normal state. This lysis buffer and procedure increases the yield of fetal DNA in any given maternal whole blood sample by approximately 15%. Following lysis an automated process for DNA extraction was employed on the Qiagen Symphony Dx instrument. This instrument utilizes bead based chemistry to extract high quality DNA from whole blood (or in this case gently lysed produced) samples. The chemistry being used for extraction was modified to work in concert with the Dx lysed product and is optimized to preferentially isolate “small” DNA products over high molecular weight genomic DNA species. This led to an enrichment of fetal DNA in each sample when compared to standard practice for DNA extraction which is critical to maximize detection of mutations that are fetal specific.

Briefly, samples consist of 8 mL to 10 mL of whole blood in an ACD tube. The samples were stored at 2°-8° C. and were processed within 8 hours of receipt. The ACD tubes were gently inverted three times to mix the blood and 10 mL of whole blood is then removed and placed in a clean 15 mL conical-bottom tube. The BioDx 20 buffer (0.32M sucrose, 5 mM MgCl₂, 3% Triton X-100, Saponin 0.1%, 10 mM Tris-HCl, pH 7.3) was then added at 10% by volume, for example, for 10 mL of blood, 1 mL of buffer was added. The tubes were then inverted at least 4 times and centrifuged at 3000 rpm for 5 minutes to separate the liquid layer from the lysed cell debris at the bottom of the tube. The top liquid layer of cell lysate was then removed to a second clean 15 mL conical-bottom tube taking care to not distrust the cell debris later. The lysate was then aliquoted into 1.2 mL aliquots and frozen for future use. A 1.2 mL aliquot of cell lysate prepared above was pipetted into a clean 2 mL tube and an automated process for DNA extraction was employed on the Qiagen Symphony Dx instrument to separate the DNA.

### Example 2

### Characterization of Conserved Free Floating DNA Sequences

A subtractive hybridization approach was utilized to identify fetal specific sequences in Dx lysed, size fractionated free floating DNA. Briefly, the subtractive hybridization approach requires that two CGH arrays be run for each clinical case. The first array analyzes maternal DNA against fetal DNA (a product of conception) to identify differences in fetal genomic DNA. The second array analyzes maternal DNA against enriched free floating fetal DNA (a product of maternal whole blood) to identify regions present in free floating fetal DNA. A comparative analysis of unique fetal segments from both arrays identifies regions of conservation in free floating fetal DNA samples in each case analyzed. By following this hybridization scheme in we can confirm which sequences are present in the free floating fetal DNA fraction when compared to the entire fetal genome. This is the first step in the conserved sequence identification process.

Differences in the free floating fetal genome relative to intact maternal and fetal DNA were identified by array CGH analysis using microarray slides, which contain 244 000 (244 K) and one million (1×1 M) oligonucleotide probes (Agilent Technologies, Santa Clara, Calif., USA).

For sample preparation and hybridization we have followed the protocol developed and described in detail by Agilent. Briefly, genomic DNA was extracted from as described above. The integrity of DNA was confirmed with nanodrop and agarose gel electrophoresis. For array CGH without WGA, we used 2.5 μg of fetal DNA and 2.5 μg of maternal DNA for each analysis. DNA was digested with Rsa I and Alu I and labeled by random priming using either Cy5-dUTP or Cy3-dUTP. Following purification with Microcon Centrifugation Filters, Ultracel YM-30 (Millipore, Billerica, Mass., USA), probes were denatured and pre-annealed with 50 μg of human Cot-1 DNA (Invitrogen, Burlington, Ontario, Canada). Hybridization was performed at 65° C. for 40 h with constant rotation.

After hybridization, slides were washed according to the manufacturer's instructions and scanned immediately with a DNA Microarray Scanner (Agilent Technologies). Data were extracted from scanned images using Feature Extraction software, version 10.7.3.1 (Agilent). The text files were then imported for analysis into Genomic Workbench, standard edition 5.0.14 (Agilent). We used the reference maternal DNA to identify DNA copy number aberrations. The algorithm used identifies all aberrant intervals in a given sample with consistently high or low log ratios based on the statistical score. It then samples adjacent probes to arrive at an estimation of the true range of the aberrant segment (aberrant being under represented as is the case with fetal fractionated samples). The statistical score represents the deviation of the average of the log ratios from the expected value of zero, in units of standard deviation. The algorithm searches for intervals in which a statistical score based on the average quality weighted log ratio of the sample and reference channels exceeds a user specified threshold. We applied a filtering option of minimum of 5 probes in region and minimum absolute average log 2 ratio>0.3. USCS human genome assembly hg18 was used as a reference and copy number variations (CNV) were identified with a database integrated in the Agilent Genomic Workbench analytic software.

During analysis with CGH analytics software, the sensitivity threshold was 6.0 and the moving average window was 1 Mb. In order to determine that there was a change in a particular locus, three criteria must have been met. These were positive call by the software, presence of 10 consecutive probes pointing out the same direction, and 1.5-fold average fold difference in the test DNA compared to the reference normal DNA.

### Example 3

### NextGen Sequencing

In order to fully understand the length and fidelity of sequence identified by array CGH this NextGeneration sequencing approach is employed to validate and finally map conserved loci in the free floating fetal genome. The loci sequenced are derived from the conserved probed sequences identified with array CGH described above. Briefly, the conserved probe sequences identified to be present in free floating fetal DNA were used as “bait” to create the capture libraries used for sequencing the entire segments of conserved free floating fetal DNA. The extent of natural genomic variation between individuals creates an additional problem when predicting conservation of fetal DNA between individuals. Hence, it is prudent to have available constitutional (“normal”) DNA as well as fetal DNA from the same individual as a potential reference, in this instance it is maternal DNA. For DNA analysis, a targeted sequencing approach using paired end genomic libraries was used. Sequence capture of conserved array CGH was performed by solution hybridization and recovered using the Agilent SureSelectXT™ system. The bait for the 30 target genes selected for this application covers all conserved fetal regions and the flanking 10 bp for interrogating splice/donor/acceptor sites and branch site mutations, and was designed using Agilent's eArray https://earray.chem.agilent.com/earray.

In brief, isolated DNA was sheared to a target size of 150-200bp with a Covaris AFA instrument, purified with Agencourt AMPureTM XP beads, and quantified using cuvetteless spectroscopy and quality determined with the Agilent 2100 bioanalyzer. The DNA ends are blunt-ended with T4 polymerase, repurified and modified by 3′ addition of an A nucleotide. Following one more round of bead purification, bar-coded paired-end adapters were ligated to the DNA fragments which are then PCR amplified for five cycles using the SureSelect™ Indexing Pre-Capture PCR (reverse) primer. After another purification round, the libraries were hybridized to biotinylated bait in solution and recovered on streptavidin-coated paramagnetic beads. Hybridization was carried out in the presence of oligonucleotide blockers complementary to minimize the formation of chains or circles which can potentially reduce enrichment levels. Genomic fragments were index tagged by post-hybridization amplification and pooled in equimolar concentrations for balanced sequencing. Sequencing was done with paired 100bp read at a density of about 700 clusters/mm². All sequence analysis and mutation detection was performed using commercially available software (e.g. SeqNext, NextGene, ZOOM, MAQ). These approaches were used to verify the primary sequence data alignments and reports the genotype at all dbSNP130 on the depth of coverage and improved concordance rates with other genotyping platforms (e.g. illumina HumanOmni 1 million SNP chip) from 96% to >99%. The primary sequencer output is in *.bcl binary files (base calls per cycle) which are converted to complete reads with quality scores (*.qseq files or quality and sequence files) each read and a third for the indexing read per tile. This is a necessary but relatively quick process and was done using the BCL converter provided with the software package. The 32 qseq files/lane were then converted to .fastq (text-based format for storing nucleotide sequence) as they undergo demultiplexing into their individual sample data and combined into 2 files per sample, one for each read of the paired run. Files were given unique names according to the convention sampleID_flowcellID_lane#_read#.fastq so that sample data collected on different runs and/or different lanes can be placed at the same file structure level. Once all the runs/lanes scheduled to contain data for a given sample have been demultiplexed the reads were aligned to the reference genome, chosen through the web interface for each sample. We used the Burrows-Wheeler Transform method implemented in the BWA (Burrows-Wheeler Alignment) package which we find as having better performance than other aligners we have tested (ELAND, Bowtie, Zoom, MAQ) in terms of quality of alignments, number of reads aligned and capacity to open gaps. Upon alignment request .fastq files are split into 10M reads chunks and a BWA process is spawned on the cluster. Each instance of BWA produces an alignment in .SAM format and all .SAM files for single samples are concatenated into a final alignment result file for that sample with a unique naming following the convention sampleID_flowcellID_lane#.sam.

Collectively, these methods have identified 67,848 conserved regions across 30 different independent subjects and correlated the conserved regions to 157 unique disease mutations. Furthermore, the methods have identified 70% of prenatal markers currently used in standard genetic analysis and conserved regions across the entire genome providing for novel targets of investigation.

The vast amount of data uncovered from the methods of the current invention are useful in targeted diagnostics by identifying targets for assay development, global screens to explore the cell free fetal DNA genome as a screening tool for early risk assessment, as well as for “follow up” diagnostics employing cell free fetal DNA as a tool for postnatal analysis.

1. A method of detecting the presence of fetal DNA in a biological sample of a maternal host of a fetus comprising
identifying the genotpye of at least one conserved segments provided in Table 1 in the biological sample of the maternal host;
comparing the genotype with a corresponding maternal genotype;
wherein a genoptype different from the corresponding maternal genotype indicates the presence of fetal DNA of the fetus.

2. The method of claim 1, wherein the biological sample is a biological sample of the maternal host enriched for fetal DNA.

3. The method of claim 1, wherein the biological sample is enriched for fetal DNA via DNA size fractionation.

4. The method of claim 1, wherein the biological sample is a sample of cell free DNA from the whole blood of a maternal host.

5. The method of claim 1, wherein the genotype is SNP, RFLP, STR, DNA sequence, or a combination thereof.

6. The method of claim 1, wherein the genotype is a group of at least 50 SNPs.

7. The method of claim 1, wherein the biological sample is a sample enriched for fetal DNA and wherein the corresponding maternal genotype is determined using a maternal cell sample.

8. A method of detecting the presence or absence of a genetic condition in a fetus comprising
detecting in a biological sample obtained form a maternal host of the fetus the presence or absence of a genetic marker for the genetic condition;
wherein the genetic marker is within a chromosomal location conserved in cell free fetal DNA in the biological sample of the maternal host;
wherein the chromosomal location is selected from the group consisting of the chromosomal locations listed in Table 2; and
wherein the presence or absence of the genetic marker indicates the presence or absence of the genetic condition in the fetus.

9. The method of claim 8, wherein the biological sample is a biological sample of the maternal host enriched for fetal DNA.

10. The method of claim 8, wherein the biological sample is confirmed for the presence of fetal DNA.

11. The method of claim 8, wherein the genetic marker is a combination of a first genetic marker from a first chromosomal location conserved in cell free fetal DNA and a second genetic marker from a second chromosomal location conserved in cell free fetal DNA wherein the first and second chromosomal location are different.

12. The method of claim 8, wherein the genetic marker is associated with spinal muscular atrophy and the chromosomal location is 5q13-5q13.

13. The method of claim 8, wherein the genetic marker is associated with trisomy and within the chromosomal locations selected from the group consisting of X21.2-Xp21.1, 17q11.2-17q11.2, 3p26-3p25, 5q13-5q13, 16q24.3-16q24.3, 1q24.2-1q23 and 11q22-11q23.

14. The method of claim 8, wherein the genetic marker is within a chromosomal location on chromosomal 13, 14, 15, 16, 18, 21, 22, X and or Y.

15. A method for selecting a genetic marker for determining a genetic condition of a fetus in a biological sample of a maternal host of the fetus comprising
identifying a group of genetic markers associated with the genetic condition to be determined for the fetus in the biological sample of the maternal host;
identifying within the group of genetic markers a subset of genetic markers that are within one or more chromosomal locations conserved in cell free fetal DNA in the biological sample of the maternal host;
selecting a subset of genetic markers for assay testing and
determining the genetic condition of the fetus based on results obtained from the assay testing.

16. A database in a computer readable medium comprising conserved genomic segments provided in Table 1, wherein the database is searchable based on an identifier for each conserved genomic segment provided in Table 1.

17. A database in a computer readable medium comprising chromosomal locations provided in Table 2, wherein the database is searchable based on an identifier for each chromosomal location provided in Table 2.

18. An array of probes useful for detecting at least one conserved genomic segments provided in Table 1.

19. An array of probes useful for detecting at least one chromosomal location provided in Table 2.

20. The array of claim 18, useful for detecting the genotype of at least one conserved genomic segments provided in Table 1.
